(19) United States
(12) Patent Application Publication
(10) Pub. No.: US 2019/0375988 A1
(43) Pub. Date: Dec. 12, 2019

(54) OPTICALLY ISOTROPIC LIQUID CRYSTAL COMPOSITION AND OPTICAL SWITCHING ELEMENT USING THE SAME

(71) Applicants: JNC CORPORATION, Tokyo (JP); JNC PETROCHEMICAL CORPORATION, Tokyo (JP)

(72) Inventors: Shinichi YAMAMOTO, Chiba (JP); Eiji OKABE, Chiba (JP)

(73) Assignees: JNC CORPORATION, Tokyo (JP); JNC PETROCHEMICAL CORPORATION, Tokyo (JP)

(21) Appl. No.: 16/436,944

(22) Filed: Jun. 11, 2019

(30) Foreign Application Priority Data
Jun. 11, 2018 (JP) 2018-111257
Jan. 23, 2019 (JP) 2019-009512

(51) Int. Cl. C09K 19/34; C09K 19/58; C09K 19/54; G02F 1/29

(52) U.S. Cl. CPC C09K 19/3402; C09K 19/586; C09K 2019/0466; G02F 1/29; C09K 19/542

(57) ABSTRACT

Since a switching element using a nematic liquid crystal medium has a long response time, there is a limit to the number of control instances over a certain time. By using a liquid crystal composition exhibiting an optical isotropic phase, an element capable of performing polarization control at high speed is provided. A mixture comprising the liquid crystal composition and polymerizable monomers, a polymer/liquid crystal composite material obtained by polymerizing the mixture, an element comprising the liquid crystal composition or the polymer/liquid crystal composite, and a LIDAR comprising the element are provided.

### CROSS-REFERENCE TO RELATED APPLICATION

This application claims the priority of Japan patent application serial no. 2018-111257, filed on Jun. 11, 2018, and Japan patent application serial no. 2019-009512, filed on Jan. 23, 2019. The entirety of each of the above-mentioned patent applications is hereby incorporated by reference herein and made a part of this specification.

### BACKGROUND

### Technical Field

The disclosure relates to an optical switching element, and for example, a mixture of a liquid crystal medium (such as a liquid crystal composition and a polymer/liquid crystal composite material) exhibiting an optically isotropic liquid crystal phase used in, for example, Laser Imaging Detection and Ranging (LIDAR), polymerizable monomers and the like, and a liquid crystal composition, and an element using the same.

### Description of Related Art

An optical switching element is an element that switches an optical path on and off, and there are mechanical types, electronic types, and all-optical types of method therefor. The mechanical type method is a method in which a prism, a mirror or an optical fiber is moved mechanically, and the electronic type uses an electrooptic effect, a magneto-optical effect, a thermo-optical effect or a semiconductor gate. The all-optical type uses non-linear refractive index change, and a method using a liquid crystal medium exhibiting an isotropic liquid crystal phase qualifies as an all-optical type. An optical switching element that can control light over a wide wavelength range is preferable, and an optical switching element that can control light in a visible light range (0.38 to 0.78 μm), a near infrared range (0.72 to 2.5 μm) or a millimeter wave range (1 to 10 mm) is more preferable.

LIDAR is one of remote sensing techniques for measuring a distance to, a direction of, and the like, a subject from reflected light, and a laser beam with a short wavelength in a near infrared range (0.72 to 2.5 μm) is used. Mechanical elements such as micro electro mechanical systems (MEMS) have been studied for polarization control. However, there are many problems therein such as difficulty in controlling a steering angle and deterioration of durability due to mechanically movable parts.

Polarization control with an element using a liquid crystal medium is performed according to an electro-optical response of a liquid crystal medium. Incident light is converted into elliptically polarized light, linearly polarized light, circularly polarized light, or the like. When an element using a liquid crystal medium is used, it can be used as an optical switching element with electrical operation only without mechanical driving.

In an element using a liquid crystal medium for controlling polarization, a nematic liquid crystal medium may be used. However, since a response time is then long, there is a problem that there is a limit to the number of control instances over a certain time. Like a nematic liquid crystal medium, a blue phase liquid crystal medium which is one of optically isotropic liquid crystal phases is known as a liquid crystal medium that can control polarization according to an electro-optical response. Wavelength variable filters, wavefront control elements, liquid crystal lenses, aberration correction elements, opening control elements, optical head devices and the like using birefringence induced due to an electric field have been proposed therefor so far (Patent Document 1 to 4).

[Patent Document 1] Japanese Patent Laid-Open No. 2005-157109

[Patent Document 2] PCT International Publication No. WO 2005/80529

[Patent Document 3] Japanese Patent Laid-Open No. 2006-127707

[Patent Document 4] PCT International Publication No. WO 2018-003658

### SUMMARY

As described above, a mechanical element that has been studied for controlling polarization has problems of difficulty in controlling a steering angle and deterioration of durability. In addition, since an element using a nematic liquid crystal medium has a long response time, the number of controls for a certain time is limited.

The inventors conducted extensive studies and as a result, found that an element using a liquid crystal medium exhibiting an optically isotropic liquid crystal phase, and particularly, a blue phase liquid crystal medium, can be suitably used for controlling polarization, and thus completed the disclosure.

It is known that an element using a blue phase liquid crystal medium has a short response time (fast response). This is because, in a blue phase liquid crystal medium when no electric field is applied, when an electric field is applied, birefringence is induced due to an electro-optical Kerr effect proportional to the square of the applied electric field, and optically anisotropy is exhibited.

In order to address the above problems, in this disclosure, a blue phase liquid crystal medium is used as a liquid crystal medium for an optical switching element. The blue phase liquid crystal medium can switch between an optically isotropic state and an anisotropic state at high speed. That is, it is possible to perform polarization control at high speed with an electrical operation. As an example, the blue phase liquid crystal medium has a property of inducing birefringence with half a wavelength (λ/2) with respect to a wavelength of incident light source with an electrical operation, and can switch polarization directions of right or left circular polarization of incident light between reverse, left or right directions. A time required for this switching is characterized by the fact that that there is no response time difference between electric field application and electric field removal in principle in the sub-millisecond order in a region in which the electro-optical Kerr effect is provided.

The disclosure provides, for example, a mixture of the following liquid crystal medium (such as a liquid crystal composition and a polymer/liquid crystal composite material), polymerizable monomers and the like, and a liquid crystal composition, and an optical switching element containing a liquid crystal medium and the like.

The disclosure includes the following items.

1. A liquid crystal composition which contains an achiral component T and has an optically isotropic liquid crystal phase and is used for optical switching in which retardation is controlled by birefringence induced due to an electric field.

2. The liquid crystal composition according to Item 1, which is used for optical switching in which the retardation is controlled such that it is 0 to λ/2 by applying a voltage.

3. The liquid crystal composition according to Item 1, which is used for switching between right circularly polarized light and left circularly polarized light.

4. The liquid crystal composition according to any one of Items 1 to 3,
wherein the achiral component T contains at least one Compound 1 represented by Formula (1):

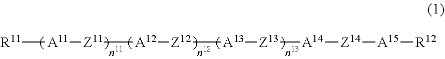

in the formula, R¹¹ is a hydrogen atom or an alkyl group having 1 to 20 carbon atoms, and at least one —CH₂— in the alkyl group is optionally replaced with —O—, —S—, —COO—, —OCO—, —CH═CH—, —CF═CF—, or —C≡C—, and at least one hydrogen atom in the alkyl group is optionally replaced with a halogen atom; R¹² is a hydrogen atom, a halogen atom, —C≡N, —N═C≡O, —N═C≡S, —CF₃, —OCF₃, or an alkyl group having 1 to 3 carbon atoms, and at least one —CH₂— in the alkyl group is optionally replaced with —O—, —S—, —COO—, —OCO—, —CH═CH—, —CF═CF—, or —C≡C—, at least one hydrogen atom in the alkyl group is optionally replaced with a halogen atom, and at least one —CH₃ in the alkyl group is optionally replaced with —C≡N; rings A¹¹ to A¹⁵ are independently a 5- to 8-membered ring or a condensed ring having 9 or more carbon atoms, and at least one hydrogen atom in these rings is optionally replaced with a halogen atom, an alkyl group having 1 to 5 carbon atoms, or an alkyl halide, at least one —CH₂— in the alkyl group or the alkyl halide is optionally replaced with —O—, —S—, or —NH—, at least one —CH₂— in these rings is optionally replaced with —O—, —S—, or —NH—, and at least one —CH═ in these rings is optionally replaced with —N═; Z¹¹ to Z¹⁴ are independently a single bond or an alkylene group having 1 to 8 carbon atoms, and at least one —CH₂— in the alkylene group is optionally replaced with —O—, —S—, —COO—, —OCO—, —CSO—, —OCS—, —N═N—, —CH═N—, —N═CH—, —N(O)═N—, —N═N(O)—, —CH═CH—, —CF═CF—, or —C≡C—, and at least one hydrogen atom in the alkylene group is optionally replaced with a halogen atom; and n¹¹ to n¹³ are independently 0 or 1.

5. The liquid crystal composition according to Item 4,
wherein, in Formula (1), n¹¹+n¹²+n¹³ is 2 or 3, A¹¹ to A¹⁴ are selected from among the group consisting of groups represented by the following Formulae (A-1) to (A-10), A¹⁵ is selected from among the group consisting of groups represented by (A-1) to (A-3), and the total number of halogen atoms in A¹¹ to A¹⁵ is 6 or more:

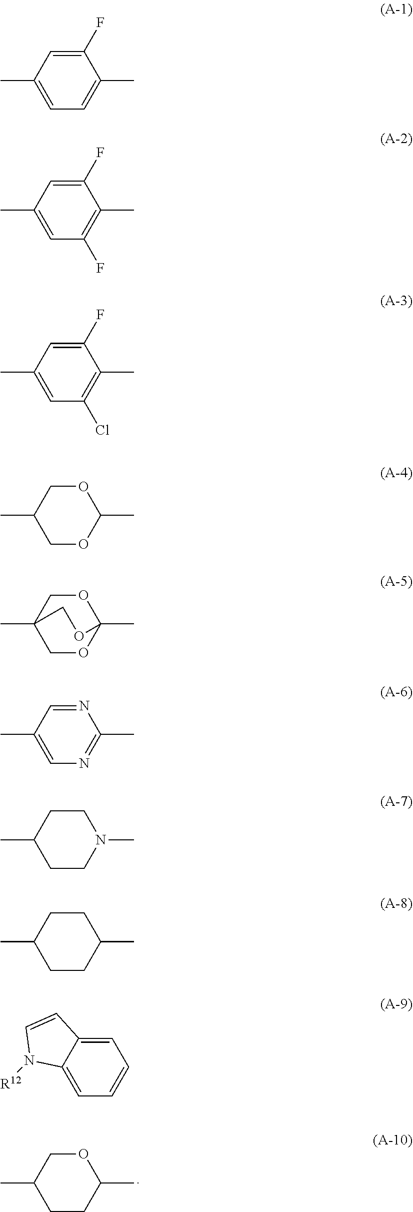

6. The liquid crystal composition according to any one of Items 1 to 5,
wherein the achiral component T contains at least one Compound 2 represented by Formula (2):

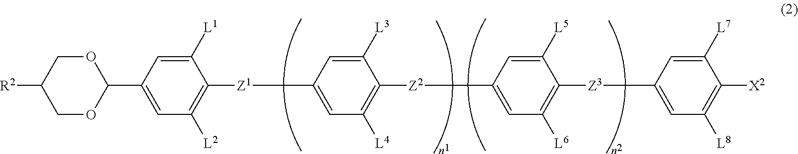

in Formula (2), R² is a hydrogen atom, an alkyl group having 1 to 20 carbon atoms an alkenyl group having 2 to 20 carbon atoms, an alkynyl group having 2 to 20 carbon atoms, an alkoxy group having 1 to 19 carbon atoms, or an alkoxyalkyl group having 1 to 20 carbon atoms in total, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R², —O— and —CH═CH—, and —CO— and —CH═CH— are not adjacent to each other;
Z¹ to Z³ are independently a single bond, —COO— or —CF₂O—, and at least one thereof is —COO— or —CF₂O—;
L¹ to L⁸ are independently a hydrogen atom or a fluorine atom; and
n¹ and n² are independently 0 or 1; and
X² is a hydrogen atom, a halogen atom, —SF₅ or an alkyl group having 1 to 10 carbon atoms, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C— is optionally replaced with a fluorine atom or a chlorine atom, where, in X², —O— and —CH═CH—, and —CO— and —CH═CH— are not adjacent to each other.

7. The liquid crystal composition according to any one of Items 1 to 6,
wherein the achiral component T contains at least one Compound 3 represented by Formula (3):

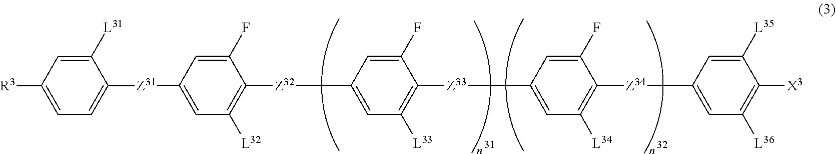

in Formula (3), R³ is a hydrogen atom, an alkyl group having 1 to 20 carbon atoms, an alkenyl group having 2 to 20 carbon atoms, an alkynyl group having 2 to 20 carbon atoms, an alkoxy group having 1 to 19 carbon atoms, or an alkoxyalkyl group having 1 to 20 carbon atoms in total, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R³, —O— and —CH═CH—, and —CO— and —CH═CH— are not adjacent to each other;
Z³¹ to Z³⁴ are independently a single bond, —COO— or —CF₂O—, and at least one thereof is —COO— or —CF₂O—;
L³¹ to L³⁶ are independently a hydrogen atom or a fluorine atom;
X³ is a hydrogen atom, a halogen atom, —SF₅ or an alkyl group having 1 to 10 carbon atoms, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C— is optionally replaced with a fluorine atom or a chlorine atom, where, in X³, —O— and —CH═CH—, and —CO— and —CH═CH— are not adjacent to each other; and
n³¹ and n³² are independently 0 or 1.

8. The liquid crystal composition according to Item 7,
wherein a total amount of Compound 2 contained is 25 weight % to 90 weight %, and a total amount of Compound 3 contained is 5 weight % to 65 weight % with respect to the total weight of the achiral component T.

9. The liquid crystal composition according to any one of Items 1 to 8, containing a chiral agent.

10. The liquid crystal composition according to any one of Items 1 to 9, containing one or more compounds selected from the group consisting of an antioxidant and a UV absorber.

11. A mixture including the liquid crystal composition according to any of Items 1 to 10 and polymerizable monomers.

12. A polymer/liquid crystal composite material which is used for an element that is driven in an optically isotropic liquid crystal phase and obtained by polymerizing the mixture according to Item 11.

13. The polymer/liquid crystal composite material according to Item 12, which is obtained by polymerizing the mixture according to Item 11 in a temperature range of a non-liquid crystalline isotropic phase or an optically isotropic liquid crystal phase.

14. An element including:
the liquid crystal composition according to any one of Items 1 to 10, the mixture according to Item 11, or the polymer/liquid crystal composite material according to Item 12 or 13.

15. The element according to Item 14 which is able to be used with respect to light in a near infrared range (0.72 to 2.5 μm).

16. The element according to Item 14, which is able to be used with respect to light in a millimeter wave range (1 to 10 mm).

17. A LIDAR including at least one of the elements according to Item 14.

### BRIEF DESCRIPTION OF THE DRAWINGS

FIG. 1 illustrates an optical system used in the examples.

### DESCRIPTION OF THE EMBODIMENTS

A preferable liquid crystal composition and polymer/liquid crystal composite material of the disclosure contain the compound of Formula (1) and thus have stability with respect to heat, light or the like, a high upper limit temperature and a low lower limit temperature of the optically isotropic liquid crystal phase, and have large dielectric anisotropy and refractive index anisotropy.

A preferable form of a polymer/liquid crystal composite material of the disclosure has a high upper limit temperature and a low lower limit temperature of the optically isotropic liquid crystal phase, and an element using the optically isotropic liquid crystal phase can be suitably used for controlling polarization. In addition, the element using the preferable form of the optically isotropic liquid crystal phase of the disclosure can be used in a wide temperature range and can achieve a fast electro-optical response.

In this specification, a “liquid crystal compound” represents a compound having a mesogen, and is not limited to a compound having a liquid crystal phase, and specifically, is a general term for a compound having a liquid crystal phase such as a nematic phase or a smectic phase and a compound which does not have a liquid crystal phase and is beneficial as a component of a liquid crystal composition.

A “liquid crystal medium” is a general term for a liquid crystal composition and a polymer/liquid crystal composite.

An “achiral component” is an achiral mesogenic compound and is a component not including an optically active compound and a compound having a polymerizable functional group. Therefore, the “achiral component” does not include a polymerization initiator, a curing agent, and a stabilizer such as a chiral agent and a polymerizable monomer.

A “chiral agent” is an optically active compound, and is a component used in order to add a desired twisted molecular arrangement to a liquid crystal composition.

An “element” abstractly represents an object that performs a required function and an element related to properties of light is called an optical element or light element. In addition, an element using a liquid crystal medium based on a material used is called a liquid crystal element in some cases.

An “optical element” refers to various elements that perform functions such as optical modulation and optical switching using an electrooptic effect, and examples thereof include a display element (liquid crystal display element), an optical communication system, and an optical modulation element and an optical switching element used for optical information processing and various sensor systems.

In addition, an “optical switching element” is an element that turns an optical signal on and off and distributes it, and switches a path for light without converting an optical signal into an electrical signal.

A change in the refractive index due to application of a voltage to an optically isotropic liquid crystal medium is known as a Kerr effect. The Kerr effect is a phenomenon in which an electric birefringence value Δn(E) is proportional to the square of an electric field E, and Δn(E)=KλE² is established in a material providing the Kerr effect (K: Kerr coefficient (Kerr constant), λ: wavelength)). Here, the electric birefringence value is a refractive index anisotropy value induced when an electric field is applied to an isotropic medium.

“Selective reflection” refers to a phenomenon in which one of left and right circularly polarized light components of light incident parallel to a helical axis of a chiral nematic liquid crystal or a cholesteric liquid crystal is specifically reflected.

A “liquid crystal compound,” and a “liquid crystal composition” may be abbreviated as a “compound” and a “composition.”

In addition, for example, an upper limit temperature of a liquid crystal phase is a phase transition temperature of a liquid crystal phase-isotropic phase, and may be abbreviated simply as a clearing point or an upper limit temperature. A lower limit temperature of a liquid crystal phase may be abbreviated simply as a lower limit temperature. In addition, an upper limit temperature of an optically isotropic liquid crystal phase, for example, a blue phase, is a phase transition temperature of a blue phase-isotropic phase, and a lower limit temperature of a blue phase is a phase transition temperature of a blue phase-crystal.

A compound represented by Formula (1) may be abbreviated as Compound 1. This abbreviation may also apply to a compound represented by Formula (2) and the like. In Formulae (2) to (13), symbols such as A⁴¹, A⁵, A⁷¹, A⁸¹, A¹¹¹, and A¹³¹ surrounded by a hexagon correspond to the ring A⁴¹, ring A⁵, ring A⁷¹, ring A⁸¹, ring A¹¹¹, and ring A¹³¹. An amount of a compound expressed as a percentage is a weight percentage (weight %) based on a total weight of a composition. A plurality of the same symbols such as rings A⁵ and Z⁵ may be shown in the same formula or different formulae, and they may be the same as or different from each other.

In this specification, specific examples of an “alkyl group” include —CH₃, —C₂H₅, —C₃H₇, —C₄H₉, —C₅H₁₁, —C₆H₁₃, —C₇H₁₅, —C₈H₁₇, —C₉H₁₉, —C₁₀H₂₁, —C₁₁H₂₃, —C₁₂H₂₅, —C₁₃H₂₇, —C₁₄H₂₉, and —C₁₅H₃₁. A methyl group, an ethyl group, a propyl group, a butyl group, a pentyl group, a hexyl group, a heptyl group and an octyl group are preferable. In order to lower the viscosity, an ethyl group, a propyl group, a butyl group, a pentyl group, and a heptyl group are more preferable.

In this specification, specific examples of an “alkyl group in which at least one hydrogen atom is replaced with a halogen atom” include —CH₂F, —CHF₂, —CF₃, —(CH₂)₂—F, —CF₂CH₂F, —CF₂CHF₂, —CH₂CF₃, —CF₂CF₃, —(CH₂)₃—F, —(CF₂)₃—F, —CF₂CHFCF₃, —CHFCF₂CF₃, —(CH₂)₄—F, —(CF₂)₄—F, —(CH₂)₅—F, and —(CF₂)₅—F.

In this specification, specific examples of an “alkoxy group” include —OCH₃, —OC₂H₅, —OC₃H₇, —OC₄H₉, —OC₅H₁₁, —OC₆H₁₃ and —OC₇H₁₅, —OC₈H₁₇, —OC₉H₁₉, —OC₁₀H₂₁, —OC₁₁H₂₃, —OC₁₂H₂₅, —OC₁₃H₂₇, and —OC₁₄H₂₉. A methoxy group, an ethoxy group, a propoxy group, a butoxy group, a pentyloxy group, a hexyloxy group, and a heptyloxy group are preferable. In order to lower the viscosity, a methoxy group and an ethoxy group are more preferable.

In this specification, specific examples of an “alkoxy group in which at least one hydrogen atom is replaced with a halogen atom” include —OCH₂F, —OCHF₂, —OCF₃, —O—(CH₂)₂—F, —OCF₂CH₂F, —OCF₂CHF₂, —OCH₂CF₃, —O—(CH₂)₃—F, —O—(CF₂)₃—F, —OCF₂CHFCF₃, —OCHFCF₂CF₃, —O(CH₂)₄—F, —O—(CF₂)₄—F, —O—(CH₂)₅—F, and —O—(CF₂)₅—F.

In this specification, specific examples of an “alkenyl group” include —CH═CH₂, —CH═CHCH₃, —CH₂CH═CH₂, —CH═CHC₂H₅, —CH₂CH═CHCH₃, —(CH₂)₂—CH═CH₂, —CH═CHC₃H₇, —CH₂CH═CHC₂H₅, —(CH₂)₂—CH═CHCH₃, and —(CH₂)₃—CH═CH₂. A vinyl group, a 1-propenyl group, a 2-propenyl group, a 1-butenyl group, a 2-butenyl group, a 3-butenyl group, a 1-pentenyl group, a 2-pentenyl group, a 3-pentenyl group, a 4-pentenyl group, a 1-hexenyl group, a 2-hexenyl group, a 3-hexenyl group, a 4-hexenyl group, and a 5-hexenyl group are preferable. In order to lower the viscosity, a vinyl group, a 1-propenyl group, a 3-butenyl group, and a 3-pentenyl group are more preferable.

In this specification, specific examples of an “alkenyl group in which at least one hydrogen atom is replaced with a halogen atom” include —CH═CHF, —CH═CF₂, —CF═CHF, —CH═CHCH₂F, —CH═CHCF₃, —(CH₂)₂—CH═CF₂, —CH₂CH═CHCF₃, —CH═CHCF₃, and —CH═CHCF₂CF₃. In order to lower the viscosity of the composition, —CH═CF₂, and —(CH₂)₂—CH═CF₂ are preferable.

In this specification, a preferable configuration of —CH═CH— in the alkenyl group depends on the position of a double bond. A trans configuration is preferable for an alkenyl having double bonds at odd-numbered positions such as —CH═CHCH₃, —CH═CHC₂H₅, —CH═CHC₃H₇, —CH═CHC₄H₉, —C₂H₄CH═CHCH₃, and —C₂H₄CH═CHC₂H₅. A cis configuration is preferable for an alkenyl group having double bonds at even-numbered positions such a —CH₂CH═CHCH₃, —CH₂CH═CHC₂H₅, and —CH₂CH═CHC₃H₇. Alkenyl compounds having a preferable configuration have a high upper limit temperature and a wide temperature range of a liquid crystal phase. Details are described in Mol. Cryst. Liq. Cryst., 1985, 131, 109 and Mol. Cryst. Liq. Cryst., 1985, 131, 327.

In this specification, specific examples of an “alkoxyalkyl group” include —CH₂OCH₃, —CH₂OC₂H₅, —CH₂OC₃H₇, —(CH₂)₂—OCH₃, —(CH₂)₂—OC₂H₅, —(CH₂)₂—OC₃H₇, —(CH₂)₃—OCH₃, —(CH₂)₄—OCH₃, and —(CH₂)₅—OCH₃.

In this specification, specific examples of an “alkenyloxy group” include —OCH₂CH═CH₂, —OCH₂CH═CHCH₃, and —OCH₂CH═CHC₂H₅.

In this specification, specific examples of an “alkynyl group” include —C≡CH, —C≡CCH₃, —CH₂C≡CH, —C≡CC₂H₅, —CH₂C≡CCH₃, —(CH₂)₂—C≡CH, —C≡CC₃H₇, —CH₂C≡CC₂H₅, —(CH₂)₂—C≡CCH₃, and —C≡C(CH₂)₅.

In this specification, specific examples of a “halogen atom” include a fluorine atom, a chlorine atom, a bromine atom, and an iodine atom.

The liquid crystal composition of the disclosure is a composition which contains an achiral component T and a chiral agent and exhibits an optically isotropic liquid crystal phase. The liquid crystal composition of the disclosure may further contain a solvent, a polymerizable monomer and the like to be described below (item 5-2-1 and item 5-2-2), a polymerization initiator (item 5-2-3), a curing agent (item 5-2-4), a stabilizer (such as an antioxidant and a UV absorber; item 5-2-4) and the like in addition to the achiral component T and the chiral agent.

1. Achiral Component T

The achiral component T contains at least one Compound 1. A preferable achiral component T contains Compound 2 included with at least one Compound 1 and Compound 3 included with at least one Compound 1.

A form of the liquid crystal composition of the disclosure is a composition containing Compound 2 and Compound 3, and other components of which component names are not specifically shown in this specification. A more preferable form is a composition containing Compound 2, Compound 3 and Compounds 4 to 13 to be described below, and other components of which component names are not specifically shown in this specification.

The achiral component T of the disclosure may contain one compound or two or more compounds among Compounds 1 to 13. That is, the liquid crystal composition of the disclosure may contain a plurality of Compounds 1 having different structures and represented by Formula (1) as Compound 1. This also applies to Compounds 2 to 13.

1-1. Liquid Crystal Medium

### 1-1-1. Compound 1

A liquid crystal medium used in the element of the disclosure is a liquid crystal medium that exhibits an optically isotropic liquid crystal phase, for example, a blue phase. The liquid crystal medium used in the element of the disclosure contains at least one or two or more compounds of Formula (1)

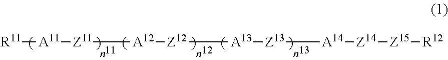

In Formula (1), R¹¹ is a hydrogen atom or an alkyl group having 1 to 20 carbon atoms, and at least one —CH₂— in the alkyl group is optionally replaced with —O—, —S—, —COO—, —OCO—, —CH═CH—, —CF═CF—, or —C≡C—, at least one hydrogen atom in the alkyl group is optionally replaced with a halogen atom;

R¹² is a hydrogen atom, a halogen atom, —C≡N, —N═C≡O, —N═C≡S, —CF₃, —OCF₃, or an alkyl group having 1 to 3 carbon atoms, and at least one —CH₂— in the alkyl group is optionally replaced with —O—, —S—, —COO—, —OCO—, —CH═CH—, —CF═CF—, or —C≡C—, at least one hydrogen atom in the alkyl group is optionally replaced with a halogen atom, and at least one —CH₃ in the alkyl group is optionally replaced with —C≡N;

Rings A¹¹ to A¹⁵ are independently a 5- to 8-membered ring or a condensed ring having 9 or more carbon atoms, and at least one hydrogen atom in these rings is optionally replaced with a halogen atom, an alkyl group having 1 to 5 carbon atoms, or an alkyl halide, at least one —CH₂— in the alkyl group or the alkyl halide is optionally replaced with —O—, —S—, or —NH—, at least one —CH₂— in these rings is optionally replaced with —O—, —S—, or —NH—, and at least one —CH═ in these rings is optionally replaced with —N═;

Z¹¹ to Z¹⁴ are independently a single bond or an alkylene group having 1 to 8 carbon atoms, and at least one —CH₂— in the alkylene group is optionally replaced with —O—, —S—, —COO—, —OCO—, —CSO—, —OCS—, —N═N—, —CH═N—, —N═CH—, —N(O)═N—, —N═N(O)—, —CH═CH—, —CF═CF—, or —C≡C—, and at least one hydrogen atom in the alkylene group is optionally replaced with a halogen atom; and

n¹¹ to n¹³ are independently 0 or 1.

In Formula (1), preferably, R¹¹ is an alkyl group having 1 to 7 carbon atoms, and at least one —CH₂— in the alkyl group is optionally replaced with —O—, —CH═CH—, or —C≡C—, and at least one hydrogen atom in the alkyl group is optionally replaced with a halogen atom.

Preferably, the rings A¹¹ to A¹⁴ are rings selected from among the group consisting of the following Formulae (A-1) to (A-10). Preferably, the ring A¹⁵ is a ring selected from among the group consisting of the following Formulae (A-1) to (A-3).

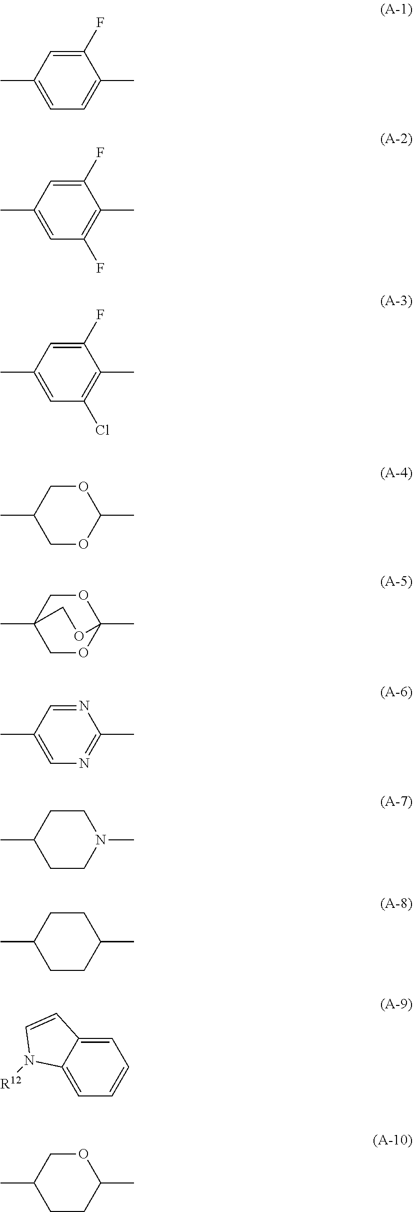

Preferably, Z¹¹ to Z¹⁴ are independently a single bond, —COO—, or —CF₂O—. More preferably, at least one of Z¹¹ to Z¹⁴ is —COO— or —CF₂O—.

Preferably, a sum (n¹¹+n¹²+n¹³) of n¹¹ to n¹³ is 2 or 3.

Preferably, X¹ is a halogen atom, —C≡N, —N═C≡S, —CF₃, —OCF₃, or an alkyl group having 1 to 3 carbon atoms, and at least one hydrogen atom in the alkyl group is optionally replaced with a halogen atom.

In addition, the liquid crystal medium used in the element of the disclosure may contain 60 weight % or more, and preferably 80 weight % or more of at least one or two or more compounds selected from among the group consisting of compounds represented by the following Formulae (1-2) and (1-3) with respect to the total weight of the achiral component T.

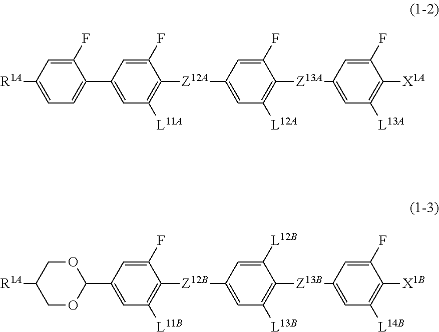

In Formula (1-2), R^{1A} is an alkyl group having 1 to 12 carbon atoms, an alkenyl group having 2 to 12 carbon atoms, or an alkoxy group having 1 to 11 carbon atoms, Z^{12A} and Z^{13A} are independently a single bond, —COO—, or —CF₂O—, L^{11A}, L^{12A} and L^{13A} are independently a hydrogen atom or a fluorine atom, and X^{1A} is a fluorine atom, a chlorine atom, —CF₃, or —OCF₃.

In addition, in Formula (1-3), R^{1B} is an alkyl group having 1 to 12 carbon atoms or an alkoxyalkyl group having 1 to 11 carbon atoms, Z^{12B} and Z^{13B} are independently a single bond, —COO—, or —CF₂O—, L^{11B}, L^{12B}, L^{13B} and L^{14B} are independently a hydrogen atom or a fluorine atom, and X^{1B} is a fluorine atom, a chlorine atom, —CF₃, or —OCF₃.

### 1-1-2. Compound 2

The liquid crystal medium used in the element of the disclosure may contain at least one or two or more Compounds 2 represented by the following Formula (2).

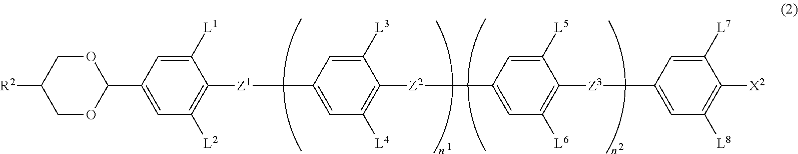

In Formula (2), R² is a hydrogen atom, an alkyl group having 1 to 20 carbon atoms, an alkenyl group having 2 to 20 carbon atoms, an alkynyl group having 2 to 20 carbon atoms, an alkoxy group having 1 to 19 carbon atoms, or an alkoxyalkyl group having 1 to 20 carbon atoms in total, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R², —O— and —CH═CH—, and —CO— and —CH═CH— are not adjacent to each other;

Z¹ to Z³ are independently a single bond, —COO— or —CF₂O—, and at least one thereof is —COO— or —CF₂O—;

L¹ to L⁸ are independently a hydrogen atom or a fluorine atom; and

n¹ and n² are independently 0 or 1; and

X² is a hydrogen atom, a halogen atom, —SF₅ or an alkyl group having 1 to 10 carbon atoms, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C— is optionally replaced with a fluorine atom or a chlorine atom, where, in X², —O— and —CH═CH—, and —CO— and —CH═CH— are not adjacent to each other.

When R² in Formula (2) is a hydrogen atom, a methyl group, or an ethyl group, this contributes greatly to reducing a driving voltage compared to a compound in which R² is an alkyl group having 3 or more carbon atoms. In addition, a compound in which R² is a methyl group has a higher clearing point than a compound in which R² is a hydrogen atom.

When X² in Formula (2) is a fluorine atom, a chlorine atom, —SF₅, —CF₃, —OCF₃, or —CH═CH—CF₃, the dielectric anisotropy is large. When X² is a fluorine group, —CF₃, or —OCF₃, Compound 2 is chemically stable. Preferably, specific examples of X² include a fluorine atom, a chlorine atom, —CF₃, —CHF₂, —OCF₃ and —OCHF₂. More preferably, examples of X² include a fluorine atom, a chlorine atom, —CF₃ and —OCF₃. When X² is a chlorine atom or a fluorine atom, Compound 2 has a low melting point and particularly excellent compatibility with other liquid crystal compounds. When X² is —CF₃, —CHF₂, —OCF₃ or —OCHF₂, the compound exhibits particularly large dielectric anisotropy.

As Compound 2, compounds represented by Formulae (2-1) to (2-9) are preferable.

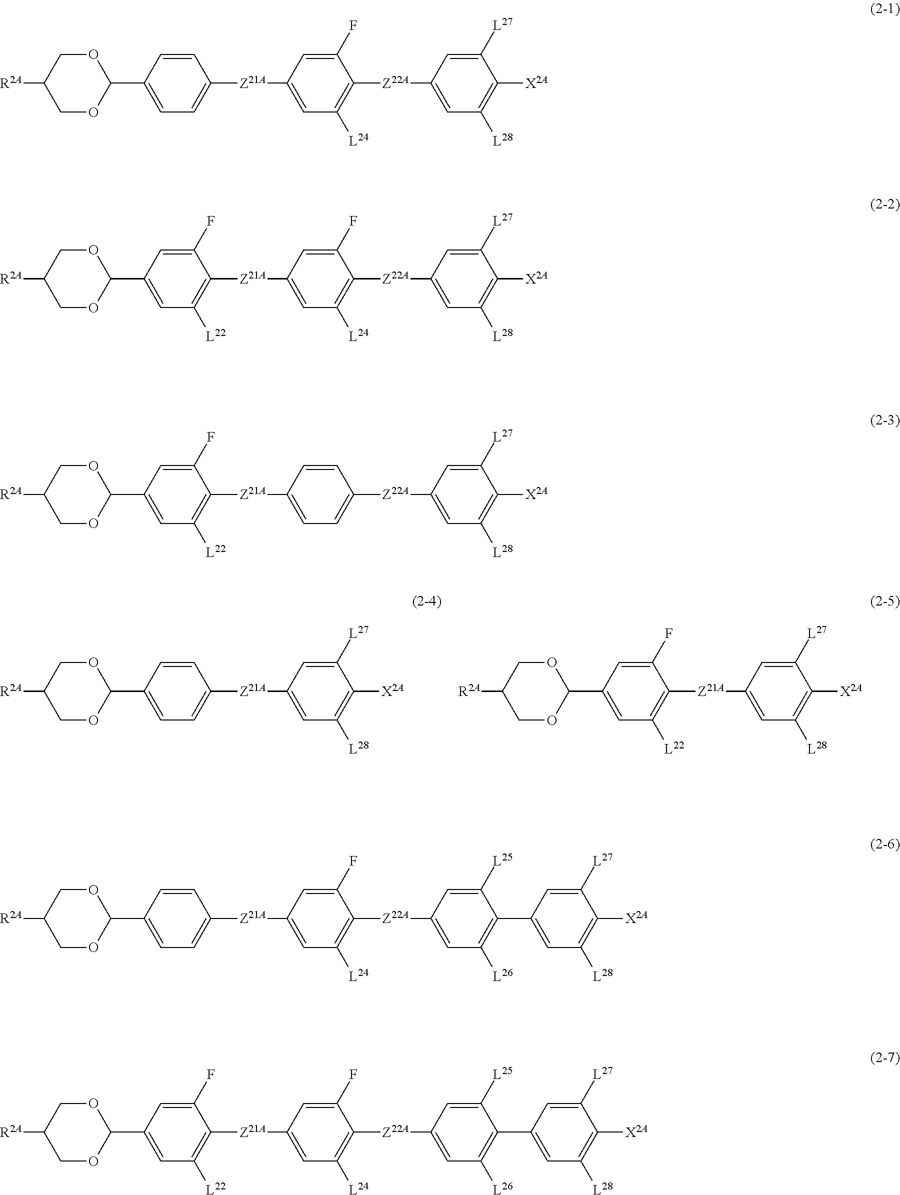

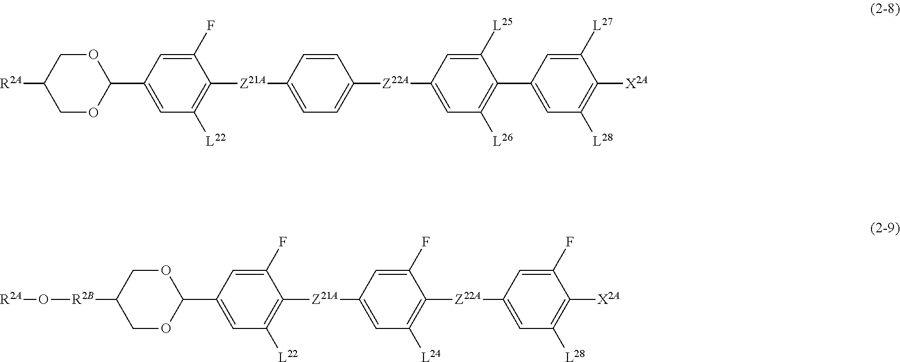

In Formulae (2-1) to (2-9), R^{2A} is an alkyl group having 1 to 12 carbon atoms, an alkoxy group having 1 to 12 carbon atoms, an alkenyl group having 2 to 12 carbon atoms or an alkenyl group having 2 to 12 carbon atoms in which at least one hydrogen atom is optionally replaced with a fluorine atom;

R^{2B} is an alkylene group having 1 to 5 carbon atoms, an alkenylene group having 2 to 5 carbon atoms, or an alkynylene group having 2 to 5 carbon atoms.

A compound in which R^{2A} in Formulae (2-1) to (2-9) is a hydrogen atom, a methyl group, or an ethyl group, and R^{2B} is a methylene or ethylene group having 1 or 2 carbon atoms contributes greatly to reducing a driving voltage.

In addition, a compound in which R^{2A} is an ethyl group and R^{2B} is a methylene group is a compound having an improved effect of lowering a driving voltage.

Z^{21A} and Z^{22A} are independently a single bond, —COO— or —CF₂O—, and at least one thereof is —COO— or —CF₂O—, and in Formulae (2-4) and (2-5), Z^{21A} is —COO— or —CF₂O—;

L²², L²⁴ to L²⁸ are independently a hydrogen atom or a fluorine atom;

X^{2A} is a fluorine atom, a chlorine atom, —CF₃ or —OCF₃.

As Compound 2, compounds represented by Formulae (2-1-1), (2-1-2), (2-2-1) to (2-2-5), (2-3-1), (2-3-2), (2-4-1), (2-5-1), and (2-5-2), and (2-9-1) to (2-9-6) are preferable, and compounds represented by Formulae (2-2-1) to (2-2-5), and (2-9-2) to (2-9-5) are more preferable.

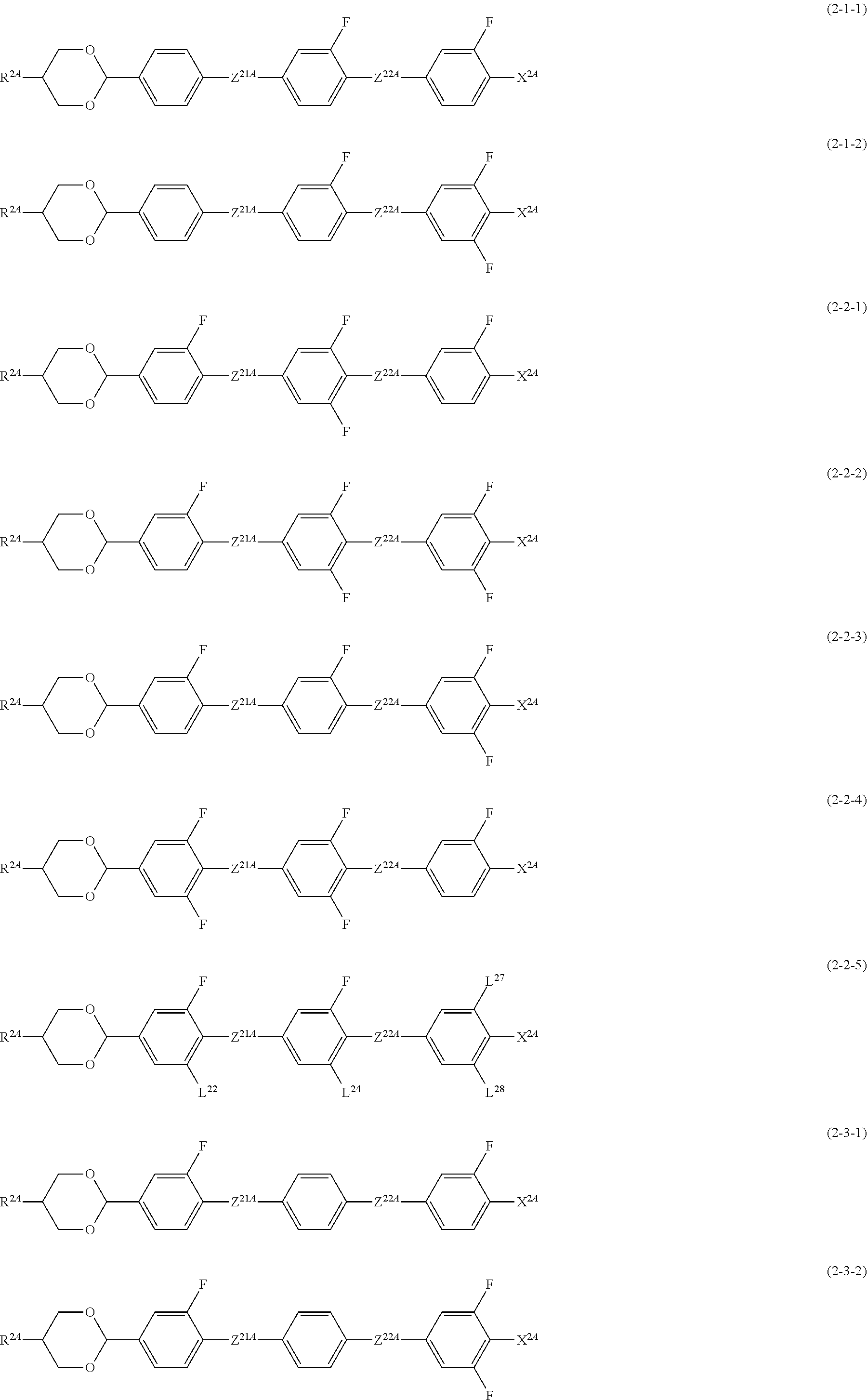

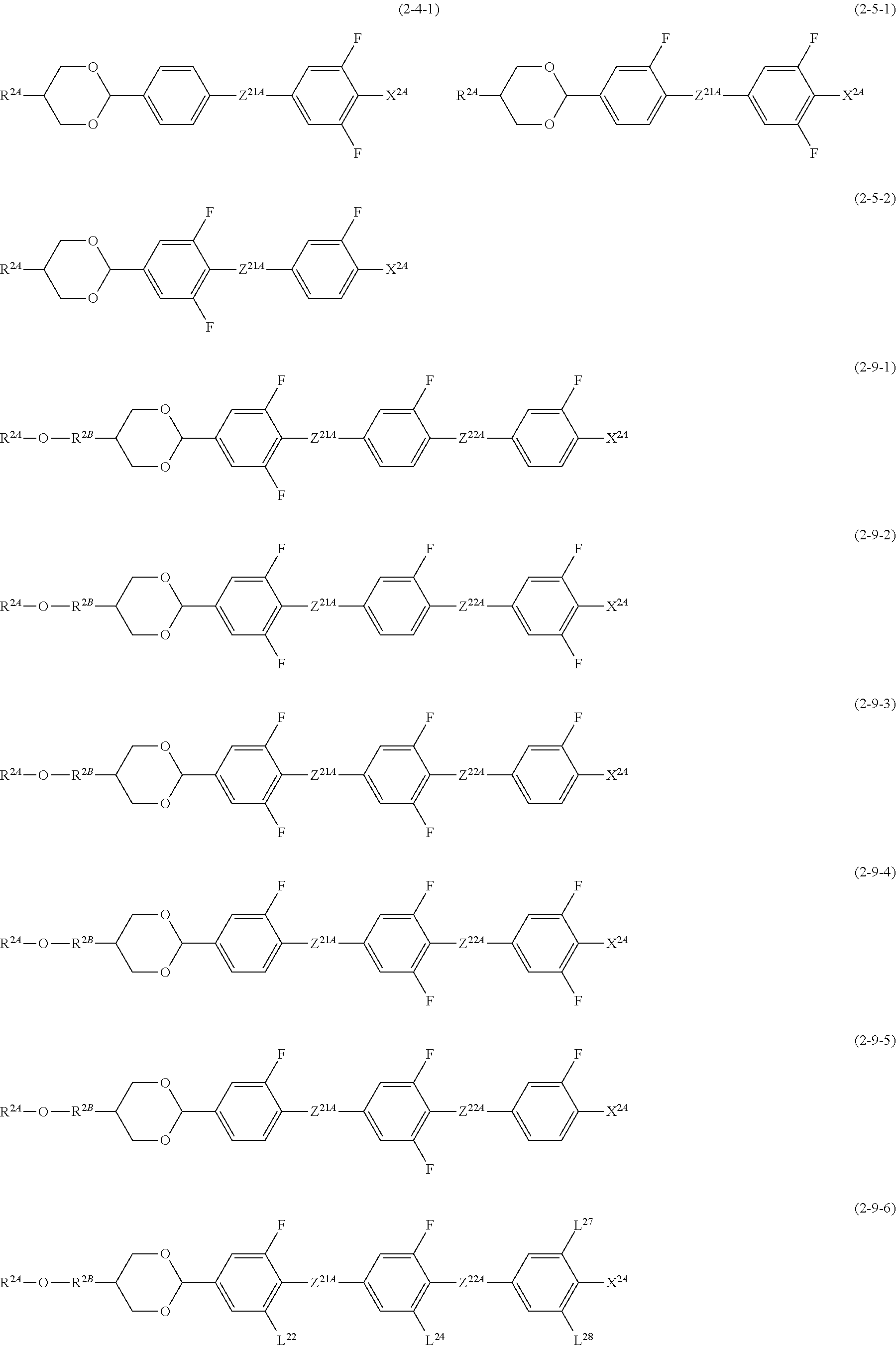

In Formulae (2-1-1), (2-1-2), (2-2-1) to (2-2-5), (2-3-1), (2-3-2), (2-4-1), (2-5-1), (2-5-2), and (2-9-1) to (2-9-6), R^{2A} is an alkyl group having 1 to 12 carbon atoms, an alkoxy group having 1 to 12 carbon atoms, an alkenyl group having 2 to 12 carbon atoms or an alkenyl group having 2 to 12 carbon atoms in which at least one hydrogen atom is optionally replaced with a fluorine atom;

R^{2B} is an alkylene group having 1 to 5 carbon atoms, an alkenylene group having 2 to 5 carbon atoms, or an alkynylene group having 2 to 5 carbon atoms,

Z^{21A} and Z^{22A} are independently a single bond, —COO— or —CF₂O—, and at least one thereof is —COO— or —CF₂O—, and in Formulae (2-4-1), (2-5-1) and (2-5-2), Z^{21A} is —COO— or —CF₂O—;

L²², L²⁴, L²⁷, L²⁸ are independently a hydrogen atom or a fluorine atom;

X^{2A} is a fluorine atom, a chlorine atom, —CF₃ or —OCF₃.

In the disclosure, in the achiral component T, one compound may be contained and two or more compounds may be contained as Compound 2. When two or more compounds represented by Formulae (2-1) to (2-9) are included as Compound 2, a combination of a compound in which Z^{21A} is a single bond, Z^{22A} is —CF₂O—, and L²², L²⁴, L²⁷ and L²⁸ are a fluorine atom, and a compound in which Z^{21A} is —CF₂O—, Z^{22A} is a single bond, L²², L²⁷ and L²⁸ are a fluorine atom, and L²⁴ is a hydrogen atom in the compound represented by Formula (2-2-5) is preferable.

A total amount of Compound 2 contained with respect to the total weight of the achiral component T is preferably 25 weight % to 90 weight %, more preferably 35 weight % to 85 weight %, and particularly preferably 45 weight % to 80 weight %.

Compound 2 is physically and chemically very stable under conditions in which elements are generally used and has relatively favorable compatibility with other compounds. A composition containing this compound is stable under conditions in which elements are generally used. Therefore, when Compound 2 is used in the liquid crystal composition, a temperature range of the optically isotropic liquid crystal phase can be widened, and the compound can be used for an element in a wide temperature range.

In addition, since Compound 2 has large dielectric anisotropy and relatively large refractive index anisotropy, it is beneficial as a component for lowering a driving voltage of the liquid crystal composition driven in the optically isotropic liquid crystal phase.

### 1-1-3. Compound 3

The liquid crystal medium used in the element of the disclosure may contain at least one or two or more Compounds 3 represented by the following Formula (3).

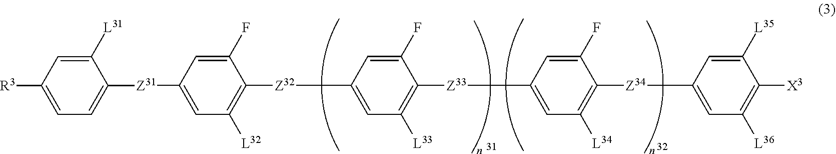

In Formula (3), R³ is a hydrogen atom, an alkyl group having 1 to 20 carbon atoms, an alkenyl group having 2 to 20 carbon atoms, an alkynyl group having 2 to 20 carbon atoms, an alkoxy group having 1 to 19 carbon atoms, or an alkoxyalkyl group having 1 to 20 carbon atoms in total, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R³, —O— and —CH═CH—, and —CO— and —CH═CH— are not adjacent to each other;

Z³¹ to Z³⁴ are independently a single bond, —COO— or —CF₂O—, and at least one thereof is —COO— or —CF₂O—;

L³¹ to L³⁶ are independently a hydrogen atom or a fluorine atom;

X³ is a hydrogen atom, a halogen atom, —SF₅ or an alkyl group having 1 to 10 carbon atoms, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C— is optionally replaced with a fluorine atom or a chlorine atom, where, in X³, —O— and —CH═CH—, and —CO— and —CH═CH— are not adjacent to each other; and

n³¹ and n³² are independently 0 or 1.

Compound 3 has 4 or 5 benzene rings and has at least one —CF₂O— linking group. Compound 3 is physically and chemically very stable under conditions in which elements are generally used and has favorable compatibility with other liquid crystal compounds. A composition containing this compound is stable under conditions in which elements are generally used. Therefore, a temperature range of a nematic phase in the composition can be widened, and the compound can be used for a display element in a wide temperature range. In addition, since the compound has large dielectric anisotropy and refractive index anisotropy, it is beneficial as a component for lowering a driving voltage of the composition driven in the optically isotropic liquid crystal phase.

When R³ in Formula (3), groups on a benzene ring (L³¹ to L³⁶ and X³), or binding groups Z³¹ to Z³⁴ are appropriately selected, it is possible to arbitrarily adjust physical properties such as a clearing point, refractive index anisotropy, and dielectric anisotropy.

In Formula (3), Z³¹ to Z³⁴ are independently a single bond, —COO— or —CF₂O—, but at least one thereof is preferably —CF₂O—. When Z³¹ to Z³⁴ are a single bond or —CF₂O—, the viscosity is low, and when Z³¹ to Z³⁴ are —CF₂O—, the dielectric anisotropy is large. When Z³¹ to Z³⁴ in Formula (3) are a single bond or —CF₂O—, the compound is relatively chemically stable and is relatively unlikely to deteriorate.

In Formula (3), L³¹ to L³⁶ are independently a hydrogen atom or a fluorine atom. When the number of fluorine atoms in L³¹ to L³⁶ is large, the dielectric anisotropy is large. When L³⁵ and L³⁶ are both a fluorine atom, the dielectric anisotropy is particularly large.

In Formula (3), X³ is a hydrogen atom, a halogen atom, —SF₅, or an alkyl group having 1 to 10 carbon atoms, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C— is optionally replaced with a fluorine atom or a chlorine atom.

In Formula (3), X³ is preferably a fluorine atom, a chlorine atom, —CF₃, —CHF₂, —OCF₃, and —OCHF₂, and more preferably a fluorine atom, a chlorine atom, —CF₃ and —OCF₃.

When X³ in Formula (3) is a fluorine atom, a chlorine atom, —SF₅, —CF₃, —CHF₂, —CH₂F, —OCF₃, —OCHF₂ or —OCH₂F, the dielectric anisotropy is large. When X³ is a fluorine group, —OCF₃, or —CF₃, the compound is chemically stable.

As Compound 3, compounds represented by Formulae (3-1) to (3-5) are preferable.

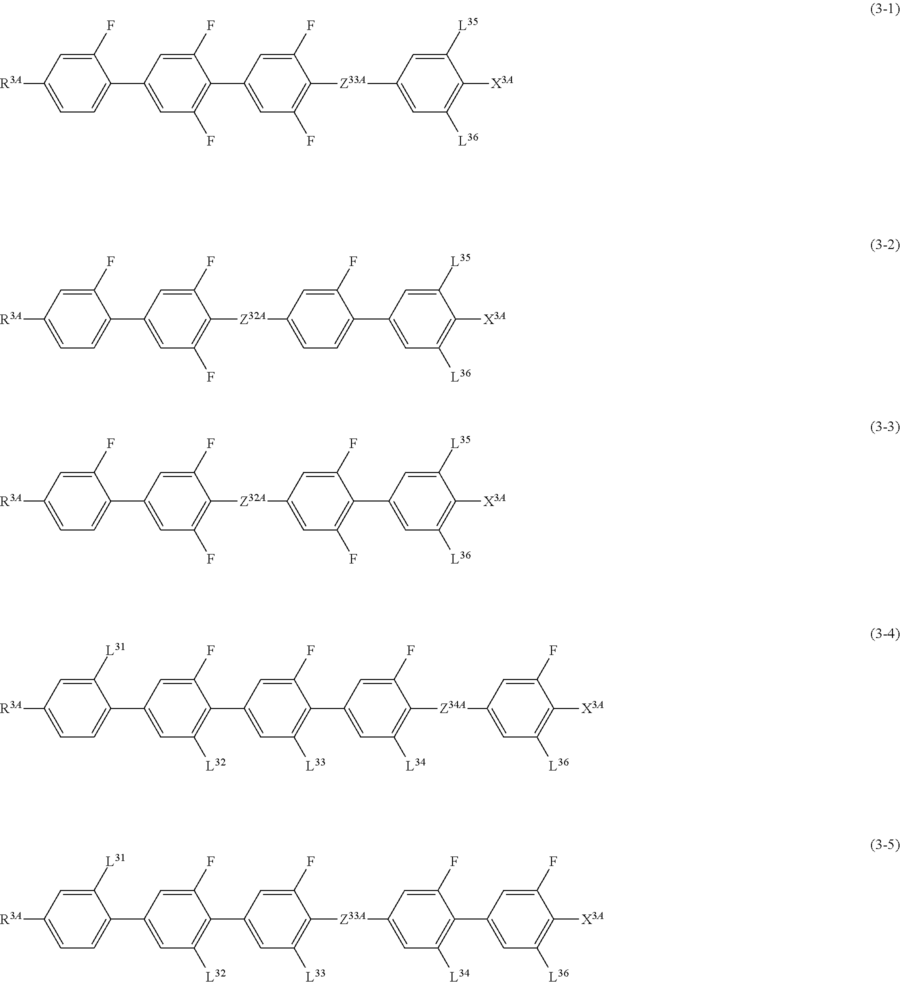

In Formulae (3-1) to (3-5), R^{3A} is an alkyl group having 1 to 12 carbon atoms, an alkoxy group having 1 to 12 carbon atoms, an alkenyl group having 2 to 12 carbon atoms or an alkenyl group having 2 to 12 carbon atoms in which at least one hydrogen atom is optionally replaced with a fluorine atom;

Z^{32A} to Z^{34A} are independently a single bond, —COO— or —CF₂O—, and at least one thereof is —COO— or —CF₂O—;

L³¹ to L³⁶ are independently a hydrogen atom or a fluorine atom;

X^{3A} is a fluorine atom, a chlorine atom, —CF₃ or —OCF₃.

In the disclosure, in the achiral component T, one compound may be included or two or more compounds may be included as Compound 3.

When two or more compounds represented by Formula (3) are included as Compound 3, a combination of a compound in which Z^{33A} is —CF₂O—, and L³⁵ and L³⁶ are a fluorine atom in the compound represented by Formula (3-1) and a compound in which Z^{32A} is —CF₂O—, and L³⁵ and L³⁶ are a fluorine atom in the compound represented by Formula (3-2) is preferable.

A total amount of Compound 3 contained with respect to the total weight of the achiral component T is preferably 5 weight % to 65 weight %, more preferably 10 weight % to 60 weight %, and particularly preferably 15 weight % to 55 weight %.

Compound 3 is physically and chemically very stable under conditions in which elements are generally used and has relatively favorable compatibility with other compounds. A composition containing this compound is stable under conditions in which elements are generally used. Therefore, when Compound 3 is used in the liquid crystal composition, a temperature range of the optically isotropic liquid crystal phase can be widened, and the compound can be used for an element in a wide temperature range.

In addition, since Compound 3 has relatively large dielectric anisotropy and large refractive index anisotropy, it is beneficial as a component for lowering a driving voltage of the liquid crystal composition driven in the optically isotropic liquid crystal phase.

### 1-1-4. Compound 4

The liquid crystal medium used in the element of the disclosure may further contain at least one or two or more Compounds 4 represented by Formula (4).

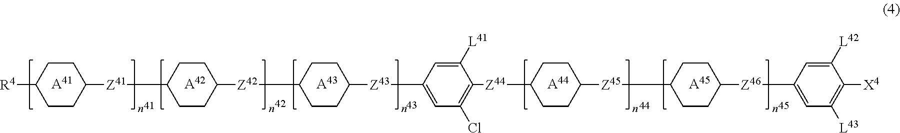

In Formula (4), R⁴ is a hydrogen atom or an alkyl group having 1 to 20 carbon atoms, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R⁴, —O— and —CH═CH—, and —CO— and —CH═CH— are not adjacent to each other;

the ring A⁴¹ to ring A⁴⁵ are independently 1,4-cyclohexylene, 1,3-dioxane-2,5-diyl, 1,4-phenylene, 1,4-phenylene in which one or two hydrogen atoms are replaced with a fluorine atom, 1,4-phenylene in which two hydrogen atoms are replaced with a fluorine atom and a chlorine atom, pyridine-2,5-diyl, or pyrimidine-2,5-diyl;

Z⁴¹ to Z⁴⁶ are independently a single bond or an alkylene group having 1 to 4 carbon atoms, and at least one —CH₂— in the alkylene group is optionally replaced with —O—, —COO— or —CF₂O—;

L⁴¹ to L⁴³ are independently a hydrogen atom or a fluorine atom;

n⁴¹ to n⁴⁵ are independently 0 or 1, and 2≤n⁴¹+n⁴²+n⁴³+n⁴⁴+n⁴5≤3 is established; and

X⁴ is a fluorine atom, a chlorine atom, —CF₃ or —OCF₃.

Compound 4 has a chlorobenzene ring. Compound 4 is physically and chemically very stable under conditions in which elements are generally used and has favorable compatibility with other liquid crystal compounds. In addition, a smectic phase is unlikely to be exhibited. A composition containing this compound is stable under conditions in which elements are generally used. Therefore, a temperature range of a nematic phase in the composition can be widened, and the compound can be used for an element in a wide temperature range. In addition, since the compound has large dielectric anisotropy and refractive index anisotropy, it is beneficial as a component for lowering a driving voltage of the composition driven in the optically isotropic liquid crystal phase.

When a combination of n⁴² to n⁴⁵ in Formula (4), R⁴, groups on the rightmost benzene ring (L⁴², L⁴³ and X⁴), or binding groups Z⁴² to Z⁴⁶ are appropriately selected, it is possible to arbitrarily adjust physical properties such as a clearing point, refractive index anisotropy, and dielectric anisotropy.

In Formula (4), R⁴ is preferably an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is replaced with a fluorine atom.

In consideration of the stability and dielectric anisotropy of the compound, the ring A⁴¹ to ring A⁴⁵ in Formula (4) are preferably 1,4-phenylene or 1,4-phenylene in which one or two hydrogen atoms are replaced with a fluorine atom. When substituents of the rings A⁴¹ to A⁴⁵, and L⁴² and L⁴³ are a hydrogen atom, the melting point is low, and when they are a fluorine atom, the dielectric anisotropy is large.

In Formula (4), Z⁴¹ to Z⁴⁶ are a single bond or an alkylene group having 1 to 4 carbon atoms, and at least one —CH₂— in the alkylene group is optionally replaced with —O—, —COO— or —CF₂O—. In Formula (4), Z⁴¹ to Z⁴⁶ are all a single bond, or at least one thereof is preferably —COO— or —CF₂O—, and when compatibility with other liquid crystal compounds is important, at least one thereof is preferably —CF₂O—.

In Formula (4), X⁴ is a fluorine atom, a chlorine atom, —CF₃, —CHF₂, —CH₂F, —OCF₃, —OCHF₂, —OCH₂F, —OCF₂CFHCF₃ or —CH═CHCF₃, and preferably a fluorine atom, a chlorine atom, —CF₃ or —OCF₃. When X⁴ is a fluorine atom, a chlorine atom, or —OCF₃, compatibility with other liquid crystal compounds at a low temperature is excellent, and when X⁴ is —CF₃, an effect of lowering a driving voltage is improved.

In Formula (4), the compound with n⁴²+n⁴³+n⁴⁴+n⁴⁵=2 has a high clearing point, and the compound with n⁴²+n⁴³+n⁴⁴+n⁴⁵=1 has a low melting point.

Since binding groups Z⁴¹ to Z⁴⁶ in Formula (4) are a single bond or —CF₂O—, the compound is relatively chemically stable, and deterioration is relatively unlikely to occur. In addition, when the binding group is a single bond, the viscosity is low. In addition, when the binding group is —CF₂O—, the dielectric anisotropy is large.

Compound 4 has favorable compatibility, large dielectric anisotropy, and large refractive index anisotropy.

A total amount of Compound 4 contained with respect to the total weight of the achiral component T is preferably 0 weight % to 80 weight %, more preferably 0 weight % to 50 weight %, and particularly preferably 0 weight % to 20 weight %.

### 1-1-5. Compound 5

The liquid crystal medium and the like used in the element of the disclosure may further contain at least one or two or more Compounds 5 represented by Formula (5).

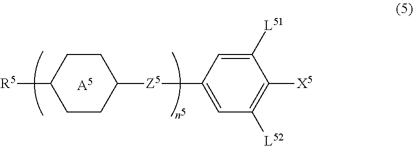

In Formula (5), R⁵ is an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is replaced with a fluorine atom;

the rings A⁵ are independently 1,4-cyclohexylene, 1,4-phenylene, 2-fluoro-1,4-phenylene, 3-fluoro-1,4-phenylene, 3,5-difluoro-1,4-phenylene, 3,5-dichloro-1,4-phenylene or pyrimidine-2,5-diyl;

Z⁵ is independently a single bond, an ethylene group, —COO—, —OCO—, —CF₂O— or —OCF₂—;

L⁵¹ and L⁵² are independently a hydrogen atom or a fluorine atom;

n⁵ is 1, 2, 3 or 4, and when n⁵ represents 2, 3 or 4, a plurality of rings A⁵ and Z⁵ may be the same as or different from each other; and

X⁵ is a fluorine atom, a chlorine atom, —CF₃ or —OCF₃.

Compound 5 is physically and chemically very stable under conditions in which elements are generally used and has favorable compatibility with other liquid crystal compounds. A composition containing this compound is stable under conditions in which elements are generally used. Therefore, a temperature range of a nematic phase in the composition can be widened, and the compound can be used for an element in a wide temperature range. In addition, since the compound has large dielectric anisotropy and refractive index anisotropy, it is beneficial as a component for lowering a driving voltage of the composition driven in the optically isotropic liquid crystal phase.

In Formula (5), R⁵ is an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is replaced with a fluorine atom. In Formula (5), R⁵ is preferably an alkyl group having 1 to 12 carbon atoms in order to improve the stability with respect to ultraviolet rays or improve the stability with respect to heat. In Formula (5), R⁵ is preferably an alkenyl group having 2 to 12 carbon atoms in order to lower the viscosity and is preferably an alkyl group having 1 to 12 carbon atoms in order to improve the stability with respect to ultraviolet rays or improve the stability with respect to heat.

The alkyl group in R⁵ in Formula (5) does not include a cyclic alkyl group. The alkoxy group does not include a cyclic alkoxy group. The alkenyl group does not include a cyclic alkenyl group. An alkenyl group in which at least one hydrogen atom is replaced with a fluorine atom does not include a cyclic alkenyl group in which at least one hydrogen atom is replaced with a fluorine atom.

In Formula (5), the rings A⁵ are independently 1,4-cyclohexylene, 1,4-phenylene, 2-fluoro-1,4-phenylene, 3-fluoro-1,4-phenylene, 3,5-difluoro-1,4-phenylene, 3,5-dichloro-1,4-phenylene, or pyrimidine-2,5-diyl, and when n⁵ is 2 or more, at least two rings A⁵ thereof may be the same as or different from each other. In Formula (5), the ring A⁵ is 1,4-phenylene or 3-fluoro-1,4-phenylene in order to increase the optical anisotropy and is preferably 1,4-cyclohexylene in order to lower the viscosity.

In Formula (5), Z⁵ is independently a single bond, an ethylene group, —COO—, —OCO—, —CF₂O— or —OCF₂—, and when n⁵ is 3 or 4, one of the Z⁵ is —CF₂O—. When n⁵ is 2 or more, at least two of the Z⁵ thereof may be the same as or different from each other. In Formula (5), Z⁵ is preferably a single bond in order to lower the viscosity. In Formula (5), Z⁵ is preferably —CF₂O— in order to increase the dielectric anisotropy and improve the compatibility.

In Formula (5), L⁵¹ and L⁵² are independently a hydrogen atom or a fluorine atom, and L⁵¹ and L⁵² are both preferably a fluorine atom in order to increase dielectric anisotropy, and L⁵¹ and L⁵² are both preferably a hydrogen atom in order to increase the clearing point.

In Formula (5), X⁵ is a fluorine atom, a chlorine atom, —CF₃ or —OCF₃, and is preferably —CF₃ in order to increase the dielectric anisotropy, preferably a fluorine group or —OCF₃ in order to improve the compatibility, and preferably a chlorine atom in order to increase the refractive index anisotropy.

Compound 5 is suitable for preparing a composition having large dielectric anisotropy or compatibility at a low temperature. A total amount of Compound 5 contained with respect to the total weight of the achiral component T is preferably 0 weight % to 80 weight %, more preferably 0 weight % to 50 weight %, and particularly preferably 0 weight % to 20 weight %.

### 1-1-6. Compound 6

The liquid crystal medium used in the element of the disclosure may further contain at least one or two or more Compounds 6 represented by Formula (6).

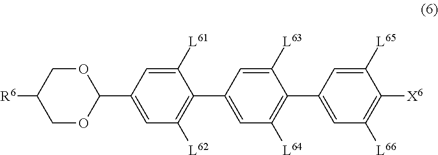

In Formula (6), R⁶ is a hydrogen atom or an alkyl group having 1 to 20 carbon atoms, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R⁶, —O— and —CH═CH—, and —CO— and —CH═CH— are not adjacent to each other;

L⁶¹ to L⁶⁶ are independently a hydrogen atom or a fluorine atom;

X⁶ is a hydrogen atom, a halogen atom, —SF₅ or an alkyl group having 1 to 10 carbon atoms, and at least one —CH₂— in the alkyl group is optionally replaced with —O—, —S—, —COO—, or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C— is optionally replaced with a fluorine atom or a chlorine atom, where, in X⁶, —O— and —CH═CH—, and —CO— and —CH═CH— are not adjacent to each other.

Compound 6 has a dioxane ring and three benzene rings. Compound 6 is physically and chemically very stable under conditions in which elements are generally used, and has relatively favorable compatibility with other liquid crystal compounds despite having a high clearing point. A composition containing Compound 6 is stable under conditions in which elements are generally used. Therefore, in a composition containing Compound 6, a temperature range of the optically isotropic liquid crystal phase can be widened, and the compound can be used for an element in a wide temperature range. In addition, Compound 6 is beneficial as a component for lowering a driving voltage of the composition driven in the optically isotropic liquid crystal phase. When a blue phase is exhibited in a preferable form of a composition containing a chiral agent and Compound 6, a uniform blue phase in which there is no N* phase and isotropic phase coexistence is exhibited. In this manner, a preferable form of a composition containing Compound 6 is likely to exhibit a uniform blue phase.

In Formula (6), X⁶ is a hydrogen atom, a halogen atom, —SF₅ or an alkyl group having 1 to 10 carbon atoms, and at least one —CH₂— in the alkyl group is optionally replaced with —O—, —S—, —COO—, or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C— is optionally replaced with a fluorine atom or a chlorine atom, where, in X⁶, —O— and —CH═CH—, and —CO— and —CH═CH— are not adjacent to each other.

Specific examples of X⁶ in Formula (6) include a fluorine atom, a chlorine atom, —CF₃, —CHF₂, —OCF₃ and —OCHF₂, and a fluorine atom, a chlorine atom, —CF₃ and —OCF₃ are preferable. When X⁶ in Formula (6) is a chlorine atom or a fluorine atom, the melting point is relatively low, and compatibility with other liquid crystal compounds is particularly excellent. When X⁶ in Formula (6) is —CF₃, —CHF₂, —OCF₃ or —OCHF₂, the compound exhibits relatively large dielectric anisotropy. When X⁶ in Formula (6) is a fluorine atom, a chlorine atom, —SF₅, —CF₃, —OCF₃, or —CH═CH—CF₃, the dielectric anisotropy is relatively large, and when X⁶ is a fluorine group, —CF₃, or —OCF₃, the compound is relatively chemically stable.

Compound 6 is suitable for preparing a composition having large dielectric anisotropy. Compound 6 is likely to exhibit a blue phase and has an effect of increasing a clearing point.

In order to increase the clearing point, a total amount of Compound 6 contained with respect to the total weight of the achiral component T is preferably about 1.0 weight % or more. In addition, in order to lower a lower limit temperature of a liquid crystal phase, a total amount of Compound 6 contained with respect to the total weight of the achiral component T is preferably 0 weight % to 80 weight %, more preferably 0 weight % to 50 weight %, and particularly preferably 0 weight % to 20 weight %.

### 1-1-7. Compound 7

The liquid crystal medium used in the element of the disclosure may further contain at least one or two or more Compounds 7 represented by Formula (7).

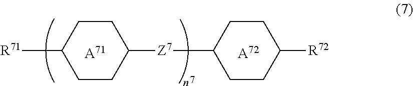

In Formula (7), R⁷¹ and R⁷² are independently an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is replaced with a fluorine atom;

The ring A⁷¹ and the ring A⁷² are independently 1,4-cyclohexylene, 1,4-phenylene, 2-fluoro-1,4-phenylene, 3-fluoro-1,4-phenylene or 2,5-difluoro-1,4-phenylene;

Z⁷ is independently a single bond, an ethylene group, —COO—, or —OCO—; and

n⁷ is 1, 2 or 3, and when n⁷ represents 2 or 3, a plurality of rings A⁷¹ and Z⁷ may be the same as or different from each other.

Compound 7 is a compound that has a small absolute value of a dielectric anisotropy value and is close to being neutral. A compound in which n⁷ in Formula (7) is 1 mainly has an effect of adjusting the viscosity or adjusting the refractive index anisotropy value, and a compound in which n⁷ in Formula (7) is 2 or 3 has an effect of widening a temperature range of an optically isotropic liquid crystal phase such as increasing a clearing point, and an effect of adjusting the refractive index anisotropy value.

In Formula (7), R⁷¹ and R⁷² are independently an alkyl group having 1 to 12 carbon atoms, an alkoxy group having 1 to 12 carbon atoms, an alkenyl group having 2 to 12 carbon atoms, or an alkenyl group having 2 to 12 carbon atoms in which at least one hydrogen atom is replaced with a fluorine atom. In order to lower the viscosity of Compound 7, R⁷¹ and R⁷² in Formula (7) are preferably an alkenyl group having 2 to 12 carbon atoms. In order to improve the stability with respect to ultraviolet rays or improve the stability with respect to heat, R⁷¹ and R⁷² in Formula (7) are preferably an alkyl group having 1 to 12 carbon atoms.

In Formula (7), the ring A⁷¹ and the ring A⁷² are independently 1,4-cyclohexylene, 1,4-phenylene, 2-fluoro-1,4-phenylene, 3-fluoro-1,4-phenylene or 2,5-difluoro-1,4-phenylene, and when n⁷ is 2 or more, at least two rings A⁷¹ thereof may be the same as or different from each other. In order to increase the optical anisotropy of Compound 7, the ring A⁷¹ and the ring A⁷² are preferably 1,4-phenylene or 3-fluoro-1,4-phenylene. In order to lower the viscosity of Compound 7, the ring A⁷¹ and the ring A⁷² are 1,4-cyclohexylene.

In Formula (7), Z⁷ is independently a single bond, an ethylene group, —COO—, or —OCO—, and when n⁷ is 2 or more, at least two of the Z⁷ thereof may be the same as or different from each other. In order to lower the viscosity, Z⁷ is preferably a single bond.

When the content of the compound represented by Formula (7) is increased, since a driving voltage of the liquid crystal composition is high and the viscosity is lowered, a smaller content is desirable in consideration of a driving voltage as long as a required value of the viscosity of the liquid crystal composition is satisfied. A total amount of Compound 7 contained with respect to the total weight of the achiral component T is preferably 0 weight % to 80 weight %, more preferably 0 weight % to 50 weight %, and particularly preferably 0 weight % to 20 weight %.

### 1-1-8. Compound 8

The liquid crystal medium used in the element of the disclosure may further contain at least one or two or more Compounds 8 represented by Formula (8).

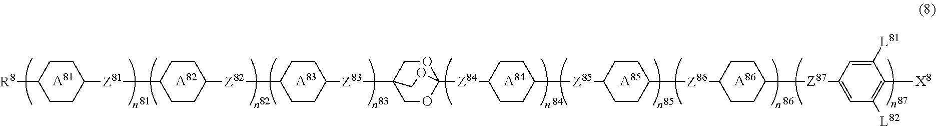

In Formula (8), R⁸ is an alkyl group having 1 to 10 carbon atoms, and at least one —CH₂— in the alkyl group is optionally replaced with —O—, and at least one —(CH₂)₂— in the alkyl group is optionally replaced with —CH═CH—;

the ring A⁸¹ to ring A⁸⁶ are independently 1,4-cyclohexylene or 1,4-phenylene, and at least one —CH₂— in 1,4-cyclohexylene is optionally replaced with —O—, at least one —(CH₂)₂— in 1,4-cyclohexylene is optionally replaced with —CH═CH—, at least one —CH═ in 1,4-phenylene is optionally replaced with —N═, and at least one hydrogen atom in 1,4-phenylene is optionally replaced with a halogen atom;

Z⁸¹ to Z⁸⁷ are independently a single bond, —(CH₂)₂—, —COO—, —OCO—, —CF₂O—, —OCF₂—, or —CH═CH—;

L⁸¹ and L⁸² are independently a hydrogen atom or a fluorine atom;

n⁸¹ to n⁸⁷ are independently 0 or 1; a sum of n⁸¹ to n⁸⁷ is 1, 2, 3, or 4; and

X⁸ is a fluorine group, —CF₃, or —OCF₃.

### 1-1-9. Compound 9

The liquid crystal medium used in the element of the disclosure may further contain at least one or two or more Compounds 9 represented by Formula (9).

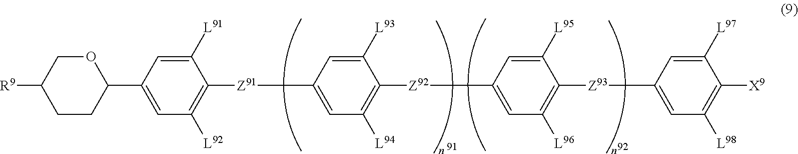

In Formula (9), R⁹ is a hydrogen atom, an alkyl group having 1 to 20 carbon atoms, an alkenyl group having 2 to 20 carbon atoms, an alkynyl group having 2 to 20 carbon atoms, an alkoxy group having 1 to 19 carbon atoms, or an alkoxyalkyl group having 1 to 20 carbon atoms in total, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R⁹, —O— and —CH═CH—, and —CO— and —CH═CH— are not adjacent to each other;

Z⁹¹ to Z⁹³ are independently a single bond, —COO— or —CF₂O—, and at least one thereof is —COO— or —CF₂O—;

L⁹¹ to L⁹⁸ are independently a hydrogen atom or a fluorine atom;

n⁹¹ and n⁹² are independently 0 or 1; and

X⁹ is a hydrogen atom, a halogen atom, —SF₅ or an alkyl group having 1 to 10 carbon atoms, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO—, or a group in which at least one —CH₂—CH₂— in the alkyl group is replaced with —CH═CH—, —CF═CF— or —C≡C— is optionally replaced with a fluorine atom or a chlorine atom, where, in X⁹¹, —O— and —CH═CH—, and —CO— and —CH═CH— are not adjacent to each other.

### 1-1-10. Compound 10

The liquid crystal medium used in the element of the disclosure may further contain at least one or two or more Compounds 10 represented by Formula (10).

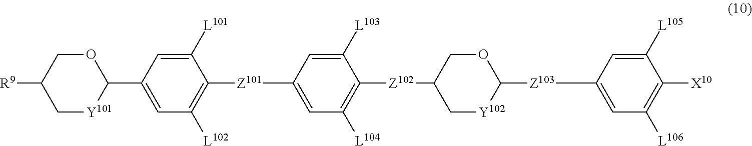

In Formula (10), R¹⁰ is a hydrogen atom or an alkyl group having 1 to 20 carbon atoms, and at least one —CH₂— in the alkyl group is optionally replaced with —O—, —S—, —COO—, —OCO—, —CH═CH—, —CF═CF— or —C≡C—, and at least one hydrogen atom in the alkyl group or a group in which any —CH₂— in the alkyl group is replaced with —O—, —S—, —COO—, —OCO—, —CH═CH—, —CF═CF— or —C≡C— is optionally replaced with a halogen atom or an alkyl group having 1 to 3 carbon atoms;

Y¹⁰¹ and Y¹⁰² are independently —O— or —CH₂—;

Z¹⁰¹ is —CF₂O— or —COO—, Z¹⁰² is a single bond or —CH₂CH₂—, but one CH₂ is optionally replaced with an oxygen atom, and Z¹⁰³ is a single bond, —CH₂CH₂—, —CF₂O— or —COO—;

L¹⁰¹ to L¹⁰⁶ are independently a hydrogen atom or a fluorine atom; and

X¹⁰ is a hydrogen atom, a halogen atom, —SF₅ or an alkyl group having 1 to 10 carbon atoms, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in X¹⁰, —O— and —CH═CH—, and —CO— and —CH═CH— are not adjacent to each other.

### 1-1-11. Compound 11

The liquid crystal medium used in the element of the disclosure may further contain at least one or two or more Compounds 11 represented by Formula (11).

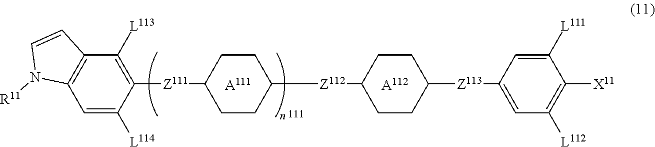

In Formula (11), R¹¹ is an alkyl group having 1 to 12 carbon atoms, an alkenyl group having 2 to 12 carbon atoms, or an alkoxy group having 1 to 11 carbon atoms; the ring A¹¹¹ and the ring A¹¹² are independently represented by the following formula;

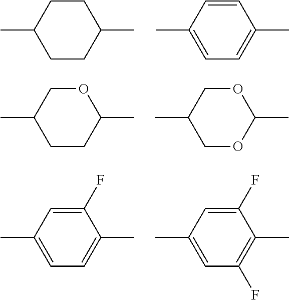

Z¹¹¹ to Z¹¹³ are independently a single bond, —(CH₂)₂—, —COO—, —CF₂O—, or —CH═CH—;

L¹¹¹ to L¹¹⁴ are independently a hydrogen atom or a halogen atom;

n¹¹¹ is 0, 1 or 2, and when n¹¹¹ represents 2, a plurality of Z¹¹¹ and rings A¹¹¹ may be the same as or different from each other; and

X¹¹ is a hydrogen atom, a halogen atom, —CF₃, —OCF₃, or —C≡N.

### 1-1-12. Compound 12

The liquid crystal medium used in the element of the disclosure may further contain at least one or two or more Compounds 12 represented by Formula (12).

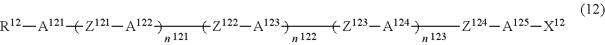

In Formula (12), R¹² is a branched alkyl or branched alkenyl group having 3 to 20 carbon atoms, and at least one —CH₂— in the branched alkyl or branched alkenyl group is optionally replaced with —O—, at least one —CH₂—CH₂— in the branched alkyl or branched alkenyl group is optionally replaced with —CH═CH—, —CF═CF— or —C≡C—, and at least one hydrogen in the branched alkyl or branched alkenyl is optionally replaced with a fluorine atom;

the rings A¹²¹ to A¹²⁵ are independently 1,4-phenylene, 1,3-dioxane-2,5-diyl, tetrahydropyran-2,5-diyl, tetrahydropyran-3,6-diyl, pyrimidine-2,5-diyl, pyridine-2,5-diyl, or naphthalene-2,6-diyl, and at least one hydrogen atom in these rings is optionally replaced with a fluorine atom or a chlorine atom;

Z¹²¹ to Z¹²⁴ are independently a single bond or an alkylene group having 1 to 4 carbon atoms, and at least one —CH₂— in the alkylene group is optionally replaced with —O—, —COO—, —OCO—, or —CF₂O—, at least one —CH₂—CH₂— in the alkylene group is optionally replaced with —CH═CH—, —CF═CF— or —C≡C—, and at least one hydrogen atom in the alkylene group is optionally replaced with a halogen atom;

n¹²¹ to n¹²³ are independently 0 or 1, and 1≤n²¹¹+n¹²²+n¹²³≤3 is established;

X¹² is a fluorine atom, a chlorine atom, —SF₅, —C≡N, —N═C≡S, or an alkyl group having 1 to 3 carbon atoms in which at least one hydrogen atom is replaced with a halogen atom, and at least one —CH₂— in the alkyl group is optionally replaced with —O—, and at least one —CH₂—CH₂— in the alkyl group is optionally replaced with —CH═CH— or —C≡C—.

### 1-1-13. Compound 13

The liquid crystal medium used in the element of the disclosure may further contain at least one or two or more Compounds 13 represented by Formula (13).

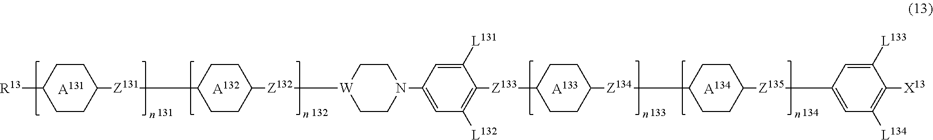

In Formula (13), R¹³ is a hydrogen atom or an alkyl group having 1 to 20 carbon atoms, and at least one —CH₂— in the alkyl group is optionally replaced with —O—, —S—, —COO—, —OCO—, —CH═CH—, —CF═CF— or —C≡C—, —CH₂—, and at least one hydrogen atom in the alkyl group and a group in which —CH₂— in the alkyl group is replaced with —O—, —S—, —COO—, —OCO—, —CH═CH—, —CF═CF— or —C≡C— is optionally replaced with a halogen atom or an alkyl group having 1 to 3 carbon atoms;

The rings A¹³¹ to A¹³⁴ are independently a benzene ring, a naphthalene ring, a thiophene ring, a piperidine ring, a cyclohexene ring, a bicyclooctane ring, a tetrahydronaphthalene ring or a cyclohexane ring, and at least one hydrogen atom in these rings is optionally replaced with a halogen atom, an alkyl group having 1 to 3 carbon atoms or an alkyl halide having 1 to 3 carbon atoms, at least one or two —CH₂— in these rings are optionally replaced with —O— or —S—, but oxygen atoms are not adjacent to each other, and —CH═ is optionally replaced with —N═;

W is CH or N;

Z¹³¹ to Z¹³ are independently a single bond or an alkylene group having 1 to 4 carbon atoms, and at least one —CH₂— in the alkylene group is optionally replaced with —O—, —COO— or —CF₂O—;

L¹³¹ to L¹³⁴ are independently a hydrogen atom or a halogen atom;

n¹³¹ to n¹³⁴ are independently 0 or 1, and 0≤n¹³¹+n¹³²+n¹³³+n¹³⁴≤2 is established; and

X¹³ is a hydrogen atom, a halogen atom, —SF₅, —C≡N, —N═C≡S or an alkyl group having 1 to 10 carbon atoms, and at least one —CH₂— in the alkyl group is optionally replaced with —O—, —S—, —COO— or —OCO—, and at least one —CH₂—CH₂— in the alkyl group and a group in which —CH₂— in the alkyl group is replaced with —O—, —S—, —COO—, —OCO—, —CH═CH—, —CF═CF— or —C≡C— is optionally replaced with —CH═CH—, —CF═CF— or —C≡C—, and at least one hydrogen atom in the alkyl group, a group in which —CH₂— in the alkyl group is replaced with —O—, —S—, —COO—, —OCO—, —CH═CH—, —CF═CF— or —C≡C—, and a group in which at least one —CH₂—CH₂— in the alkyl group is replaced with —CH═CH—, —CF═CF— or —C≡C— is optionally replaced with a fluorine atom or a chlorine atom, where, in X¹³, —O— and —CH═CH— are not adjacent to each other, and —CO— and —CH═CH— are not adjacent to each other.

### 1-1-14. Properties of Compounds 8 to 13

Compounds 8 to 13 are physically and chemically very stable under conditions in which elements are generally used, and have relatively favorable compatibility with other liquid crystal compounds despite having a high clearing point. A composition containing Compounds 8 to 13 is relatively stable under conditions in which elements are generally used. Therefore, in a composition containing Compounds 8 to 13, a temperature range of an optically isotropic liquid crystal phase can be widened, and the compounds can be used for an element in a wide temperature range. In addition, Compounds 8 to 13 are beneficial for a component for lowering a driving voltage of the composition driven in the optically isotropic liquid crystal phase. In addition, when a blue phase is exhibited in a composition containing Compounds 8 to 13 and a chiral agent, a uniform blue phase in which there is no N* phase and isotropic phase coexistence is likely to be exhibited. That is, Compounds 8 to 13 are compounds that are likely to exhibit a uniform blue phase, and exhibit very large dielectric anisotropy.

In Formulae (8) to (13), X⁸, X⁹, X¹⁰, X¹¹, X¹², and X¹³ are preferably a fluorine atom, a chlorine atom, —CF₃, —CHF₂, —OCF₃ or —OCHF₂, and more preferably a fluorine atom, a chlorine atom, —CF₃ or —OCF₃.

When X⁸, X⁹, X¹⁰, X¹¹, X¹², and X¹³ in Formulae (8) to (13) are a chlorine atom or a fluorine atom, the melting point of Compounds (8) to (13) is relatively low, and compatibility with other liquid crystal compounds is particularly excellent. When X⁸, X⁹, X¹⁰, X¹¹, X¹², and X¹³ in Formulae (8) to (13) are —CF₃, —SF₅, —CHF₂, —OCF₃ and —OCHF₂, Compounds 8 to 13 exhibit relatively large dielectric anisotropy.

When X⁸, X⁹, X¹⁰, X¹¹, X¹², and X¹³ are a fluorine group, —CF₃, or —OCF₃, the compound is chemically stable.

Compounds 8 to 13 are suitable for preparing a composition having large dielectric anisotropy, and can lower a driving voltage in the element of the disclosure. A total amount of one, two or more of any of Compounds 8 to 13 contained with respect to the total weight of the achiral component T is preferably 0 weight % to 80 weight %, more preferably 0 weight % to 50 weight %, and particularly preferably 0 weight % to 20 weight %.

### 1-1-15. Synthesis of Compounds 1 to 13

Compound 1 and Compounds 2 to 13 can be synthesized by appropriately combining methods in synthetic organic chemistry. Methods of introducing desired end groups, rings and binding groups to a starting material are described in Organic Syntheses (John Wiley & Sons, Inc), Organic Reactions (John Wiley & Sons, Inc), Comprehensive Organic Synthesis, (Pergamon Press), New Course of Experimental Chemistry (Maruzen), and the like.

For example, Compounds 1 and 2 to 13 can be synthesized according to the method in Japanese Patent No. 2959526.

2. Chiral Agent

The chiral agent contained in the optically isotropic liquid crystal composition is an optically active compound, and is preferably composed of a compound selected from among compounds having no radical polymerizable group.

As the chiral agent used in the composition of the disclosure, a compound having a large helical twisting power is preferable. Since an amount of a compound needed to be added to obtain a desired pitch can be reduced, and increase in the driving voltage can be minimized therewith, a compound having a large helical twisting power is practically advantageous. Specifically, compounds represented by Formulae (K1) to (K7) are preferable. Among these compounds, for a chiral agent added to the liquid crystal composition, Formula (K2-1) to Formula (K2-8) included in Formula (K2), Formula (K4-1) to Formula (K4-6) included in Formula (K4), and Formula (K5-1) to Formula (K5-3) included in Formula (K5), and Formula (K6) are preferable, and Formula (K4-1) to Formula (K4-6), Formula (K5-1) to Formula (K5-3) and Formula (K6) are more preferable. Here, in Compounds (K4) to (K7), a binaphthyl group and an octahydronaphthyl group are optically active sites and the chirality of the chiral agent is not important.

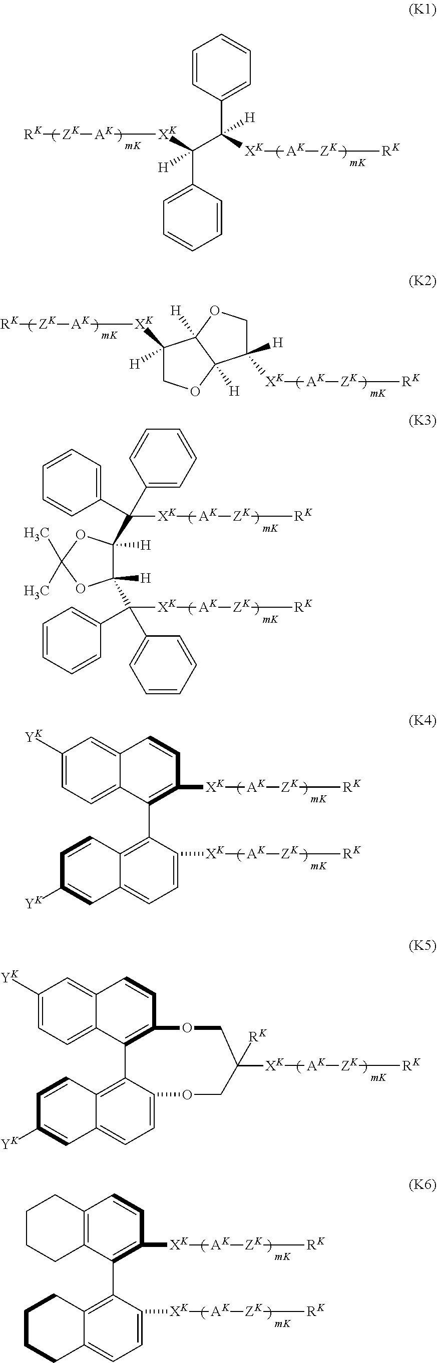

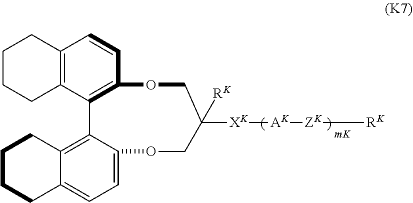

In Formulae (K1) to (K7), R^{K} is independently a hydrogen atom, a halogen atom, —C≡N, —N═C≡O, —N═C≡S or an alkyl group having 1 to 12 carbon atoms, and at least one —CH₂— in R^{K} is optionally replaced with —O—, —S—, —COO— or —OCO—, at least one —CH₂—CH₂— in R^{K} is optionally replaced with —CH═CH—, —CF═CF— or —C≡C—, and at least one hydrogen atom in R^{K} is optionally replaced with a fluorine atom or a chlorine atom;

A^{K} is independently a 6- to 8-membered aromatic ring, a 3- to 8-membered nonaromatic ring, or a condensed ring having 9 or more carbon atoms, and at least one hydrogen atom in these rings is optionally replaced with a halogen atom or an alkyl or haloalkyl group having 1 to 3 carbon atoms, at least one —CH₂— in these rings is optionally replaced with —O—, —S— or —NH—, and at least one —CH═ in these rings is optionally replaced with —N═;

Y^{K} is independently a hydrogen atom, a halogen atom, an alkyl group having 1 to 3 carbon atoms, a haloalkyl group having 1 to 3 carbon atoms, a 6- to 8-membered aromatic ring, a 3- to 8-membered nonaromatic ring, or a condensed ring having 9 or more carbon atoms, at least one hydrogen atom in these rings is optionally replaced with a halogen atom, an alkyl or haloalkyl group having 1 to 3 carbon atoms, at least one —CH₂— in the alkyl group is optionally replaced with —O—, —S— or —NH—, and at least one —CH═ in the alkyl group is optionally replaced with —N═;

Z^{K} is independently a single bond or an alkylene group having 1 to 8 carbon atoms, and at least one —CH₂— in Z^{K} is optionally replaced with —O—, —S—, —COO—, —OCO—, —CSO—, —OCS—, —N═N—, —CH═N— or —N═CH—, at least one —CH₂—CH₂— in Z^{K} is optionally replaced with —CH═CH—, —CF═CF— or —C≡C—, and at least one hydrogen atom in Z^{K} is optionally replaced with a halogen atom;

X^{K} is independently a single bond, —COO—, —OCO—, —CH₂O—, —OCH₂—, —CF₂O—, —OCF₂—, or —CH₂CH₂—; and

mK is independently an integer of 1 to 3.

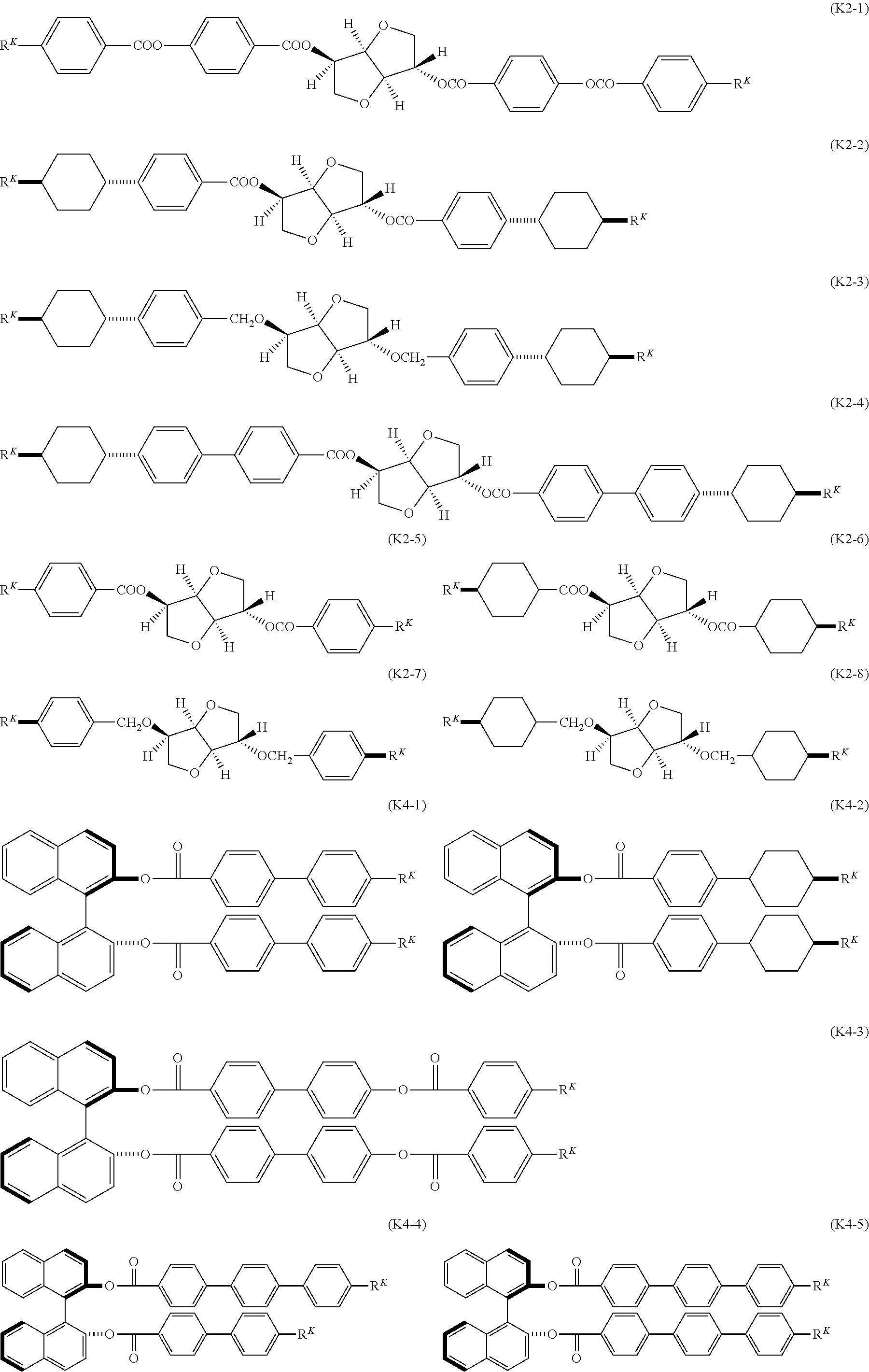

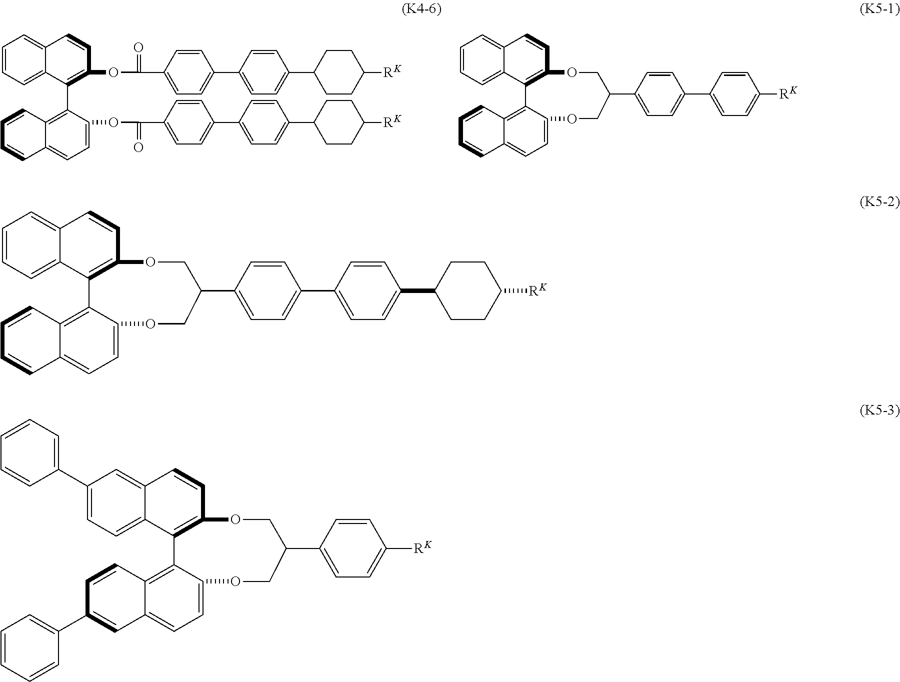

In Formulae (K2-1) to (K2-8), Formulae (K4-1) to (K4-6), and Formulae (K5-1) to (K5-3), R^{K} is independently an alkyl group having 3 to 10 carbon atoms or an alkoxy group having 3 to 10 carbon atoms, and at least one —CH₂—CH₂— in the alkyl or alkoxy group is optionally replaced with —CH═CH—.

Depending on properties required for a liquid crystal composition, a chiral agent of which a helical twisting power is not relatively large can be used. High solubility in a liquid crystal composition is required for the chiral agent of which a helical twisting power is not relatively large. Examples thereof include compounds represented by the following Formulae (Op-1) to (Op-13).

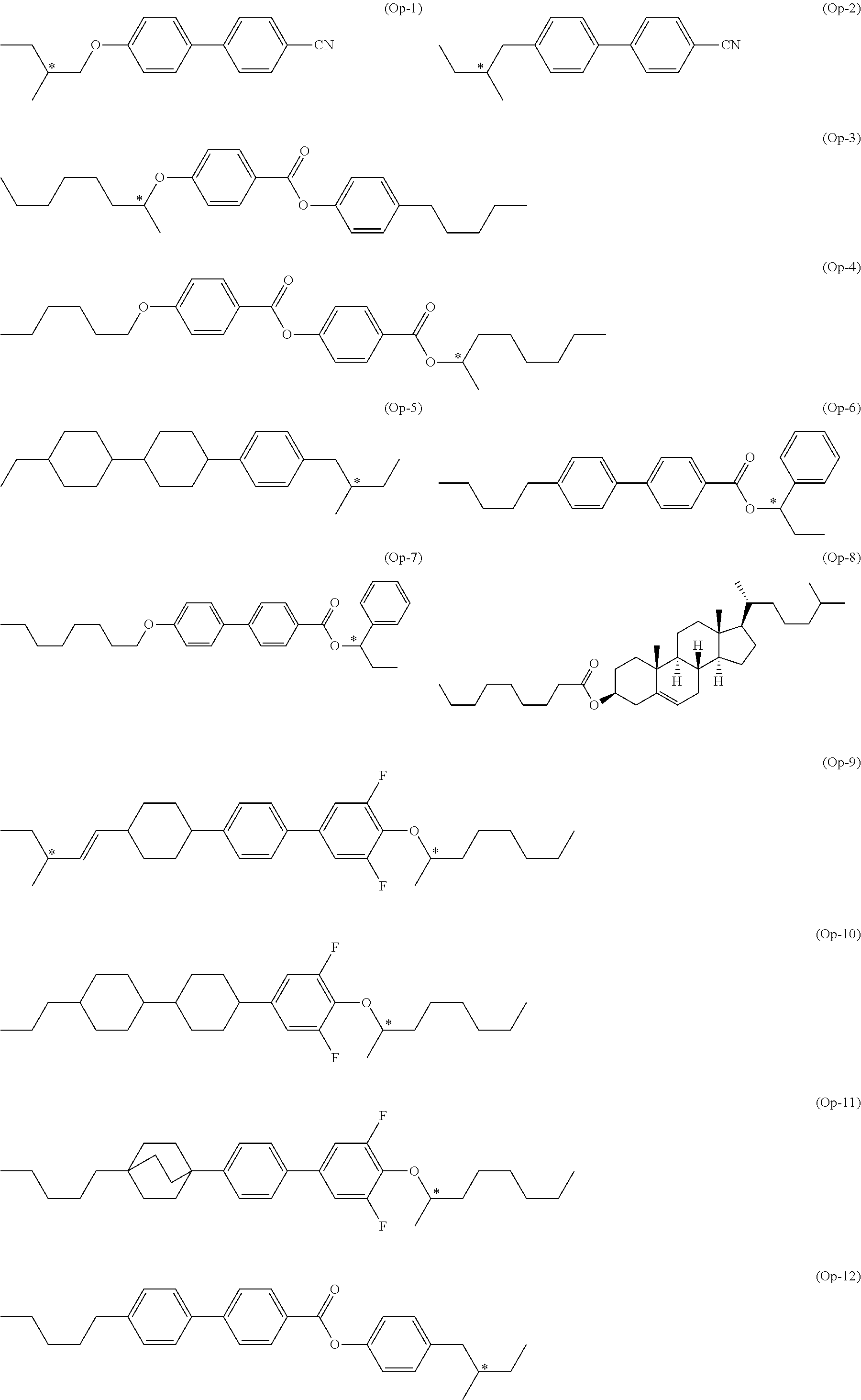

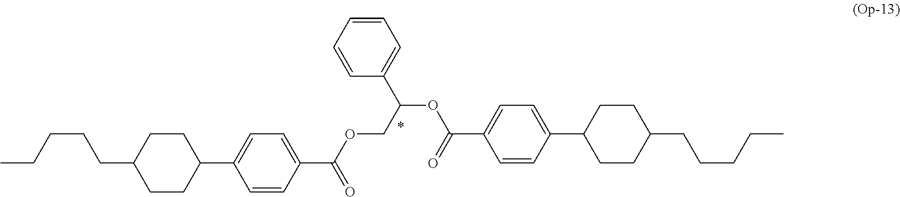 [SMILES: CCCCCC1CCC(c2ccc(C(=O)OCC(OC(=O)c3ccc(C4CCC(CCCCC)CC4)cc3)c3ccccc3)cc2)CC1]

One compound or two or more compounds may be used for a chiral agent contained in the liquid crystal composition.

In order for an optically isotropic liquid crystal phase to be easily exhibited, preferably 0.5 weight % to 40 weight %, more preferably 1 weight % to 25 weight %, and particularly preferably 2 weight % to 15 weight % of a chiral agent is included with respect to the total weight of the liquid crystal composition of the disclosure.

In order to set a desired pitch length, a chiral agent having a polymerizable group or a chiral agent that is photoisomerized may be used.

3. Optically Isotropic Liquid Crystal Phase

When it is stated that the liquid crystal composition is optically isotropic, this means that a liquid crystal molecular arrangement is macroscopically isotropic so that the composition is optically isotropic, but there is a liquid crystal order microscopically. “A pitch based on a liquid crystal order that the liquid crystal composition microscopically has (hereinafter referred to as a pitch in some cases)” is preferably 700 nm or less, more preferably 500 nm or less, and most preferably 350 nm or less.

Here, the “non-liquid crystalline isotropic phase” is an isotropic phase which is generally defined, that is, a disordered phase, and an isotropic phase in which, even if a region in which a local order parameter is not zero is generated, its cause is due to fluctuation. For example, an isotropic phase exhibited on the high-temperature side of a nematic phase corresponds to a non-liquid crystalline isotropic phase in this specification. The same definition also applies to a chiral liquid crystal in this specification.

In this specification, the “optically isotropic liquid crystal phase” refers to a phase that exhibits an optically isotropic liquid crystal phase without fluctuation, for example, a phase in which a platelet structure is exhibited (a blue phase in a narrow sense) is one example thereof.

In the optically isotropic liquid crystal composition of the disclosure, although it has an optically isotropic liquid crystal phase, a typical platelet structure in a blue phase may not be observed under a polarizing microscope. Therefore, in this specification, a phase in which a platelet structure is exhibited is referred to as a blue phase, and an optically isotropic liquid crystal phase including a blue phase is referred to as an optically isotropic liquid crystal phase. That is, a blue phase is included in an optically isotropic liquid crystal phase.

Generally, blue phases are classified into three types: a blue phase I, a blue phase II, and a blue phase III, and all of 3 types of these blue phases are optically active and isotropic. In the blue phase of the blue phase I and the blue phase II, two or more types of diffracted light caused by Bragg reflection from a different lattice plane are observed. A blue phase is generally observed in a temperature range between the non-liquid crystalline isotropic phase and the chiral nematic phase.

A state in which the optically isotropic liquid crystal phase does not exhibit diffracted light with two or more colors means that the platelet structure observed in the blue phase I and the blue phase II is not observed, and one plane has almost a single color. In an optically isotropic liquid crystal phase in which diffracted light with two or more colors is not shown, uniform brightness of color in the plane is not necessary.

An optically isotropic liquid crystal phase in which diffracted light with two or more colors is not shown has an advantage of a so-called shift to a side in which an intensity of reflected light due to Bragg reflection is minimized or the low wavelength side.

In addition, in a liquid crystal medium at which visible light is reflected, tinting may be a problem when used for a display element. However, in liquid crystals in which diffracted light with two or more colors is not exhibited, since a reflection wavelength is shifted to a lower wavelength, reflection of visible light with a longer pitch than in a blue phase in a narrow sense (a phase in which the platelet structure is exhibited) can be eliminated.

The optically isotropic liquid crystal composition of the disclosure can also be obtained by adding a chiral agent to a composition having a chiral nematic phase and not having an optically isotropic liquid crystal phase. Here, the composition having a chiral nematic phase and not having an optically isotropic liquid crystal contains Compound 1, an optically active compound, and other components as necessary. In this case, in order to prevent an optically isotropic liquid crystal phase being exhibited, a chiral agent is preferably added at a concentration in which the pitch is 700 nm or more.

The temperature range in which the preferable form of the liquid crystal composition of the disclosure exhibits an optically isotropic liquid crystal phase can be widened when a chiral agent is added to a liquid crystal composition having a wide temperature range in which a nematic phase or a chiral nematic phase and an isotropic phase coexist and an optically isotropic liquid crystal phase is caused to be exhibited. For example, a liquid crystal compound having a high clearing point and a liquid crystal compound having a low clearing point may be mixed together to prepare a liquid crystal composition having a wide coexistence temperature range for a nematic phase and an isotropic phase in a wide temperature range, and a chiral agent may be added thereto, and thereby a composition that exhibits an optically isotropic liquid crystal phase in a wide temperature range can be prepared.

Regarding the liquid crystal composition having a wide temperature range in which a nematic phase or a chiral nematic phase and an isotropic phase coexist, a liquid crystal composition in which a difference between an upper limit temperature and a lower limit temperature in which a chiral nematic phase and a non-liquid crystalline isotropic phase coexist is 3 to 150° C. is preferable, and a liquid crystal composition in which the difference is 5 to 150° C. is more preferable. In addition, a liquid crystal composition in which a difference between an upper limit temperature and a lower limit temperature in which a nematic phase and a non-liquid crystalline isotropic phase coexist is 3 to 150° C. is preferable.

When an electric field is applied to the liquid crystal medium of the disclosure in the optically isotropic liquid crystal phase, electric birefringence occurs, but it is not necessary to be a Kerr effect.

Since electric birefringence in an optically isotropic liquid crystal phase increases as the pitch becomes longer, as long as requirements for other optical properties (such as a transmittance and a diffraction wavelength) are satisfied, a type and a content of a chiral agent may be adjusted and the pitch may be set to be longer, and thus the electric birefringence can be increased.

4. Other Components

The optically isotropic liquid crystal composition of the disclosure may further contain a solvent, a polymeric substance, a dichroic dye, a photochromic compound and the like as long as they do not greatly influence properties of the composition.

In addition, examples of the dichroic dye used in the liquid crystal composition of the disclosure include merocyanine type, styryl type, azo type, azomethine type, azoxy type, quinophthalone type, anthraquinone type, and tetrazine type dyes.

5. Optically Isotropic Polymer/Liquid Crystal Composite Material

The optically isotropic polymer/liquid crystal composite material of the disclosure can be produced by mixing an optically isotropic liquid crystal composition and a polymer obtained by preliminary polymerization, but it is preferably produced by producing a mixture of low molecular weight monomers, macromonomers, oligomers and the like (hereinafter collectively referred to as polymerizable monomers and the like”) as a polymer material and a liquid crystal composition and then causing a polymerization reaction to occur in the mixture.

### 5-1. Polymer/Liquid Crystal Composite Material

The polymer/liquid crystal composite material of the disclosure is a composite material containing a liquid crystal composition and a polymer, and is optically isotropic, and can be used for an optical switching element that is driven in the optically isotropic liquid crystal phase. The liquid crystal composition contained in the polymer/liquid crystal composite material of the disclosure is the liquid crystal composition of the disclosure.

In this specification, the “polymer/liquid crystal composite material” is not particularly limited as long as it is a composite material containing both a liquid crystal composition and a polymer compound, but it is in a state in which polymers are phase-separated from a liquid crystal composition while some or all of polymers are not dissolved in the liquid crystal composition. Here, in this specification, unless otherwise noted, the nematic phase means a nematic phase in a narrow sense, which does not include a chiral nematic phase.

The optically isotropic polymer/liquid crystal composite material according to the preferable form of the disclosure can exhibit the optically isotropic liquid crystal phase in a wide temperature range. In addition, the polymer/liquid crystal composite material according to the preferable form of the disclosure has a very fast response speed. In addition, the preferable form of the polymer/liquid crystal composite material according to the disclosure can be suitably used for an optical switching element based on these effects.

### 5-2. Polymerizable Monomer and the Like

A mixture containing polymerizable monomers and the like, and a liquid crystal composition is referred to as a “polymerizable monomer/liquid crystal mixture” in this specification. As necessary, a polymerization initiator (item 5-2-3), a curing agent (item 5-2-4), a curing accelerator (item 5-2-4), a stabilizer (item 5-2-4), a dichroic dye, a photochromic compound, and the like, which will be described below, may be contained in the “polymerizable monomer/liquid crystal mixture,” as long as effects of the disclosure are not impaired. For example, as necessary, 0.1 to 20 parts by weight of the polymerization initiator with respect to 100 parts by weight of polymerizable monomers may be contained in the polymerizable monomer/liquid crystal mixture in this disclosure. The “polymerizable monomer/liquid crystal mixture” needs to be a liquid crystal medium when polymerizing at a temperature in which a blue phase is exhibited, but it is not necessarily to be a liquid crystal medium when polymerizing at a temperature in which an isotropic phase is exhibited.

The polymerization temperature is preferably a temperature at which the polymer/liquid crystal composite material exhibits high transparency and isotropy. More preferably, the polymerization ends at a temperature in which a mixture of polymerizable monomers and the like and a liquid crystal composition exhibits an isotropic phase or a blue phase and at a temperature in which an isotropic phase or an optically isotropic liquid crystal phase is exhibited. That is, it is preferable to set a temperature in which the polymer/liquid crystal composite material does not substantially scatter light on the side with a longer wavelength than visible light, and an optically isotropic state is exhibited after the polymerization.

Regarding a raw material of polymers constituting the composite material of the disclosure, for example, low molecular weight monomers, macromonomers, and oligomers can be used. When the term “raw material monomers of polymers” is used in this specification, it includes low molecular weight monomers, macromonomers, oligomers and the like. In addition, it is preferable for the obtained polymers to have a three-dimensional crosslinked structure. Thus, multifunctional monomers having two or more polymerizable functional groups are preferably used as raw material monomers of polymers. The polymerizable functional group is not particularly limited, and examples thereof include an acrylic group, a methacrylic group, a glycidyl group, an epoxy group, an oxetanyl group, and a vinyl group. In consideration of a polymerization rate, an acrylic group and a methacrylic group are preferable. It is preferable that 10 weight % or more of monomers having two or more polymerizable functional groups among raw material monomers of polymers be contained in the monomers because high transparency and isotropy are easily exhibited in the composite material of the disclosure.

In addition, in order to obtain a suitable composite material, polymers having mesogen sites are preferably used, and raw material monomers having mesogen sites can be used as raw material monomers of polymers in a part thereof or all thereof.

In addition, in order to obtain a suitable composite material, monofunctional or multifunctional monomers having mesogen sites, and monomers having a polymerizable functional group having no mesogen site can be used together. In addition, a polymerizable compound other than monofunctional or multifunctional monomers having mesogen sites and monomers having a polymerizable functional group having no mesogen site can be used as necessary.

5-2-1. Monofunctional or Multifunctional Monomers Having Mesogen Sites

The monofunctional or bifunctional monomers having mesogen sites are not particularly limited in terms of structure. For example, compounds represented by the following Formula (M1) or Formula (M2) may be exemplified.

R^{a}—Y-(A^{M}-Z^{M})ₘ₁-A^{M}-Y—R^{b} (M1)

R^{b}—Y-(A^{M}-Z^{M})ₘ₁-A^{M}-Y—R^{b} (M2)

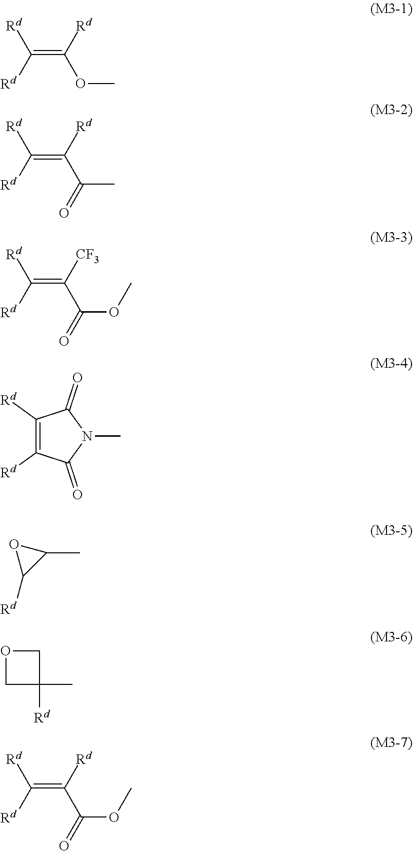

In Formula (M1), R^{a} is a hydrogen atom, a halogen atom, —C≡N, —N═C≡O, —N═C≡S, or an alkyl group having 1 to 20 carbon atoms, and at least one —CH₂— in the alkyl group is optionally replaced with —O—, —S—, —CO—, —COO—, or —OCO—, at least one —CH₂—CH₂— in the alkyl group is optionally replaced with —CH═CH—, —CF═CF—, or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C— is optionally replaced with a halogen atom or —C≡N. R^{b} is independently polymerizable groups of Formula (M3-1) to Formula (M3-7).

Preferably, R^{a} is a hydrogen atom, a halogen atom, —C≡N, —CF₃, —CF₂H, —CFH₂, —OCF₃, —OCF₂H, an alkyl group having 1 to 20 carbon atoms, an alkoxy group having 1 to 19 carbon atoms, an alkenyl group having 2 to 21 carbon atoms, or an alkynyl group having 2 to 21 carbon atoms. Particularly preferably, R^{a} is —C≡N, an alkyl group having 1 to 20 carbon atoms or an alkoxy group having 1 to 19 carbon atoms.

In Formula (M2), R^{b} is independently polymerizable groups of Formulae (M3-1) to (M3-7).

Here, in Formulae (M3-1) to (M3-7), R^{d}'s are independently a hydrogen atom, a halogen atom or an alkyl group having 1 to 5 carbon atoms, and at least one hydrogen atom in the alkyl group is optionally replaced with a halogen atom. Preferably, R^{d} is a hydrogen atom, a halogen atom or a methyl group. Particularly preferably, R^{d} is a hydrogen atom, a fluorine atom or a methyl group.

In addition, the compounds of Formula (M3-2), Formula (M3-3), Formula (M3-4), and Formula (M3-7) are preferably polymerized according to radical polymerization. The compounds of Formula (M3-1), Formula (M3-5), and Formula (M3-6) are preferably polymerized according to cationic polymerization. Since both are living polymerization, polymerization starts when a small amount of radicals or cation active species is generated in a reaction system. A polymerization initiator can be used in order to accelerate the generation of active species. For example, light or heat can be used to generate active species.

In Formulae (M1) and (M2), A^{M} is independently an aromatic or non-aromatic 5-membered ring or 6-membered ring or a condensed ring having 9 or more carbon atoms, and at least one —CH₂— in these rings is optionally replaced with —O—, —S—, —NH—, or —NCH₃—, at least one —CH═ in these rings is optionally replaced with —N═, and at least one hydrogen atom in these rings is optionally replaced with a halogen atom, an alkyl group having 1 to 5 carbon atoms, or an alkyl halide. Preferably, specific examples of A^{M} include 1,4-cyclohexylene, 1,4-cyclohexenylene, 1,4-phenylene, naphthalene-2,6-diyl, tetrahydro naphthalene-2,6-diyl, fluorene-2,7-diyl, and bicyclo [2.2.2] octane-1,4-diyl, and at least one —CH₂— in these rings is optionally replaced with —O—, at least one —CH═ in these rings is optionally replaced with —N═, and at least one hydrogen atom in these rings is optionally replaced with a halogen atom, an alkyl group having 1 to 5 carbon atoms, or an alkyl halide having 1 to 5 carbon atoms. In consideration of the stability of compounds, —CH₂—O—CH₂—O— in which oxygen and oxygen are not adjacent to each other is more preferable than —CH₂—O—O—CH₂— in which oxygen and oxygen are adjacent to each other. This also applies to sulfur.

Among these, particularly preferably, A^{M} is 1,4-cyclohexylene, 1,4-cyclohexenylene, 1,4-phenylene, 2-fluoro-1,4-phenylene, 2,3-difluoro-1,4-phenylene, 2,5-difluoro-1,4-phenylene, 2,6-difluoro-1,4-phenylene, 2-methyl-i 1,4-phenylene, 2-trifluoromethyl-1,4-phenylene, 2,3-bis(trifluoromethyl)-1,4-phenylene, naphthalene-2,6-diyl, tetrahydro naphthalene-2,6-diyl, fluorene-2,7-diyl, 9-methyl fluorene-2,7-diyl, 1,3-dioxane-2,5-diyl, pyridine-2,5-diyl, or pyrimidine-2,5-diyl. Here, the configuration of 1,4-cyclohexylene and 1,3-dioxane-2,5-diyl is preferably trans rather than cis.

Since 2-fluoro-1,4-phenylene is structurally identical to 3-fluoro-1,4-phenylene, the latter is not exemplified. This rule also applies to the relationship between 2,5-difluoro-1,4-phenylene and 3,6-difluoro-1,4-phenylene.

In Formulae (M1) and (M2), Y is independently a single bond or an alkylene group having 1 to 20 carbon atoms, and at least one —CH₂— in the alkylene group is optionally replaced with —O—, or —S—, and at least one —CH₂—CH₂— in the alkylene group is optionally replaced with —CH═CH—, —C≡C—, —COO—, or —OCO—. Preferably, Y is a single bond, —(CH₂)ₘ₂—, —O(CH₂)ₘ₂—, or —(CH₂)ₘ₂O— (in the above formula, m2 is an integer of 1 to 20). Particularly preferably, Y is a single bond, —(CH₂)ₘ₂—, —O(CH₂)ₘ₂—, or —(CH₂)ₘ₂O— (in the above formula, m2 is an integer of 1 to 10). In consideration of the stability of compounds, it is preferable that —Y—R^{a} and —Y—R^{b} have no —O—O—, —O—S—, —S—O—, or —S—S— in the group.

In Formulae (M1) and (M2), Z^{M} is independently a single bond, —(CH₂)ₘ₃—, —O(CH₂)ₘ₃—, —(CH₂)ₘ₃O—, —O(CH₂)ₘ₃O—, —CH═CH—, —C≡C—, —COO—, —OCO—, —(CF₂)₂—, —(CH₂)₂—COO—, —OCO—(CH₂)₂—, —CH═CH—COO—, —OCO—CH═CH—, —C≡C≡COO—, —OCO—C≡C—, —CH═CH—(CH₂)₂—, —(CH₂)₂—CH═CH—, —CF═CF—, —C≡C—CH═CH—, —CH═CH—C≡C—, —OCF₂—(CH₂)₂—, —(CH₂)₂—CF₂O—, —OCF₂— or —CF₂O— (in the above formula, m3 is an integer of 1 to 20).

Preferably, Z^{M} is a single bond, —(CH₂)ₘ₃—, —O(CH₂)ₘ₃—, —(CH₂)ₘ₃O—, —CH═CH—, —C≡C—, —COO—, —OCO—, —(CH₂)₂—COO—, —OCO—(CH₂)₂—, —CH═CH—COO—, —OCO—CH═CH—, —OCF₂—, or —CF₂O—.

In Formulae (M1) and (M2), m1 is an integer of 1 to 6, and m1 is preferably an integer of 1 to 3. When m1 is 1, the compound is a bicyclic compound having two rings such as a 6-membered ring. When m1 is 2 or 3, the compound is a tricyclic or tetracyclic compound. For example, when m1 is 1, two of the A^{M} may be the same as or different from each other. In addition, for example, when m1 is 2, three A^{M} (or two Z^{M}) may be the same as or different from each other. This also applies when m1 is 3 to 6. This also applies for R^{a}, R^{b}, R^{d}, Z^{M}, A^{M} and Y.

Compound (M1) represented by Formula (M1) and Compound (M2) represented by Formula (M2) can be preferably used because they have the same properties even if they contain a larger amount of isotopes such as ²H (deuterium) and ¹³C than a natural abundance of isotopes.

More preferable examples of Compound (M1) and Compound (M2) include Compounds (M1-1) to (M1-41) and Compounds (M2-1) to (M2-27) represented by Formulae (M1-1) to (M1-41) and (M2-1) to (M2-27). In these compounds, definitions of R^{a}, R^{b}, R^{d}, Z^{M}, A^{M}, Y and p are the same as those of Formula (M1) and Formula (M2) described in the form of the disclosure.

The following partial structures in Compounds (M1-1) to (M1-41) and (M2-1) to (M2-27) will be described. A partial structure (a1) represents 1,4-phenylene in which at least one hydrogen atom is replaced with a fluorine atom. A partial structure (a2) represents 1,4-phenylene in which at least one hydrogen atom is optionally replaced with a fluorine atom. A partial structure (a3) represents 1,4-phenylene in which at least one hydrogen atom is optionally replaced with a fluorine atom or a methyl group. A partial structure (a4) represents fluorine in which a hydrogen atom at position 9 is optionally replaced with a methyl group.

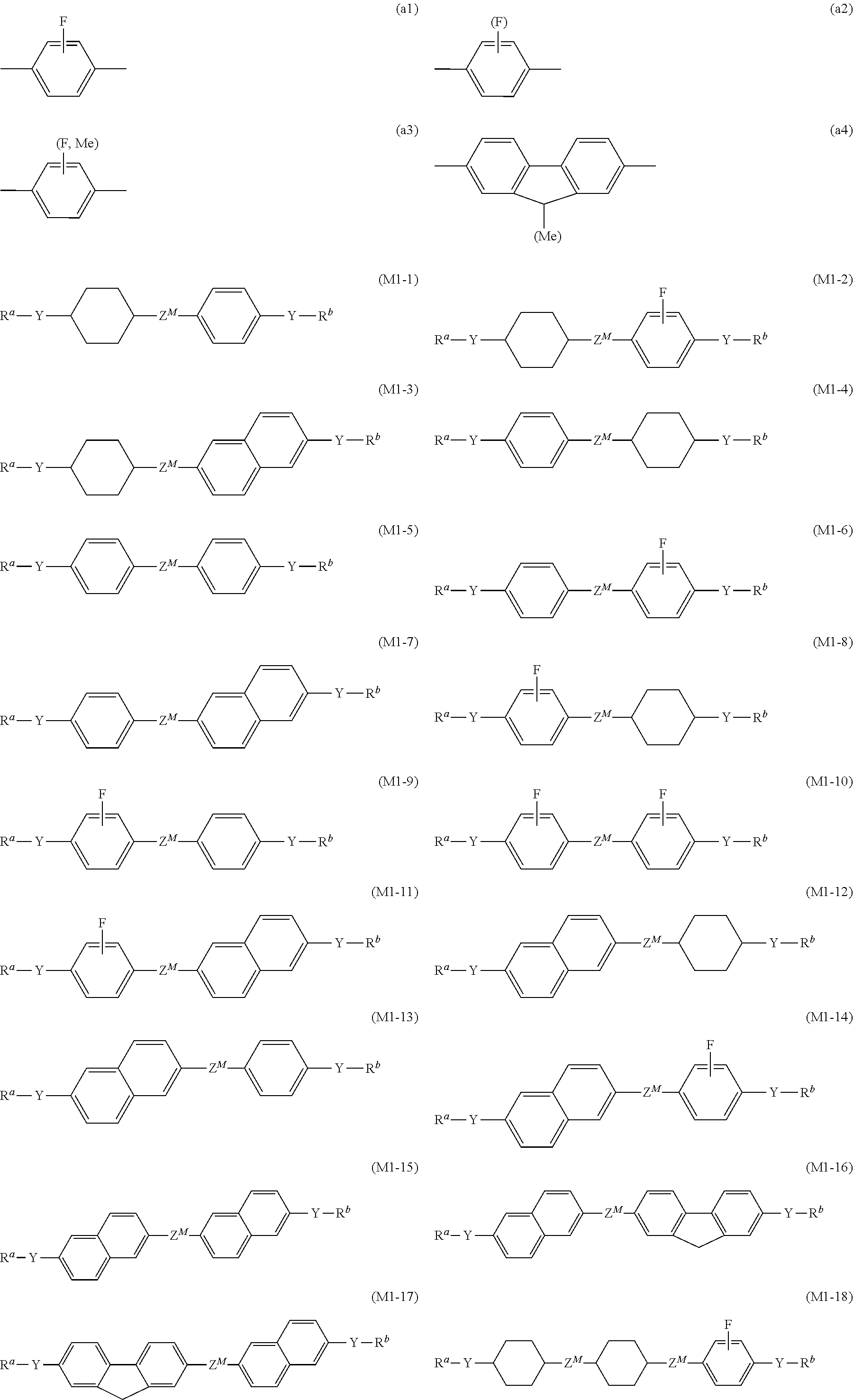

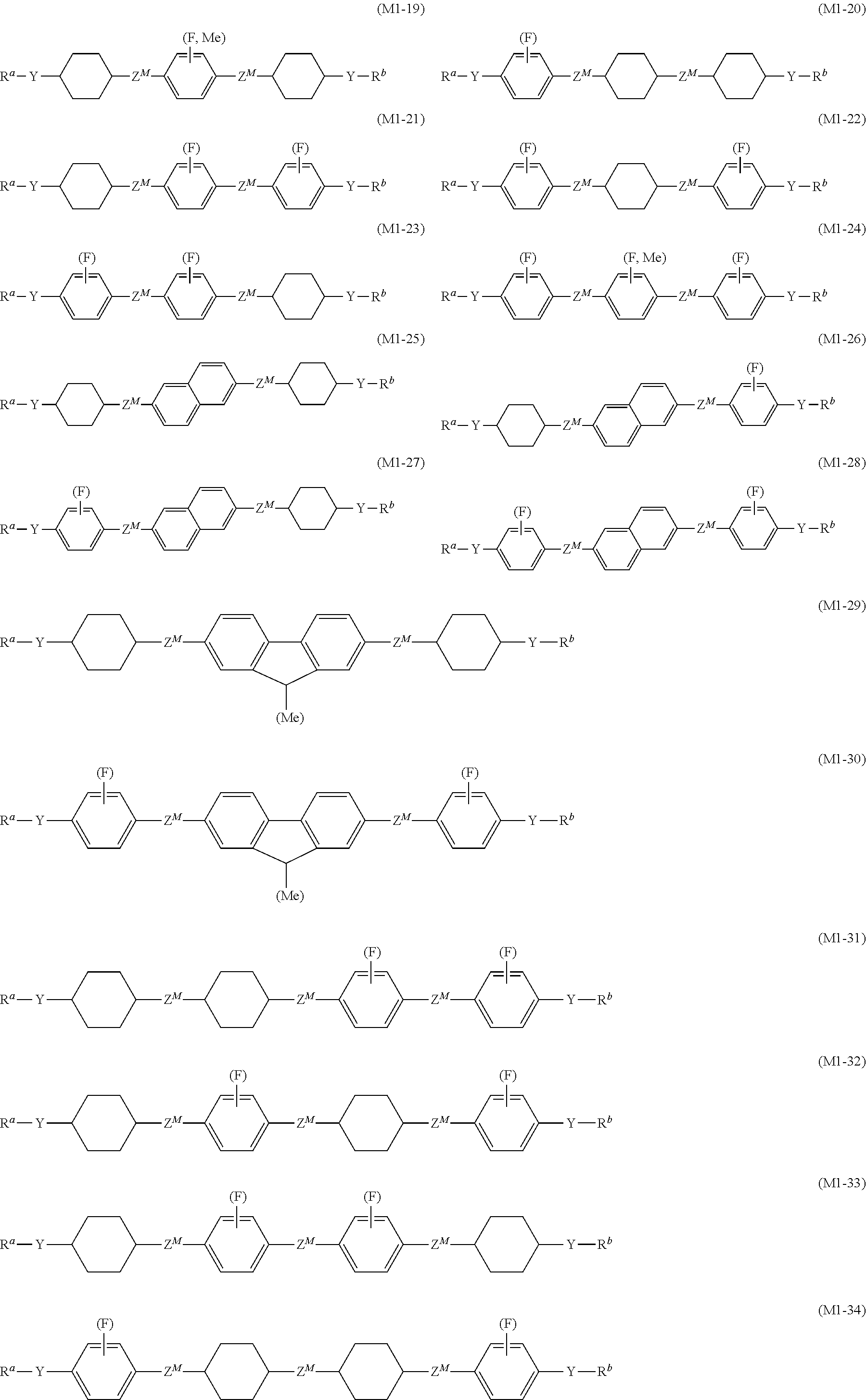

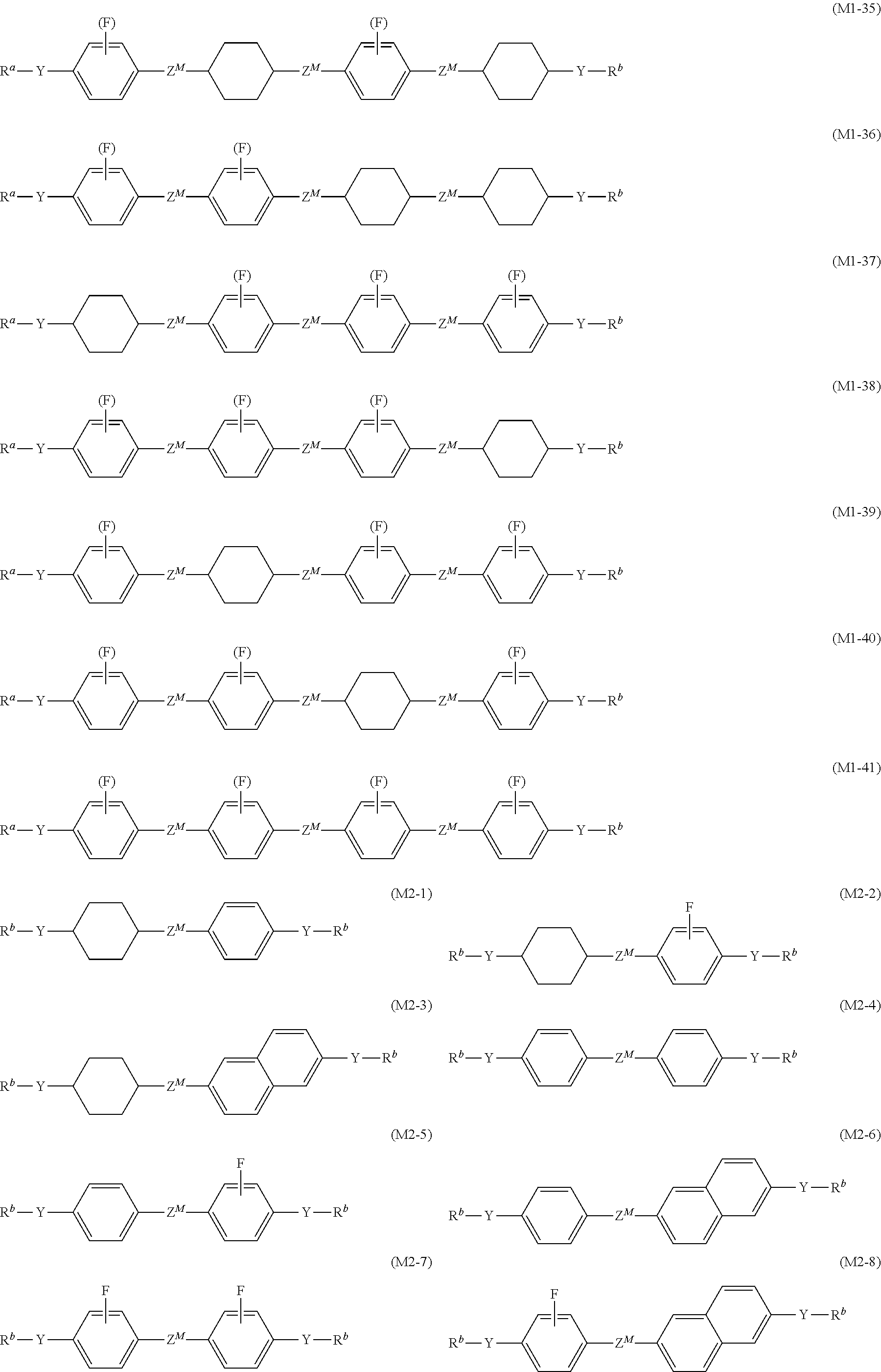

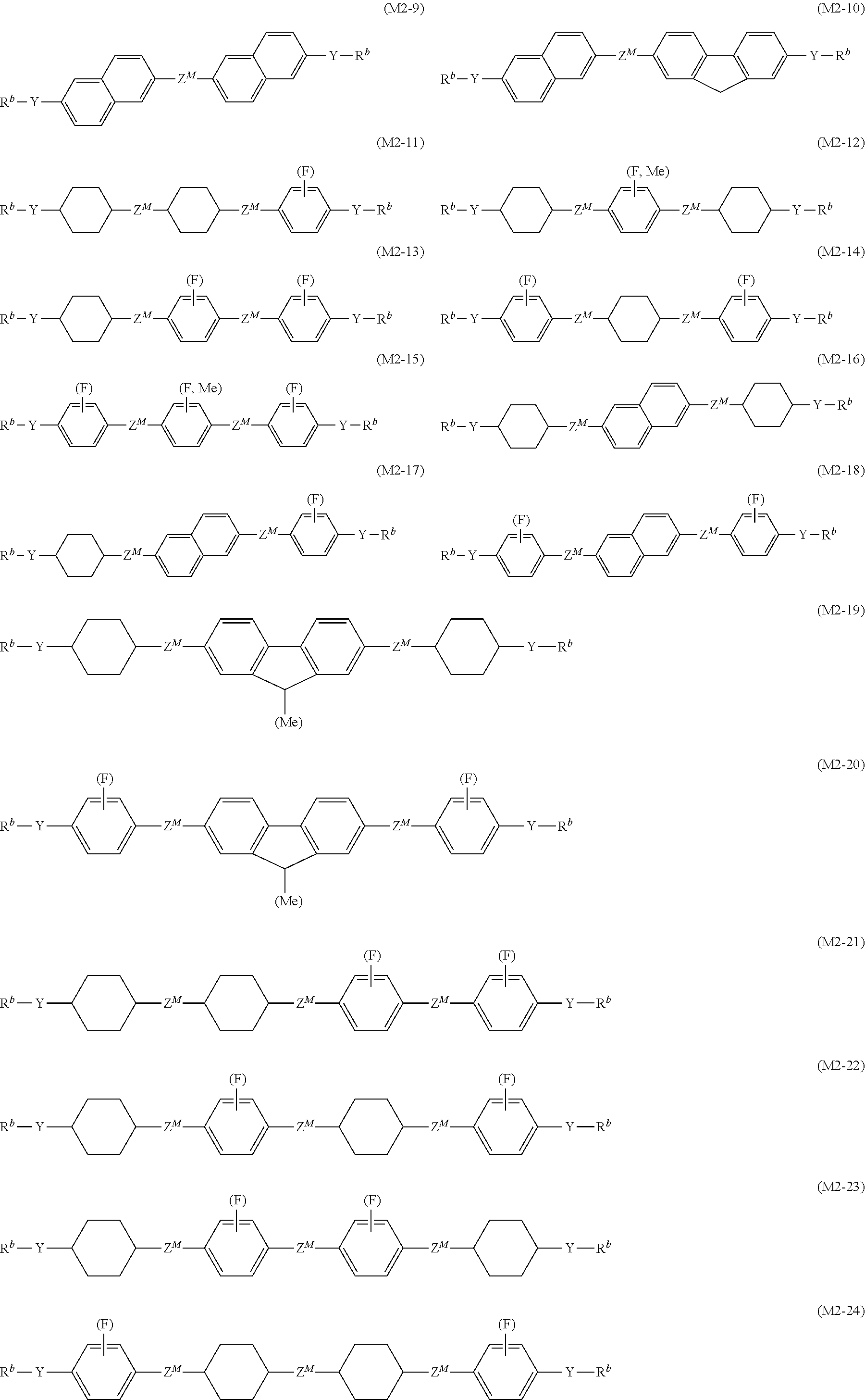

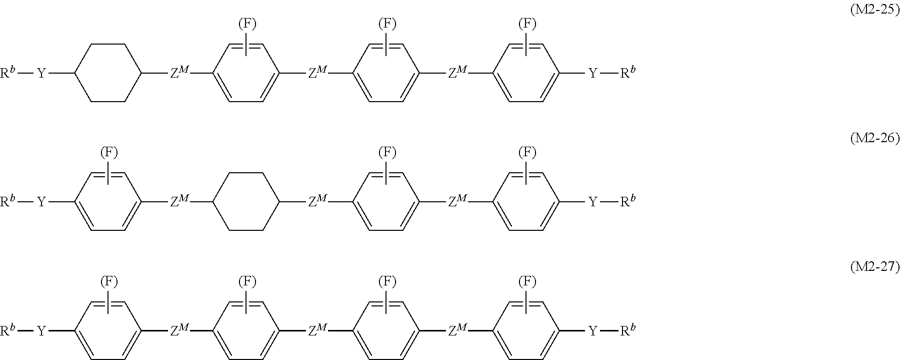

In order to optimize optical isotropy of the polymer/liquid crystal composite material of the disclosure, monomers having three or more polymerizable functional groups having mesogen sites can be used. Regarding monomers having three or more polymerizable functional groups having mesogen sites, known compounds can be suitably used. For example, (M4-1) to (M4-3), and as more specific examples, compounds described in Japanese Patent Laid-Open No. 2000-327632, Japanese Patent Laid-Open No. 2004-182949, and Japanese Patent Laid-Open No. 2004-59772 can be used. Here, in (M4-1) to (M4-3), definitions of R^{b}, Y, and (F) are the same as those described above. The definition of Za is the same as Z^{M} described above.

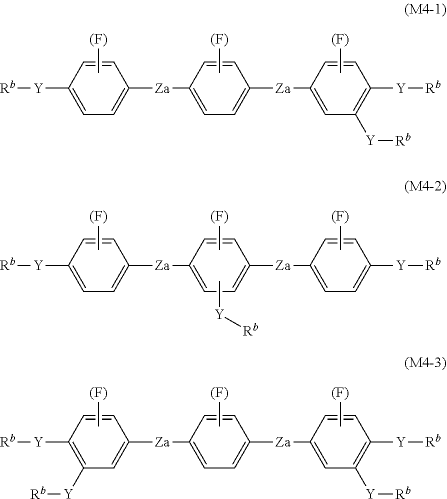

5-2-2. Monomers Having a Polymerizable Functional Group Having No Mesogen Site

Regarding monomers having a polymerizable functional group having no mesogen site, examples of a linear or branched acrylate having 1 to 30 carbon atoms, a linear or branched diacrylate having 1 to 30 carbon atoms, and monomers having three or more polymerizable functional groups include glycerol propoxylate (1 PO/OH)triacrylate, pentaerythritol propoxylate triacrylate, pentaerythritol triacrylate, trimethylolpropane ethoxylate triacrylate, trimethylolpropane propoxylate triacrylate, trimethylolpropane triacrylate, di(trimethylolpropane)tetraacrylate, pentaerythritol tetraacrylate, di(pentaerythritol)pentaacrylate, di(pentaerythritol)hexaacrylate, trimethylolpropane triacrylate, but the disclosure is not limited thereto.

5-2-3. Polymerization Initiator

A polymerization reaction in production of polymers constituting the composite material of the disclosure is not particularly limited. For example, photoradical polymerization, thermal radical polymerization, photo cationic polymerization, or the like is performed.

Examples of the photoradical polymerization initiator that can be used in photoradical polymerization include DAROCUR 1173 and 4265 (product name, commercially available from BASF Japan), and IRGACURE 184, 369, 500, 651, 784, 819, 907, 1300, 1700, 1800, 1850, and 2959 (product name, commercially available from BASF Japan).

Examples of preferable polymerization initiators for radical polymerization by heat that can be used in thermal radical polymerization include benzoyl peroxide, diisopropyl peroxydicarbonate, t-butylperoxy-2-ethylhexanoate, t-butyl peroxypivalate, t-butyl peroxydiisobutyrate, lauroyl peroxide, dimethyl 2,2′-azobisisobutyrate (MAIB), di-t-butyl peroxide (DTBPO), azobisisobutyronitrile (AIBN), and azobiscyclohexanecarbonitrile (ACN).

Examples of the photo cationic polymerization initiator that can be used in photo cationic polymerization include a diaryl iodonium salt (hereinafter referred to as “DAS”), and a triaryl sulfonium salt (hereinafter referred to as “TAS”).

Examples of DAS include diphenyliodonium tetrafluoroborate, diphenyliodonium hexafluorophosphonate, diphenyliodonium hexafluoroarsenate, diphenyliodonium trifluoromethanesulfonate, diphenyliodonium trifluoroacetate, diphenyliodonium-p-toluene sulfonate, diphenyliodonium tetra(pentafluorophenyl)borate, 4-methoxyphenyl phenyl iodonium tetrafluoroborate, 4-methoxyphenyl phenyl iodonium hexafluorophosphonate, 4-methoxyphenylphenyl iodonium hexafluoroarsenate, 4-methoxyphenylphenyl iodonium trifluoromethanesulfonate, 4-methoxyphenylphenyl iodonium trifluoroacetate, and 4-methoxyphenylphenyliodonium-p-toluene sulfonate.

High sensitivity can be imparted to DAS by adding a photosensitizer such as thioxanthone, phenothiazine, chlorothioxanthone, xanthone, anthracene, diphenylanthracene, and rubrene.

Examples of TAS include triphenylsulfonium tetrafluoroborate, triphenylsulfonium hexafluorophosphonate, triphenylsulfonium hexafluoroarsenate, triphenylsulfonium trifluoromethanesulfonate, triphenylsulfonium trifluoroacetate, triphenylsulfonium-p-toluene sulfonate, triphenylsulfonium tetra(pentafluorophenyl)borate, 4-methoxyphenyldiphenylsulfonium tetrafluoroborate, 4-methoxyphenyldiphenylsulfonium hexafluorophosphonate, 4-methoxyphenyldiphenylsulfonium hexafluoroarsenate, 4-methoxyphenyldiphenylsulfonium trifluoromethanesulfonate, 4-methoxyphenyldiphenylsulfonium trifluoroacetate, and 4-methoxyphenyldiphenylsulfonium-p-toluene sulfonate.

Specific examples of product names of the photo cationic polymerization initiator include Cyracure UVI-6990, Cyracure UVI-6974, and Cyracure UVI-6992 (product name, commercially available from UCC), Adeka Optomer SP-150, SP-152, SP-170, and SP-172 (product name, commercially available from ADEKA), Rhodorsil Photoinitiator 2074 (product name, commercially available from Rhodia Japan), IRGACURE 250 (product name, commercially available from BASF Japan), and UV-9380C (product name, commercially available from GE Toshiba Silicones).

5-2-4. Curing Agent and the Like

When polymers constituting the composite material of the disclosure are produced, one, two or more other suitable components, for example, a curing agent, a curing accelerator, and a stabilizer may be additionally added in addition to the polymerizable monomers and the like and the polymerization initiator.

Regarding the curing agent, a latent curing agent known in the related art which is generally used as a curing agent for an epoxy resin can be used. Examples of a curing agent for a latent epoxy resin include an amine-based curing agent, a novolak resin-based curing agent, an imidazole-based curing agent, and an acid anhydride-based curing agent. Examples of the amine-based curing agent include aliphatic polyamines such as diethylenetriamine, triethylenetetramine, tetraethylene pentamine, m-xylenediamine, trimethylhexamethylenediamine, 2-methylpentamethylenediamine, and diethylaminopropylamine, alicyclic polyamines such as isophorone diamine, 1,3-bisaminomethyl cyclohexane, bis(4-aminocyclohexyl)methane, norbornene diamine, 1,2-diaminocyclohexane, and laromin, and aromatic polyamines such as diaminodiphenylmethane, diaminodiphenylethane, and metaphenylenediamine.

Examples of the novolak resin-based curing agent include a phenol novolak resin, and a bisphenol novolak resin. Examples of the imidazole-based curing agent include 2-methylimidazole, 2-ethylhexylimidazole, 2-phenylimidazole, and 1-cyanoethyl-2-phenylimidazolium trimellitate.

Examples of the acid anhydride-based curing agent include tetrahydrophthalic anhydride, hexahydrophthalic anhydride, methyltetrahydrophthalic anhydride, methylhexahydrophthalic anhydride, methyl cyclohexene tetracarboxylic dianhydride, phthalic anhydride, trimellitic anhydride, pyromellitic anhydride, and benzophenone tetracarboxylic dianhydride.

In addition, a curing accelerator for promoting a curing reaction between polymerizable compounds having a glycidyl group, an epoxy group, and an oxetanyl group and a curing agent may be additionally used. Examples of the curing accelerator include tertiary amines such as benzyldimethylamine, tris(dimethylaminomethyl)phenol, and dimethylcyclohexylamine, imidazoles such as 1-cyanoethyl-2-ethyl-4-methylimidazole, and 2-ethyl-4-methylimidazole, organic phosphorus compounds such as triphenylphosphine, quaternary phosphonium salts such as tetraphenylphosphonium bromide, diazabicycloalkenes such as 1,8-diazabicyclo [5.4.0]undecene-7 and organic acid salts thereof, quaternary ammonium salts of tetraethylammonium bromide, tetrabutylammonium bromide and the like, and boron compounds such as boron trifluoride and triphenyl borate. These curing accelerators can be used alone or a mixture of two or more thereof can be used.

In addition, for example, in order to prevent undesired polymerization during storage, a stabilizer is preferably added. All compounds known to those skilled in the art can be used as the stabilizer. Representative examples of the stabilizer include 4-ethoxyphenol, hydroquinone, and butylated hydroxytoluene (BHT).

5-3. Composition of Polymer/Liquid Crystal Composite Material

The content of the liquid crystal composition in the polymer/liquid crystal composite material of the disclosure is preferably as high as possible as long as the composite material can exhibit an optically isotropic liquid crystal phase. This is because, as the content of the liquid crystal composition is higher, the electric birefringence value of the composite material of the disclosure is larger.

In the polymer/liquid crystal composite material of the disclosure, the content of the liquid crystal composition with respect to the composite material is preferably 60 to 99 weight %, more preferably 60 weight % to 98 weight %, and particularly preferably 80 weight % to 97 weight %. In addition, in the polymer/liquid crystal composite material of the disclosure, the content of polymers with respect to the composite material is preferably 1 weight % to 40 weight %, more preferably 2 weight % to 40 weight %, and particularly preferably 3 weight % to 20 weight %.

6. Optical Switching Element

As will be described in detail in the following examples, regarding an element for applying a voltage to a surface of an electrode in the vertical direction, the element was inserted between glass substrates with two electrodes not subjected to an alignment treatment, the obtained cell was heated so that the blue phase was exhibited. In this state, ultraviolet light was emitted so that a polymerization reaction occurred. The polymer/liquid crystal composite material (PSBP-A1) obtained in this manner maintained the optically isotropic liquid crystal phase even when cooled to room temperature. The cell into which the polymer/liquid crystal composite material was inserted was used as an optical switching element.

In addition, regarding an element for applying a voltage to a surface of an electrode in the horizontal direction, a liquid crystal composition was inserted between a comb-shaped electrode substrate not subjected to an alignment treatment and a facing glass substrate (non-electrode application), and the obtained cell was heated so that the blue phase was exhibited. In this state, ultraviolet light was emitted so that a polymerization reaction occurred. The polymer/liquid crystal composite material obtained in this manner maintained the optically isotropic liquid crystal phase even when cooled to room temperature. The cell into which the polymer/liquid crystal composite material was inserted was used as an optical switching element.

### EXAMPLES

While the disclosure will be described below in further detail with reference to examples, the disclosure is not limited to such examples. Here, unless otherwise specified, “%” refers to “weight %.”

Since the obtained compounds were identified using nuclear magnetic resonance spectrums obtained in ¹H-NMR analysis and gas chromatograms obtained in gas chromatograph (GC) analysis, analysis methods will be described first.

¹H-NMR analysis:

DRX-500 (commercially available from Bruker BioSpin) was as a measurement device. Samples produced in examples and the like were dissolved in a deuterated solvent in which a sample such as CDCl₃ was soluble, and measurement was performed under conditions of room temperature, 500 MHz with a cumulative number of 24 measurements. Here, in description of the obtained nuclear magnetic resonance spectrum, s indicates a singlet, d indicates a doublet, t indicates a triplet, q indicates a quartet, and m indicates a multiplet. In addition, tetramethylsilane (TMS) was used as a reference substance at a zero point of a chemical shift δ value.

Gc Analysis:

As a measurement device, GC-14B type gas chromatograph (commercially available from Shimadzu Corporation) was used. A capillary column CBP1-M25-025 (commercially available from Shimadzu Corporation) (with a length of 25 m, an inner diameter of 0.22 mm, and a film thickness of 0.25 μm; and a fixed liquid phase of dimethyl polysiloxane; nonpolar) was used as the column. A helium gas was used as a carrier gas, and a flow rate was adjusted to 1 ml/min. A temperature of a sample vaporization chamber was set to 300° C., and a temperature of a detector (FID) part was set to 300° C.

The sample was dissolved in toluene to prepare a 1 weight % solution, and 1 μl of the obtained solution was injected into the sample vaporization chamber. As a recorder, a C-R6A type Chromatopac (commercially available from Shimadzu Corporation) or a device equivalent thereto was used. In the obtained gas chromatogram, retention times of peaks corresponding to component compounds and area values of peaks were shown.

Here, as a dilution solvent for a sample, for example, chloroform and hexane may be used. In addition, as the column, a capillary column DB-1 (commercially available from Agilent Technologies Inc.) (with a length of 30 m, an inner diameter of 0.32 mm, and a film thickness of 0.25 μm), HP-1 (commercially available from Agilent Technologies Inc.) (with a length 30 m, an inner diameter of 0.32 mm, and a film thickness of 0.25 μm), Rtx-1 (commercially available from Restek Corporation) (with a length of 30 m, an inner diameter of 0.32 mm, and a film thickness of 0.25 μm), BP-1 (commercially available from SGE International Pty. Ltd.) (with a length of 30 m, an inner diameter of 0.32 mm, and a film thickness of 0.25 μm) and the like may be used.

An area ratio of peaks in the gas chromatogram corresponded to a ratio of component compounds. Generally, weight % of the component compound of the analysis sample was not completely the same as area % of each peak in the analysis sample. However, when the above column in the disclosure was used, since a correction coefficient was substantially 1, weight % of the component compound in the analysis sample almost corresponded to area % of each peak in the analysis sample. This is because there was no large difference in the correction coefficient in the liquid crystal compound of the component. In order to obtain a composition proportion of the liquid crystal compound in the liquid crystal composition more accurately according to gas chromatogram, an internal standard method according to gas chromatogram was used. Each liquid crystal compound component (test component) that was accurately weighed out in a certain amount and a liquid crystal compound serving as a reference (reference substance) were measured at the same time according to gas chromatograph, and a relative intensity of an area ratio between a peak of the obtained test component and a peak of the reference substance was calculated in advance. When a relative intensity of a peak area of each component with respect to the reference substance was used for correction, it was possible to obtain a composition proportion of the liquid crystal compound in the liquid crystal composition more accurately through gas chromatograph analysis.

Sample for measuring physical property values of a liquid crystal compound and the like:

Regarding a sample for measuring physical property values of a liquid crystal compound, there were two cases: a case in which a compound itself was used as a sample and a case in which a compound was mixed with a mother liquid crystal to obtain a sample.

In the latter case in which a sample obtained by mixing a compound with a mother liquid crystal was used, measurement was performed by the following method. First, 15 weight % of the obtained liquid crystal compound and 85 weight % of the mother liquid crystal were mixed to prepare a sample. Then, an extrapolated value was calculated from the measured value of the obtained sample according to an extrapolation method based on the following calculation formula. This extrapolated value was determined as a physical property value of the compound.

<Extrapolated value>=(100×<measured value of sample>−<weight % of mother liquid crystal>×<measured value of mother liquid crystal>)/<weight % of liquid crystal compound>

Even if a ratio between the liquid crystal compound and the mother liquid crystal was this ratio, when a smectic phase or a crystal was precipitated at 25° C., a ratio between the liquid crystal compound and the mother liquid crystal was changed in the order of 10 weight %:90 weight %, 5 weight %:95 weight %, and 1 weight %:99 weight %, and a physical property value of the sample with a composition in which the smectic phase or the crystal was not precipitated at 25° C. was measured, an extrapolated value was obtained according to the above formula, and this was determined as a physical property value of the liquid crystal compound.

There were various types of mother liquid crystals used for measurement. For example, the composition (weight %) of the mother liquid crystal A was as follows.

### Mother Liquid Crystal A:

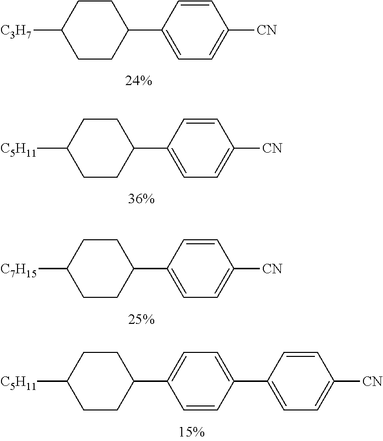

Method of measuring a physical property value of a liquid crystal compound and the like:

The following methods were used to measure physical property values. Many of these measurement methods were methods described in EIAJ-ED-2521A (Standard of Electric Industries Association of Japan) or modified methods thereof. In addition, no TFT was attached to a TN element used for measurement.

Among measured values, the obtained value was described as experiment data when the liquid crystal compound itself was used as a sample. When a mixture of the liquid crystal compound and the mother liquid crystal was used as a sample, the value obtained by the extrapolation method was described as experiment data.

Phase Structure and Phase Transition Temperature (° C.):

Measurement was performed by the following (1) and (2) methods.

(1) A compound was placed on a hot plate of a melting point measuring device having a polarizing microscope (FP-52 type hot stage commercially available from Mettler), a phase state and its change were observed under a polarizing microscope while heating at a rate of 3° C./min, and the type of the liquid crystal phase was determined.
(2) A starting point of an endothermic peak or an exothermic peak resulting from a phase change in the sample was obtained by extrapolation (on set) using a scanning calorimeter DSC-7 system or Diamond DSC system (commercially available from PerkinElmer Inc.) while heating at a rate of 3° C./min, and a phase transition temperature was determined.

Hereinafter, K represents a crystal, and when crystals are distinguished, they are represented by K₁ and K₂. In addition, Sm represents a smectic phase, N represents a nematic phase, and N* represents a chiral nematic phase. I represents a liquid (isotropic). When the smectic phase is distinguished as a smectic B phase or a smectic A phase, it is represented by SmB or SmA. BP represents a blue phase or an optically isotropic liquid crystal phase. A 2-phase coexistence state may be represented by a format of (N*+I), and (N*+BP). Specifically, (N*+I) represents a phase in which a non-liquid crystalline isotropic phase and a chiral nematic phase coexist, and (N*+BP) represents a phase in which a BP phase or an optically isotropic liquid crystal phase, and a chiral nematic phase coexist. Un represents an unidentified phase that is not optically isotropic. Regarding the notation of the phase transition temperature, for example, “K 50.0 N 100.0 I” represents that a phase transition temperature (KN) from a crystal to a nematic phase was 50.0° C., and a phase transition temperature (NI) from a nematic phase to a liquid was 100.0° C. In addition, “BP—I” represents that it was not possible to determine a phase transition temperature from a blue phase or an optically isotropic liquid crystal phase to a liquid (isotropic), and “N 83.0-83.4 I” represents that a phase transition temperature from a nematic phase to a liquid (isotropic) had a range of 83.0° C. to 83.4° C. This similarly applies to other notations.

Upper Limit Temperature of Nematic Phase (T_{NI}; ° C.):

A sample (a mixture of the liquid crystal compound and the mother liquid crystal) was placed on a hot plate of a melting point measuring device having a polarizing microscope (FP-52 type hot stage commercially available from Mettler), and observed under a polarizing microscope while heating at a rate of 1° C./min. A temperature at which a part of the sample was changed from a nematic phase to an isotropic liquid was determined as an upper limit temperature of the nematic phase. Hereinafter, the upper limit temperature of the nematic phase may be abbreviated simply as an “upper limit temperature.”

Low Temperature Compatibility:

A sample in which a mother liquid crystal and a liquid crystal compound were mixed together so that an amount of the liquid crystal compound was 20 weight %, 15 weight %, 10 weight %, 5 weight %, 3 weight %, and 1 weight % was prepared, and the sample was put into a glass bottle. The glass bottle was stored in a freezer at −10° C. or −20° C. for a certain period, and it was then observed whether a crystal or a smectic phase was precipitated.

Viscosity (η; Measured at 20° C.; mPa·s):

A mixture of the liquid crystal compound and the mother liquid crystal was measured using an E type viscometer.

Refractive Index Anisotropy (αn):

Measurement was performed using an Abbe refractometer in which a polarizing plate was attached to an eyepiece at a temperature of 25° C. using light with a wavelength of 589 nm. A surface of a main prism was rubbed in one direction and the sample (a mixture of the liquid crystal compound and the mother liquid crystal) was then added dropwise to the main prism. The refractive index (n∥) was measured when a polarization direction was parallel to a rubbing direction. The refractive index (n⊥) was measured when the polarization direction was perpendicular to the rubbing direction. The value of the refractive index anisotropy (Δn) was calculated from the formula Δn=n∥−n⊥.

Dielectric Anisotropy (αε; Measured at 25° C.):

The sample (a mixture of the liquid crystal compound and the mother liquid crystal) was inserted into a liquid crystal cell having an interval (gap) between two glass substrates of about 9 μm and a twist angle of 80 degrees. 20 V was applied to the cell, and a dielectric constant (ε∥) of liquid crystal molecules in the long axis direction was measured. 0.5 V was applied, and a dielectric constant (ε⊥) of liquid crystal molecules in the short axis direction was measured. The value of the dielectric anisotropy was calculated from the formula Δε=ε∥−ε⊥.

Pitch (P; Measured at 25° C.; Nm):

The pitch length was measured using selective reflection (Handbook of Liquid Crystals, p 196, published in 2000, Maruzen). For the selective reflection wavelength λ, the relational formula <n>p/λ=1 was established. Here, <n> represents an average refractive index, and is obtained by the following formula. <n>={(n∥²+n⊥²)/2}^{1/2}. The selective reflection wavelength was measured by a microspectrophotometer (product name MSV-350 commercially available from JEOL Ltd.). The pitch was obtained by dividing the obtained reflection wavelength by the average refractive index. Since the pitch of the cholesteric liquid crystal having a reflection wavelength in a longer wavelength range than that of visible light was proportional to a reciprocal number of the concentration of the optically active compound in a region in which the concentration of the optically active compound was low, the pitch length of liquid crystals having a selective reflection wavelength in a visible light range was measured several times and a linear extrapolation method was used for measurement. The “optically active compound” corresponds to the chiral agent in the disclosure.

In the disclosure, property values of the liquid crystal composition can be measured according to the following methods. Many of them are methods described in EIAJ and ED-2521A (Standard of Electric Industries Association of Japan) or modified methods thereof. No TFT was attached to a TN element used for measurement.

Upper Limit Temperature of Nematic Phase (NI; ° C.):

A sample was placed on a hot plate of a melting point measuring device having a polarizing microscope while heating at a rate of 1° C./min. A temperature at which a part of the sample was changed from a nematic phase to an isotropic liquid was measured. The upper limit temperature of the nematic phase may be abbreviated as an “upper limit temperature.”

Lower Limit Temperature of Nematic Phase (T_{C}; ° C.):

A sample having a nematic phase was stored in a freezer at 0° C., −10° C., −20° C., −30° C., and −40° C. for 10 days, and then a liquid crystal phase was observed. For example, when the sample remained in a nematic phase at −20° C. and was changed to a crystal (or a smectic phase) at −30° C., T_{C}≤−20° C. was described. The lower limit temperature of the nematic phase may be abbreviated as a “lower limit temperature.”

Transition Temperature of Optically Isotropic Liquid Crystal Phase:

The sample was placed on a hot plate of a melting point measuring device having a polarizing microscope, and in a crossed Nicole state, first, the sample was heated to a temperature at which a non-liquid crystalline isotropic phase was exhibited, and the temperature was then lowered at a rate of 1° C./min, and a chiral nematic phase or an optically isotropic liquid crystal phase appeared completely. The temperature at which a phase transition occurred during the temperature lowering process was measured, and the temperature was then raised at a rate of 1° C./min, and the temperature at which a phase transition occurred in the temperature raising process was measured. In the disclosure, unless otherwise noted, the temperature at which a phase transition occurred in the temperature raising process was set as a phase transition temperature. When it was difficult to determine a phase transition temperature in a dark field in the crossed Nicole state in the optically isotropic liquid crystal phase, the phase transition temperature was measured by shifting the polarizing plate from the crossed Nicole state by 1 to 100.

Viscosity (η; Measured at 20° C.; mPa·s):

An E type viscometer was used for measurement.

Rotational Viscosity (γI; Measured at 25° C.; mPa·s):

1) Sample having positive dielectric anisotropy: Measurement was performed according to the method described in M. Imai et al., Molecular Crystals and Liquid Crystals, Vol. 259, 37 (1995). The sample was inserted into a TN element having a twist angle of 0° and an interval (cell gap) between two glass substrates of 5 μm. Voltages in a range of 16 V to 19.5 V were gradually applied at 0.5 V intervals to the TN element. After no application for 0.2 seconds, application was repeated under conditions of only one square wave (rectangular pulse; 0.2 seconds) and no application (2 seconds). A peak current and a peak time of a transient current generated according to the application were measured. The value of rotational viscosity was obtained from these measured values and Calculation Formula (8) on page 40 in the paper of M. Imai. The value of dielectric anisotropy necessary for this calculation was obtained using the element used for measuring the rotational viscosity by the following dielectric anisotropy measurement method.
2) Sample having negative dielectric anisotropy: Measurement was performed according to the method described in M. Imai et al., Molecular Crystals and Liquid Crystals, Vol. 259, 37 (1995). The sample was inserted into a VA element having an interval (cell gap) between two glass substrates of 20 μm. Voltages in a range of 30 V to 50 V were gradually applied at 1 V intervals to the element. After no application for 0.2 seconds, application was repeated under conditions of only one square wave (rectangular pulse; 0.2 seconds) and no application (2 seconds). A peak current and a peak time of a transient current generated according to the application were measured. The value of rotational viscosity was obtained from these measured values and Calculation Formula (8) on page 40 in the paper of M. Imai. For the dielectric anisotropy necessary for this calculation, the value measured by the following dielectric anisotropy was used.

Refractive Index Anisotropy (αn; Measured at 25° C.):

Measurement was performed using an Abbe refractometer in which a polarizing plate was attached to an eyepiece using light with a wavelength of 589 nm. A surface of a main prism was rubbed in one direction, and the sample was then added dropwise to the main prism. The refractive index (n∥) was measured when the polarization direction was parallel to the rubbing direction. The refractive index (n⊥) was measured when the polarization direction was perpendicular to the rubbing direction. The value of the refractive index anisotropy was calculated from the formula Δn=n∥−n⊥. When the sample was a composition, the refractive index anisotropy was measured by this method.

Dielectric Anisotropy (Δε; Measured at 25° C.):

1) Composition having positive dielectric anisotropy: A sample was inserted into a liquid crystal cell having an interval (gap) between two glass substrates of about 9 μm and a twist angle of 80 degrees. 20 V was applied to the cell, and a dielectric constant (ε∥) of liquid crystal molecules in the long axis direction was measured. 0.5 V was applied, and a dielectric constant (ε⊥) of liquid crystal molecules in the short axis direction was measured. The value of the dielectric anisotropy was calculated from the formula Δε=ε∥−ε⊥.
2) Composition having negative dielectric anisotropy: A sample was inserted into a liquid crystal cell subjected to a homeotropic alignment, 0.5 V was applied and a dielectric constant (ε∥) was measured. The sample was inserted into the liquid crystal cell subjected to the homogeneous alignment, 0.5 V was applied, and a dielectric constant (ε⊥) was measured. The value of the dielectric anisotropy was calculated from the formula Δε=ε∥−ε⊥.

### Threshold Voltage (Vth; Measured at 25° C.; V):

1) Composition having positive dielectric anisotropy: A sample was inserted into a normally white mode liquid crystal display element having an interval (gap) between two glass substrates of (0.5/Δn) μm and a twist angle of 80 degrees. Δn was a value of the refractive index anisotropy measured according to the above method. A square wave having a frequency of 32 Hz was applied to the element. The voltage of the square wave was increased and the value of a voltage when a transmittance of light passing through the element was 90% was measured.
2) Composition having negative dielectric anisotropy: A sample was inserted into a normally black mode liquid crystal display element subjected to a homeotropic alignment having an interval (gap) between two glass substrates of about 9 μm. A square wave having a frequency of 32 Hz was applied to the element. The voltage of the square wave was increased and the value of a voltage when a transmittance of light passing through the element was 10% was measured.

Voltage Holding Ratio (VHR; Measured at 25° C.; %):

A TN element used for measurement had a polyimide alignment film and an interval (cell gap) between two glass substrates of 6 μm. After the sample was inserted, the element was sealed using an adhesive that was polymerized with ultraviolet rays. A pulse voltage (for 60 microseconds at 5 V) was applied to the TN element for charging. An attenuating voltage was measured using a high-speed voltmeter for 16.7 milliseconds, and an area A between the voltage curve and the horizontal axis in the unit cycle was obtained. An area B was an area when no attenuation occurred. A voltage holding ratio was a percentage of the area A with respect to the area B.

Helical Pitch (Measured at 20° C.; μm):

A Cano wedge type cell method was used to measure a helical pitch. A sample was inserted into a Cano wedge type cell, and an interval (a; unit is μm) between disclination lines observed from the cell was measured. The helical pitch (P) was calculated from the formula P=2·a·tan θ. θ was an angle between two glass plates in the wedge type cell.

### Selective Reflection Wavelength (λ; Measured at 25° C.; Nm):

A selective reflection wavelength was measured using a microspectrophotometer (product name MSV-350 commercially available from JEOL Ltd.).

The pitch of a cholesteric liquid crystal having a reflection wavelength in a long wavelength range or a short wavelength range of visible light and the cholesteric liquid crystal for which measurement was difficult was obtained when a chiral compound was added (a concentration C′) in a concentration in which it had a selective reflection wavelength in a visible light range, a selective reflection wavelength (λ′) was measured, and the original selective reflection wavelength (λ) was calculated from the original chiral concentration (concentration C) using a linear extrapolation method (λ=λ′×C′/C).

The pitch length was obtained by dividing the obtained reflection wavelength by an average refractive index (Handbook of Liquid Crystals, p 196, published in 2000, Maruzen). For the selective reflection wavelength λ, the relational formula <n>p/λ=1 was established. Here, <n> represents an average refractive index, and is obtained by the following formula <n>={(n∥²+n⊥²)/2}^{1/2}

Helical Twist Power (HTP; Measured at 25° C.; μm⁻¹):

HTP was obtained by the following formula using the average refractive index <n> and the value of the pitch obtained by the following method HTP=<n>/(λ·C). λ represents the selective reflection wavelength (nm), and C represents the chiral concentration (wt %).

A proportion (percentage) of the component or the liquid crystal compound was a weight percentage (weight %) based on the total weight of the liquid crystal compound. The composition was prepared by measuring weights of components such as a liquid crystal compound and performing mixing. Therefore, it was easy to calculate weight % of the component.

Determination of HTP of Chiral Agent (8H) BN-H5

A chiral agent (8H) BN-H5 (2.00 weight %) shown below was heated and dissolved at 100° C. in a nematic liquid crystal composition NLC-Z (98.00 weight %) to obtain a chiral nematic liquid crystal composition CLC-Z. The selective reflection wavelength (λ) of the liquid crystal composition CLC-Z was 525 (nm), and HTP of the compound chiral agent (8H) BN-H5 calculated from this value was 148.3 (m).

The chemical structural formula of the chiral agent (8H) BN-H5 is as follows.

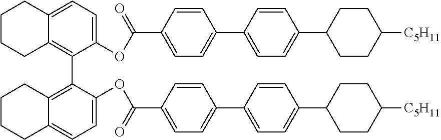

Nematic Liquid Crystal Composition NLC-Z

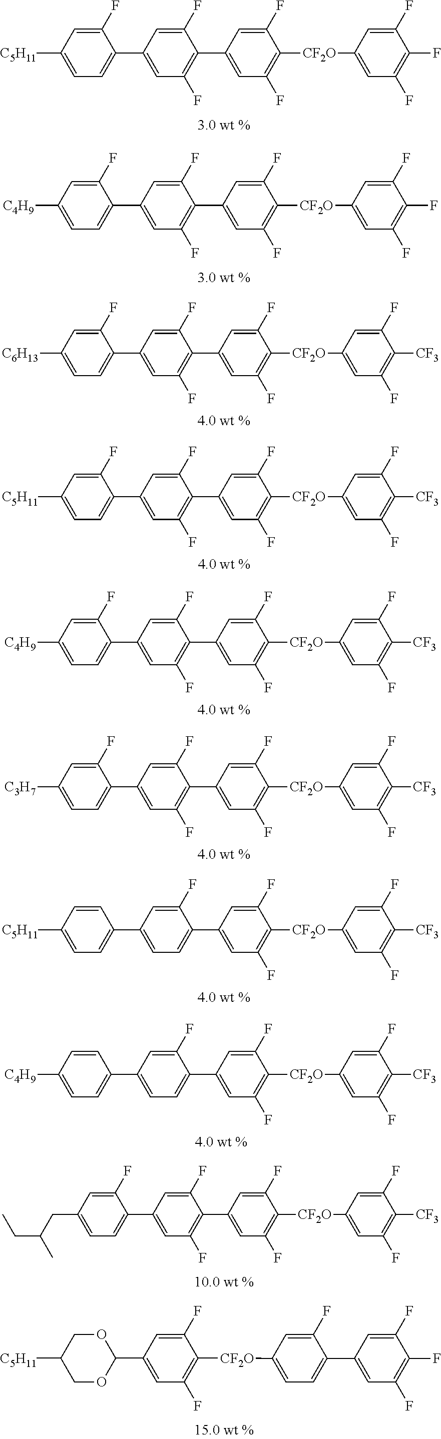

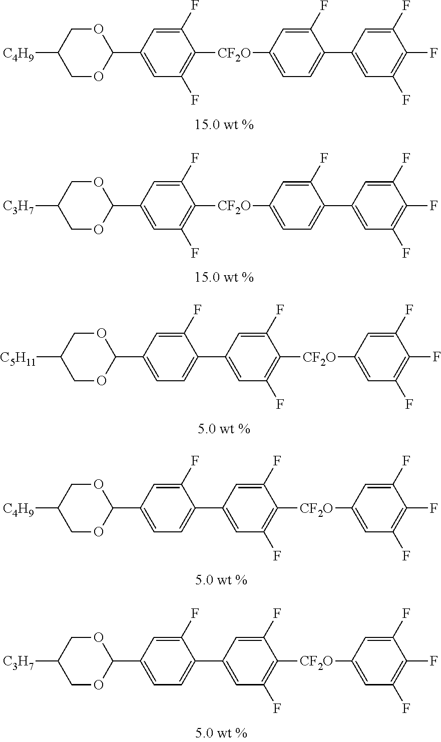

The phase transition temperature (° C.) of the nematic liquid crystal composition NLC-Z was N 77.6 I.

### Example 1

Liquid crystal compounds shown in the following drawings were mixed in the following proportion to prepare a nematic liquid crystal composition NLC-A.

### Nematic Liquid Crystal Composition NLC-A

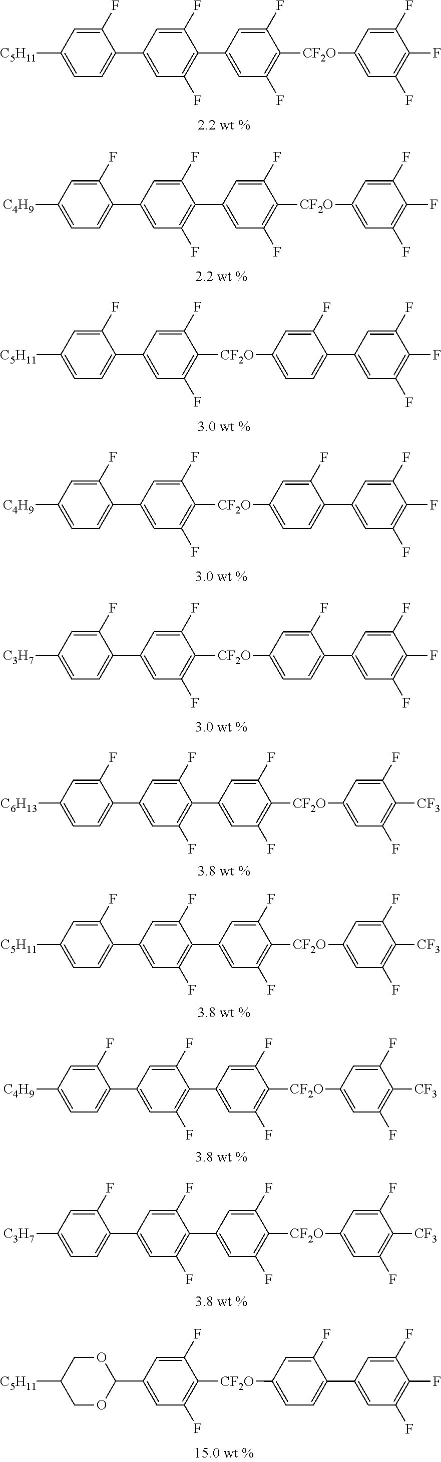

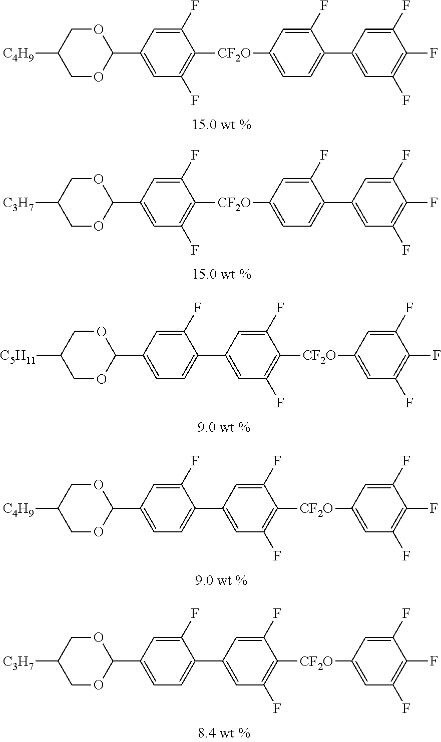

The phase transition temperature (° C.) of the nematic liquid crystal composition NLC-A was N 87.8 I.

Next, a chiral nematic liquid crystal composition CLC-A1 including the nematic liquid crystal composition NLC-A (95.2 weight %) and the chiral agent (8H) BN-H5 (4.8 weight %) was obtained.

The phase transition temperature (° C.) of the chiral nematic liquid crystal composition CLC-A1 was N* 79.0 BP-I.

Preparation of Mixture (MLC-A1) of Polymerizable Monomer and Chiral Nematic Liquid Crystal Composition

As a mixture of the chiral nematic liquid crystal composition and the polymerizable monomer, a mixture MLC-A1 in which 88.8 weight % of the chiral nematic liquid crystal composition CLC-A1, 6.0 weight % of n-hexadecyl acrylate, 4.8 weight %, of benzene-1,2,4-triyltris(4-(12-(acryloyloxy)dodecyloxy)benzoyloxy)benzoate(LCA-1), and 0.4 weight % of 2,2′-dimethoxyphenylacetophenone as a photopolymerization initiator were mixed together was prepared. The phase transition temperature (° C.) of the mixture MLC-A1 was N* 50.9 BP 54.3 I.

The chemical structural formula of LCA-1 is as follows.

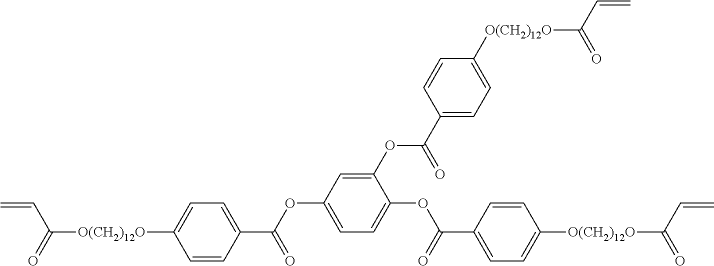

Preparation of a Polymer/Liquid Crystal Composite Material (PSBP-A1)

The mixture MLC-A1 was inserted between glass substrates with two electrodes not subjected to an alignment treatment (with a cell thickness of 15 μm), and the obtained cell was heated at 51.1° C. so that the blue phase was exhibited. In this state, ultraviolet light (a UV light intensity of 2.0 mWcm⁻² (365 nm)) was emitted for 7 minutes so that a polymerization reaction occurred. The polymer/liquid crystal composite material (PSBP-A1) obtained in this manner maintained the optically isotropic liquid crystal phase even when cooled to room temperature.

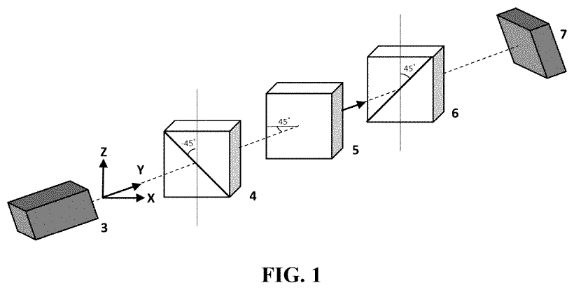

The cell into which the polymer/liquid crystal composite material PSBP-A1 was inserted was set in an optical system shown in FIG. 1, and electro-optical characteristics were measured. A white light source of a polarizing microscope (commercially available from Nikon Eclipse LV100POL) was used as a light source, and an angle of incidence on the cell was set to be tilted 45 degrees with respect to the cell surface. It was confirmed that an optical change was observed when a voltage was applied at room temperature, and polarization control was possible.

### Example 2

A chiral nematic liquid crystal composition CLC-A2 including the nematic liquid crystal composition NLC-A (96.5 weight %) and the chiral agent (8H) BN-H5 (3.5 weight %) was obtained.

The phase transition temperature (° C.) of the chiral nematic liquid crystal composition CLC-A2 was N* 79.8 BP-I.

Preparation of a Mixture (MLC-A2) of the Polymerizable Monomer and the Chiral Nematic Liquid Crystal Composition

As a mixture of the chiral nematic liquid crystal composition and the polymerizable monomer, a mixture MLC-A2 in which 88.8 weight % of the chiral nematic liquid crystal composition CLC-A2, 6.0 weight % of n-hexadecyl acrylate, 4.8 weight % of benzene-1,2,4-triyltris(4-(12-(acryloyloxy)dodecyloxy)benzoyloxy)benzoate (LCA-1), and 0.4 weight % of 2,2′-dimethoxyphenylacetophenone as a photopolymerization initiator were mixed together was prepared. The phase transition temperature (° C.) of the mixture MLC-A2 was N* 52.5 BP-I.

Preparation of a Polymer/Liquid Crystal Composite Material (PSBP-A3)

The mixture MLC-A2 was inserted between glass substrates with two electrodes not subjected to an alignment treatment (with a cell thickness of 15 μm), and the obtained cell was heated at 52.7° C. so that the blue phase was exhibited. In this state, ultraviolet light (a UV light intensity of 2.0 mWcm⁻² (365 nm)) was emitted for 7 minutes so that a polymerization reaction occurred. The polymer/liquid crystal composite material (PSBP-A3) obtained in this manner maintained in the optically isotropic liquid crystal phase even when cooled to room temperature.

The cell into which the polymer/liquid crystal composite material PSBP-A3 was inserted was set in an optical system shown in FIG. 1, and electro-optical characteristics were measured. A white light source of a polarizing microscope (commercially available from Nikon Eclipse LV100POL) was used as a light source, and an angle of incidence on the cell was set to be tilted 45 degrees with respect to the cell surface. It was confirmed that an optical change was observed when a voltage was applied at room temperature, and polarization control was possible.

### Example 3

Liquid crystal compounds shown in the following drawings were mixed in the following proportions to prepare a nematic liquid crystal composition NLC-B.

### Nematic Liquid Crystal Composition NLC-B

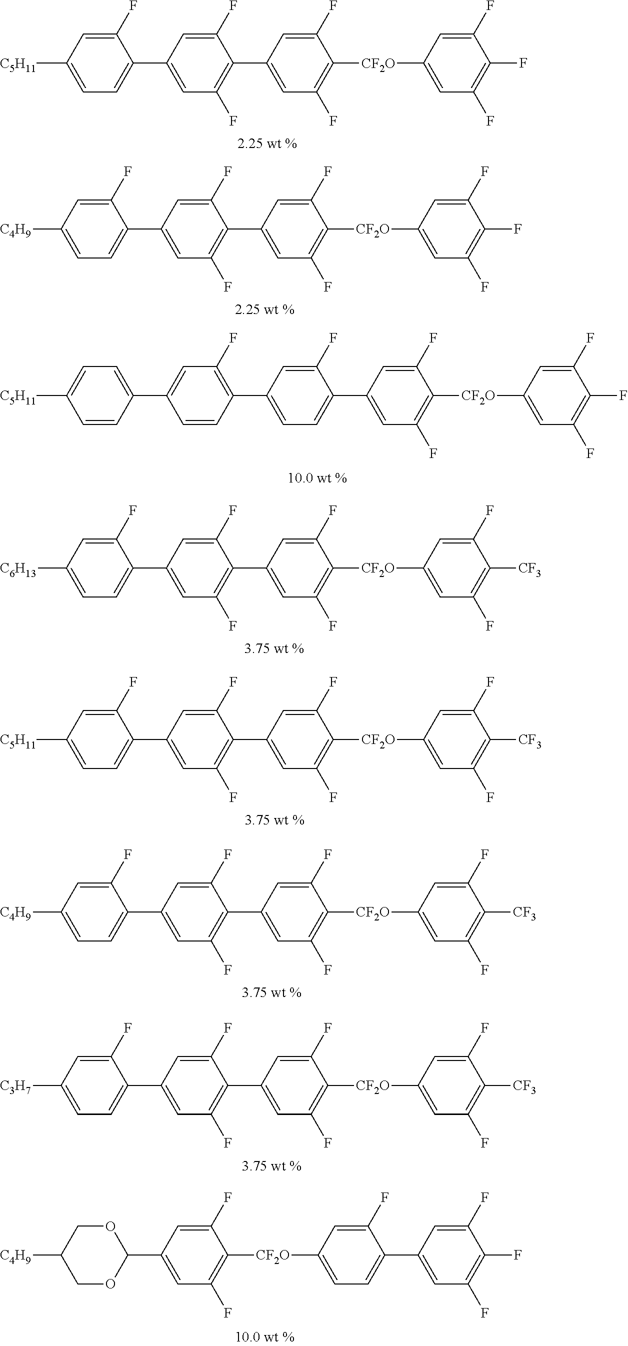

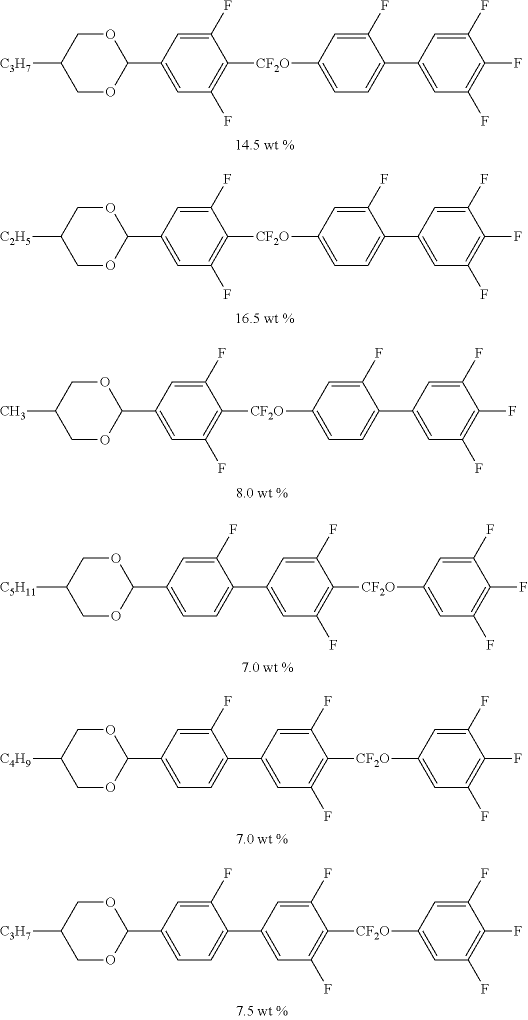

The phase transition temperature (° C.) of the nematic liquid crystal composition NLC-B was N 97.1 I.

Next, a chiral nematic liquid crystal composition CLC-B including the nematic liquid crystal composition NLC-B (96.5 weight %) and the chiral agent (8H) BN-H5 (3.5 weight %) was obtained.

The phase transition temperature (° C.) of the chiral nematic liquid crystal composition CLC-B was N* 90.4 BP-I.

Preparation of a Mixture (MLC-B) of the Polymerizable Monomer and the Chiral Nematic Liquid Crystal Composition

As a mixture of the chiral nematic liquid crystal composition and the polymerizable monomer, a mixture MLC-B in which 88.8 weight % of the chiral nematic liquid crystal composition CLC-B, 6.0 weight % of n-dodecyl acrylate, 4.8 weight % of benzene-1,2,4-triyltris(4-(12-(acryloyloxy)dodecyloxy)benzoyloxy)benzoate (LCA-1), and 0.4 weight % of 2,2′-dimethoxyphenylacetophenone as a photopolymerization initiator were mixed together was prepared. The phase transition temperature (° C.) of the mixture MLC-B was N* 56.5 BP-I.

Preparation of a Polymer/Liquid Crystal Composite Material (PSBP-B1)

The mixture MLC-B was inserted between glass substrates with two electrodes not subjected to an alignment treatment (with a cell thickness of 15 μm), and the obtained cell was heated at 56.7° C. so that the blue phase was exhibited. In this state, ultraviolet light (a UV light intensity of 2.0 mWcm⁻² (365 nm)) was emitted for 7 minutes so that a polymerization reaction occurred. The polymer/liquid crystal composite material (PSBP-B1) obtained in this manner maintained in the optically isotropic liquid crystal phase even when cooled to room temperature.

The cell into which the polymer/liquid crystal composite material PSBP-B1 was inserted was set in an optical system shown in FIG. 1, and electro-optical characteristics were measured. A white light source of a polarizing microscope (commercially available from Nikon Eclipse LV100POL) was used as a light source, and an angle of incidence on the cell was set to be tilted 45 degrees with respect to the cell surface. It was confirmed that an optical change was observed when a voltage was applied at room temperature, and polarization control was possible.

### Example 4

Liquid crystal compounds shown in Table 1 were mixed in the following proportions to prepare nematic liquid crystal compositions NLC-C to NLC-I. The numerical value in Table 1 indicates the composition proportion (weight %), and N→I indicates a phase transition temperature (° C.) of each nematic liquid crystal composition. “Compound” in Table 1 corresponds to Compound 1 which is an achiral component T, and more specifically, corresponds to a compound represented by the number of “Formula.”

TABLE 1

| | form- | | | | | | | |
|---|---|---|---|---|---|---|---|---|
| Compound | ula | NLC-C | NLC-D | NLC-E | NLC-F | NLC-G | NLC-H | NLC-I |
| 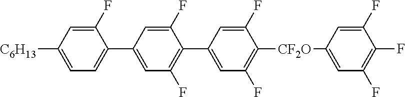 | (3-1) | 2.2 | 2.2 | 2.2 | 2.2 | 2.2 | 2.2 | 2.2 |
| 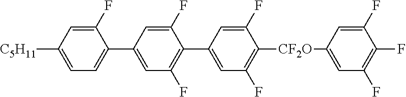 | (3-1) | 2.2 | 2.2 | 2.2 | 2.2 | 2.2 | 2.2 | 2.2 |
| 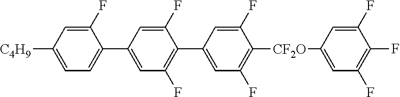 | (3-1) | 2.2 | 2.2 | 2.2 | 2.2 | 2.2 | 2.2 | 2.2 |
| 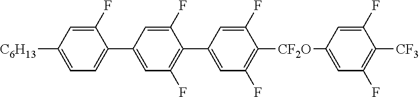 | (3-1) | 3.8 | 3.8 | 3.8 | 3.8 | 3.8 | 3.8 | 3.8 |
| 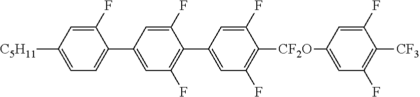 | (3-1) | 3.8 | 3.8 | 3.8 | 3.8 | 3.8 | 3.8 | 3.8 |
| 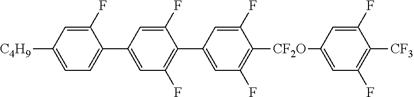 | (3-1) | 3.8 | 3.8 | 3.8 | 3.8 | 3.8 | 3.8 | 3.8 |
| 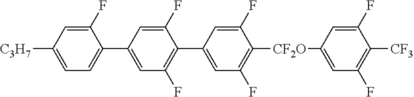 | (3-1) | 3.8 | 3.8 | 3.8 | 3.8 | 3.8 | 3.8 | 3.8 |
| 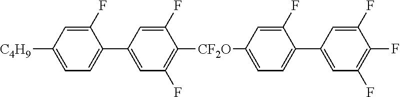 | (3-2) | | | | | 10.0 | 10.0 | 10.0 |
| 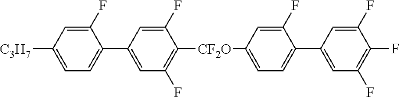 | (3-2) | | 10.0 | 9.0 | 10.0 | 10.0 | 10.0 | 10.0 |
| 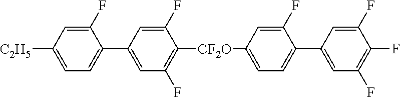 | (3-2) | | | | | | 7.2 | |
| 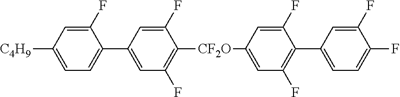 | (3-3) | 5.0 | | | | | | |
| 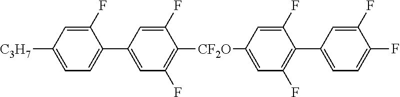 | (3-3) | 5.0 | | | | | | |
| 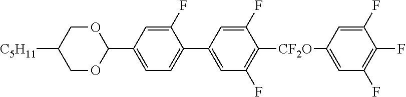 | (2-2-5) | 11.0 | 11.0 | 11.0 | 7.0 | 11.0 | 10.0 | 10.0 |
| 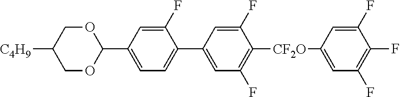 | (2-2-5) | 11.0 | 11.0 | 11.0 | 7.0 | | | |
| 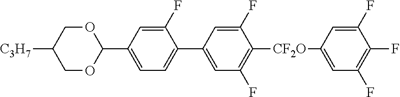 | (2-2-5) | 11.0 | 11.0 | 11.0 | 7.0 | 11.0 | 10.0 | 10.0 |
| 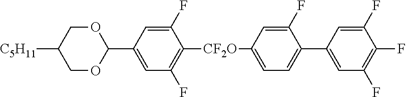 | (2-2-5) | 15.0 | 15.0 | | | 7.2 | | 7.2 |
| 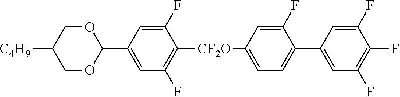 | (2-2-5) | | | | 11.0 | | | |
| 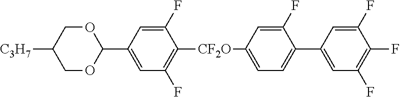 | (2-2-5) | | | 10.0 | 12.0 | 7.0 | 8.0 | 8.0 |
| 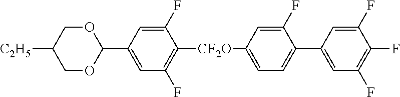 | (2-2-5) | 5.0 | 5.0 | 10.0 | 5.2 | | 8.0 | 8.0 |
| 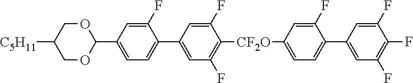 | (2-7) | | | 1.2 | 4.0 | | | |
| 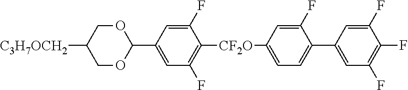 | (2-9-2) | | | | | 7.0 | | |
| 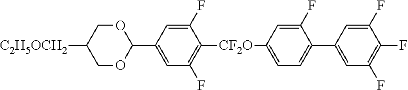 | (2-9-2) | 15.2 | 10.2 | 10.0 | 15.0 | 5.0 | | |
| 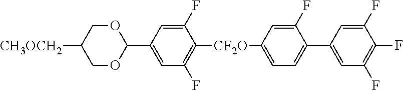 | (2-9-2) | | | 5.0 | | | | |
| 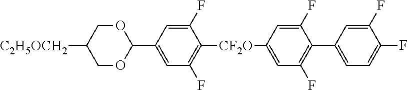 | (2-9-3) | | 5.0 | | | | | |
| 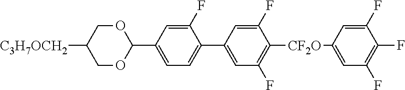 | (2-9-4) | | | | | | 5.0 | 5.0 |
| 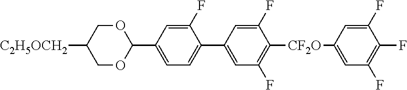 | (2-9-4) | | | | | 10.0 | 10.0 | 5.0 |
| 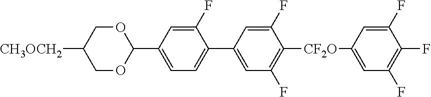 | (2-9-4) | | | | | | | 5.0 |
| SUM | | 100.0 | 100.0 | 100.0 | 100.0 | 100.0 | 100.0 | 100.0 |
| Phase transition temperature (° C.) | N→I | 86.2- | 86.8- | 86.8- | 86.9- | 86.5- | 85.0- | 86.6- |
| | | 86.4 | 87.1 | 87.3 | 87.5 | 86.7 | 85.1 | 86.9 |

Next, nematic liquid crystal compositions and the chiral agent (8H) BN-H5 were mixed together in proportions in the following table to prepare chiral nematic liquid crystal compositions CLC-C to CLC-I. The numerical value in Table 2 indicates a composition proportion (weight %), and N*→N*+BP, N*+BP→BP, and BP→I indicate a phase transition temperature (° C.) of each chiral nematic liquid crystal composition.

TABLE 2

| | | CLC-C | CLC-D | CLC-E | CLC-F | CLC-G | CLC-H | CLC-I |
|---|---|---|---|---|---|---|---|---|
| Content (weight %) of | | 95.2 | 95.2 | 95.2 | 95.2 | 95.2 | 95.2 | 95.2 |
| NLC | | | | | | | | |
| Content (weight %) of | | 4.8 | 4.8 | 4.8 | 4.8 | 4.8 | 4.8 | 4.8 |
| (8H) BN-H5 | | | | | | | | |
| Phase | N* → N* + BP | 77.9 | 78.2 | 78.9 | 77.7 | 78.3 | 76.5 | 78.6 |
| transition | N* + BP → BP | 78.1 | 79.4 | 79.1 | 77.9 | 79.6 | 76.7 | 78.8 |
| temperature | BP → I | 79.9 | 80.2 | 81.1 | 80.0 | 80.2 | 78.2 | — |
| (° C.) | | | | | | | | |

Preparation of a Mixture of Monomers and a Liquid Crystal Composition

Regarding a mixture of the liquid crystal composition and the polymerizable monomer, a chiral nematic liquid crystal composition, n-dodecyl acrylate, benzene-1,2,4-triyltris(4-(12-(acryloyloxy)dodecyloxy)benzoyloxy)benzoate (LCA-1) or 1,4-di(4-(6-(acryloyloxy)dodecyloxy)benzoyloxy)-2-methylbenzene (LCA-2), and 2,2′-dimethoxyphenylacetophenone as a photopolymerization initiator were mixed together in the following proportions to prepare liquid crystal compositions MLC-C to MLC-I. The numerical value in Table 3 indicates the composition proportion (weight %), and N*→N*+BP, N*+BP→BP, and BP→I indicate a phase transition temperature (° C.) of each chiral nematic liquid crystal composition.

Here, the chemical structural formula of LCA-2 is as follows.

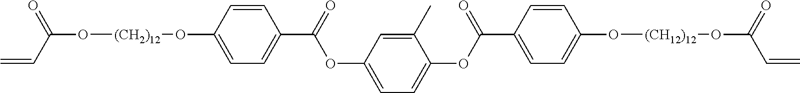

TABLE 3

| | | MLC-C | MLC-D | MLC-E | MLC-F | MLC-G | MLC-H | MLC-I |
|---|---|---|---|---|---|---|---|---|
| Content (weight %) of CLC | | 87.4 | 88.8 | 88.8 | 88.8 | 88.8 | 88.8 | 88.8 |
| Content (weight %) of n-dodecyl acrylate | | 6.8 | 5.4 | 5.4 | 5.4 | 5.4 | 5.4 | 5.4 |
| Content (weight %) of LCA-1 | | | 5.4 | 5.4 | 5.4 | 5.4 | 5.4 | 5.4 |
| Content (weight %) of LCA-2 | | 5.4 | | | | | | |
| Content (weight %) of | | 0.4 | 0.4 | 0.4 | 0.4 | 0.4 | 0.4 | 0.4 |
| 2,2′-dimethoxyphenylacetophenone | | | | | | | | |
| Phase transition | N* → N* + BP | 48.1 | 48.5 | 47.6 | 46.8 | 46.4 | 47.5 | 48.0 |
| temperature | N* + BP → BP | 48.5 | 48.8 | 48.0 | 47.2 | 46.8 | 50.1 | 48.3 |
| (° C.) | BP → I | — | — | 52.3 | — | — | 52.0 | 52.7 |

Preparation of a Polymer/Liquid Crystal Composite Material

Liquid crystal compositions MLC-C to MLC-I were inserted between glass substrates with two electrodes not subjected to an alignment treatment (with a cell thickness of 15 μm), and the obtained cell was heated to a temperature at which the blue phase was exhibited. In this state, ultraviolet light (a UV light intensity of 2.0 mWcm⁻² (365 nm)) was emitted for 7 minutes so that a polymerization reaction occurred. The polymer/liquid crystal composite material obtained in this manner maintained in the optically isotropic liquid crystal phase even when cooled to room temperature.

The cells into which the polymer/liquid crystal composite materials PSBP-C to PSBP-I were inserted were set in an optical system shown in FIG. 1, and electro-optical characteristics were measured. A white light source of a polarizing microscope (commercially available from Nikon Eclipse LV100POL) was used as a light source, and an angle of incidence on the cell was set to be tilted 45 degrees with respect to the cell surface. It was confirmed that an optical change was observed when a voltage was applied at room temperature, and polarization control was possible.

It was found that the liquid crystal medium exhibiting the optically isotropic liquid crystal phase of this specification could be suitably used for an element for controlling retardation or an element for controlling polarization (switching between right circularly polarized light and left circularly polarized light) in which a blue phase liquid crystal medium was specifically used.

The liquid crystal composition of the disclosure can be used for an optical switching element using a polymer/liquid crystal composite material having an optically isotropic liquid crystal phase, for example, a blue phase, for example, an optical switching element for LIDAR.

What is claimed is:

1. A liquid crystal composition which comprises an achiral component T and has an optically isotropic liquid crystal phase and is used for optical switching in which retardation is controlled by birefringence induced due to an electric field.

2. The liquid crystal composition according to claim 1, which is used for optical switching in which the retardation is controlled such that it is 0 to λ/2 by applying a voltage.

3. The liquid crystal composition according to claim 1, which is used for switching between right circularly polarized light and left circularly polarized light.

4. The liquid crystal composition according to claim 1,
wherein the achiral component T contains at least one Compound 1 represented by Formula (1): 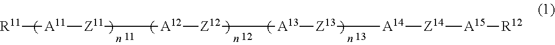
in the formula, R¹¹ is a hydrogen atom or an alkyl group having 1 to 20 carbon atoms, at least one —CH₂— in the alkyl group is optionally replaced with —O—, —S—, —COO—, —OCO—, —CH═CH—, —CF═CF—, or —C≡C—, at least one hydrogen atom in the alkyl group is optionally replaced with a halogen atom; R¹² is a hydrogen atom, a halogen atom, —C≡N, —N═C≡O, —N═C≡S, —CF₃, —OCF₃, or an alkyl group having 1 to 3 carbon atoms, and at least one —CH₂— in the alkyl group is optionally replaced with —O—, —S—, —COO—, —OCO—, —CH═CH—, —CF═CF—, or —C≡C—, at least one hydrogen atom in the alkyl group is optionally replaced with a halogen atom, and at least one —CH₃ in the alkyl group is optionally replaced with —C≡N; rings A¹¹ to A¹⁵ are independently a 5- to 8-membered ring or a condensed ring having 9 or more carbon atoms, and at least one hydrogen atom in these rings is optionally replaced with a halogen atom, an alkyl group having 1 to 5 carbon atoms, or an alkyl halide, at least one —CH₂— in the alkyl group or the alkyl halide is optionally replaced with —O—, —S—, or —NH—, at least one —CH₂— in these rings is optionally replaced with —O—, —S—, or —NH—, and at least one —CH═ in these rings is optionally replaced with —N═; Z¹¹ to Z¹⁴ are independently a single bond or an alkylene group having 1 to 8 carbon atoms, and at least one —CH₂— in the alkylene group is optionally replaced with —O—, —S—, —COO—, —OCO—, —CSO—, —OCS—, —N═N—, —CH═N—, —N═CH—, —N(O)═N—, —N═N(O)—, —CH═CH—, —CF═CF—, or —C≡C—, and at least one hydrogen atom in the alkylene group is optionally replaced with a halogen atom; and n¹¹ to n¹³ are independently 0 or 1.

5. The liquid crystal composition according to claim 4,
wherein, in Formula (1), n¹¹+n¹²+n¹³ is 2 or 3, A¹¹ to A¹⁴ are selected from among the group consisting of groups represented by (A-1) to (A-10), A¹⁵ is selected from among the group consisting of groups represented by (A-1) to (A-3), and the total number of halogen atoms in A¹¹ to A¹⁵ is 6 or more:

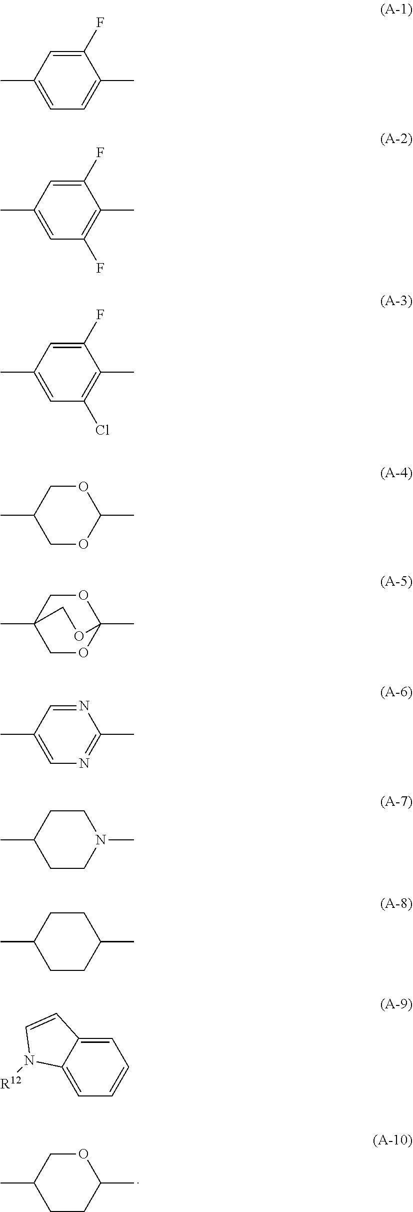

6. The liquid crystal composition according to claim 1,
wherein the achiral component T contains at least one Compound 2 represented by Formula (2): 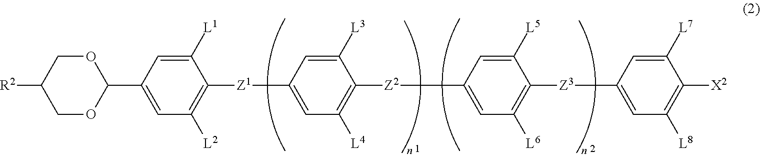
in Formula (2), R² is a hydrogen atom, an alkyl group having 1 to 20 carbon atoms, an alkenyl group having 2 to 20 carbon atoms, an alkynyl group having 2 to 20 carbon atoms, an alkoxy group having 1 to 19 carbon atoms, or an alkoxyalkyl group having 1 to 20 carbon atoms in total, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R², —O— and —CH═CH—, and —CO— and —CH═CH— are not adjacent to each other;
Z¹ to Z³ are independently a single bond, —COO— or —CF₂O—, and at least one thereof is —COO— or —CF₂O—;
L¹ to L⁸ are independently a hydrogen atom or a fluorine atom; and
n¹ and n² are independently 0 or 1; and
X² is a hydrogen atom, a halogen atom, —SF₅ or an alkyl group having 1 to 10 carbon atoms, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C—, is optionally replaced with a fluorine atom or a chlorine atom, where, in X², —O— and —CH═CH—, and —CO— and —CH═CH— are not adjacent to each other.

7. The liquid crystal composition according to claim 4,
wherein the achiral component T further contains at least one Compound 2 represented by Formula (2): 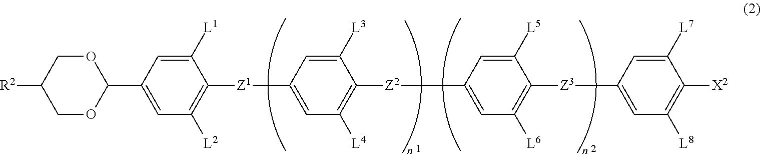
in Formula (2), R² is a hydrogen atom, an alkyl group having 1 to 20 carbon atoms, an alkenyl group having 2 to 20 carbon atoms, an alkynyl group having 2 to 20 carbon atoms, an alkoxy group having 1 to 19 carbon atoms, or an alkoxyalkyl group having 1 to 20 carbon atoms in total, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R², —O— and —CH═CH—, and —CO— and —CH═CH— are not adjacent to each other;
Z¹ to Z³ are independently a single bond, —COO— or —CF₂O—, and at least one thereof is —COO— or —CF₂O—;
L¹ to L⁸ are independently a hydrogen atom or a fluorine atom; and
n¹ and n² are independently 0 or 1; and
X² is a hydrogen atom, a halogen atom, —SF₅ or an alkyl group having 1 to 10 carbon atoms, at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C—, is optionally replaced with a fluorine atom or a chlorine atom, where, in X², —O— and —CH═CH—, and —CO— and —CH═CH— are not adjacent to each other.

8. The liquid crystal composition according to claim 6,
wherein the achiral component T contains at least one Compound 3 represented by Formula (3): 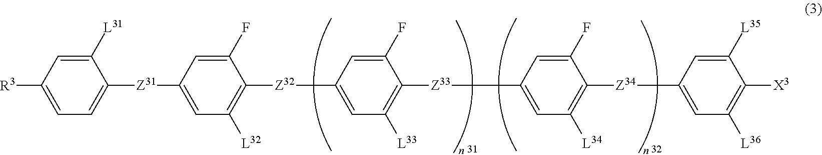
in Formula (3), R³ is a hydrogen atom, an alkyl group having 1 to 20 carbon atoms, an alkenyl group having 2 to 20 carbon atoms, an alkynyl group having 2 to 20 carbon atoms, an alkoxy group having 1 to 19 carbon atoms, or an alkoxyalkyl group having 1 to 20 carbon atoms in total, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and at least one hydrogen atom in the alkyl group is optionally replaced with a fluorine atom or a chlorine atom, where, in R³, —O— and —CH═CH—, and —CO— and —CH═CH— are not adjacent to each other;
Z³¹ to Z³⁴ are independently a single bond, —COO— or —CF₂O—, and at least one thereof is —COO— or —CF₂O—;
L³¹ to L³⁶ are independently a hydrogen atom or a fluorine atom;
X³ is a hydrogen atom, a halogen atom, —SF₅ or an alkyl group having 1 to 10 carbon atoms, and at least one —CH₂— in the alkyl group is optionally replaced with —O—, —S—, —COO— or —OCO—, at least one —CH₂—CH₂— in the alkyl group is optionally replaced with —CH═CH—, —CF═CF— or —C≡C—, and in the alkyl group, at least one hydrogen atom in a group in which at least one —CH₂— in the alkyl group is replaced with —O—, —S—, —COO—, or —OCO— or a group in which at least one —CH₂—CH₂— in the alkyl group is replaced with —CH═CH—, —CF═CF— or —C≡C—, is optionally replaced with a fluorine atom or a chlorine atom, where, in X³, —O— and —CH═CH—, and —CO— and —CH═CH— are not adjacent to each other; and
n³¹ and n³² are independently 0 or 1.

9. The liquid crystal composition according to claim 8,
wherein a total amount of Compound 2 contained is 25 weight % to 90 weight %, and a total amount of Compound 3 contained is 5 weight % to 65 weight % with respect to a total weight of the achiral component T.

10. The liquid crystal composition according to claim 1, containing a chiral agent.

11. The liquid crystal composition according to claim 1, containing one or more compounds selected from the group consisting of an antioxidant and a UV absorber.

12. A mixture comprising the liquid crystal composition according to claim 1 and polymerizable monomers.

13. A polymer/liquid crystal composite material which is used for an element that is driven in an optically isotropic liquid crystal phase and obtained by polymerizing the mixture according to claim 12.

14. The polymer/liquid crystal composite material according to claim 13, which is obtained by polymerizing the mixture in a temperature range of a non-liquid crystalline isotropic phase or an optically isotropic liquid crystal phase.

15. An element comprising the liquid crystal composition according to claim 1.

16. An element comprising the polymer/liquid crystal composite material according to claim 13.

17. The element according to claim 15 which is able to be used with respect to light in a near infrared range of 0.72 to 2.5 μm.

18. The element according to claim 15, which is able to be used with respect to light in a millimeter wave range of 1 to 10 mm.

19. A LIDAR comprising the element according to claim 15.

20. A LIDAR comprising the element according to claim 16.
